(19) United States
(12) Patent Application Publication
(10) Pub. No.: US 2025/0271778 A1
(43) Pub. Date: Aug. 28, 2025

(54) DETERMINATION OF THIN FILM PATTERN TO COMPENSATE SUBSTRATE WARPAGE

(71) Applicant: Tignis, Inc., Seattle, WA (US)

(72) Inventors: Abhishek Bihani, Barrie (CA); Ryan J. Stoddard, Seattle, WA (US)

(21) Appl. No.: 19/066,100

(22) Filed: Feb. 27, 2025

Related U.S. Application Data
(60) Provisional application No. 63/558,766, filed on Feb. 28, 2024.

(51) Int. Cl. G03F 7/00; G06F 30/23; G06F 30/27; G06F 30/398; G06F 111/06; H01L 21/66; H01L 21/67

(52) U.S. Cl. CPC G03F 7/706841; G03F 7/70608; G03F 7/706837; G06F 30/23; G06F 30/27; G06F 30/398; H01L 21/67288; H01L 22/12; G06F 2111/06

(57) ABSTRACT

A system may receive a training data set including a set of target wafer shape transformations corresponding to negatives of warpage signatures of semiconductor wafers, and a set of training corrective film patterns that reduce warpage signatures of semiconductor wafers. A system may provide a surrogate machine learning model that includes a forward model comprising a first neural network model configured to take as input a corrective film pattern and output a corresponding wafer shape transformation and an inverse model comprising a second neural network model configured to take as input a wafer shape transformation and output a corresponding corrective film pattern. A system may train a forward model using training corrective film patterns. A system may train an inverse model using target wafer shape transformations, output from a forward model, and by calculating a loss that includes a regularization penalty for film patterns outside a main distribution.

### CROSS-REFERENCE TO RELATED APPLICATIONS

This application claims priority to Provisional Patent Application No. 63/558,766, titled “DETERMINING CORRECTIVE FILM PATTERN TO REDUCE SEMICONDUCTOR WAFER BOW,” and filed Feb. 28, 2024, the content of which is incorporated by reference herein in its entirety.

### TECHNICAL FIELD

The disclosed technology relates generally to semiconductor fabrication and metrology methods and apparatuses. More specifically, it relates to techniques and systems for reducing wafer warpage caused by stress.

### BACKGROUND

In semiconductor manufacturing, complex structures can be fabricated using sequences of thin film deposition, photolithography and etching. Complex structures can be fabricated using lithography and etching masks with small feature sizes and repeating these steps many times for various materials. In each processing step, the lithography and etching masks can be precisely aligned with an absolute coordinate system for each device on a wafer. As device dimensions get smaller, the tolerance for spatial deviations in mask alignment becomes stricter. If the spatial offset (or “overlay error”) in two or more processing steps is too great, the device may be inoperable or not operate as intended. One phenomenon that can lead to overlay error is wafer bowing and warping during processing. Wafer bow can occur when distinct material films with unequal thermal expansion coefficients undergo a temperature change during processing. In cases with many different thin film materials and complex device patterns, the wafer bow signatures can be complex and the in-plane distortion that arises due to the bow signature can be difficult to determine.

Applying a corrective film to reduce or eliminate wafer bow is one route to minimize overlay error and increase device yield. One technical challenge that arises with this solution is determining which corrective film pattern to apply to the wafer that can effectively remove bow signature and reduce overlay error to an acceptable tolerance. The wafer bow problem can be modeled as a linear elasticity problem and solved using a numerical approach (e.g., using a finite element method). However, the calculation time for this approach can be too long to be practical in semiconductor fabrication environments, such as on-line semiconductor fabrication environments.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

Disclosed herein methods for reducing semiconductor wafer bow. According to various embodiments, solutions to the wafer bow correction problem using a machine learning surrogate model approach are described. The surrogate model can successfully suggest a corrective film pattern to reverse a generic wafer bow signature with computation time of about three orders of magnitude less than a finite element method approach.

In one aspect, the disclosure includes a method for generating a corrective film pattern for reducing wafer bow in a semiconductor wafer fabrication process. The method can include inputting to a neural network a wafer bow signature for a predetermined semiconductor fabrication step and generating, by the neural network, a corrective film pattern corresponding to the wafer bow signature The neural network can be trained with a training dataset of wafer shape transformations and corresponding corrective film patterns.

In some embodiments, the training dataset may be generated using a simulation to compute the corrective film patterns from the wafer shape transformations for a predetermined semiconductor fabrication step. The training dataset may be generated by experimentally determining the corrective film patterns corresponding to the wafer shape transformations. The training dataset may be generated using a finite element method to solve a linear elasticity problem and using an optimization framework to select the wafer shape transformations that minimize a cost function.

In some embodiments, the method may further include performing active learning feedback to refine the neural network. The neural network may be implemented as a convolutional U-Net, a Zernike convolutional neural network, a conditional variational autoencoder, as a conditional generative adversarial network, or any other suitable neural network or machine learning algorithm. The conditional generative adversarial network may include a generator implemented as a U-Net with skip connections or a discriminator implemented as a convolutional classifier.

In one aspect, a method of supervised training a surrogate machine learning model for generating corrective film patterns to reduce warpage of semiconductor wafers during manufacturing of integrated circuit devices is described. The method can include receiving a training data set including: a set of target wafer shape transformations corresponding to negatives of warpage signatures of semiconductor wafers, and a set of training corrective film patterns that reduce warpage signatures of semiconductor wafers. The method can include providing the surrogate machine learning model including: a forward model including a first neural network model configured to take as input a corrective film pattern and output a corresponding wafer shape transformation, and an inverse model including a second neural network model configured to take as input a wafer shape transformation and output a corresponding corrective film pattern; training the forward model using the set of training corrective film patterns. The method can include training the inverse model using the set of wafer shape transformations and the wafer shape transformations determined by the trained forward model. Training the inverse model can include determining a training loss associated with each wafer shape transformation input thereto and the corresponding corrective film pattern output therefrom. Training the inverse model can further include a regularization process, including: determining one or more corrective film patterns of a set of corrective film patterns output by the inverse model to be outlier corrective film patterns that are outside of a main distribution of the set of corrective film patterns output by the inverse model, and applying a regularization penalty to the training loss associated with the outlier corrective film patterns. The method can include continuing to train the surrogate machine learning model until a difference between the wafer shape transformation output from the forward model and the wafer shape transformation input to the inverse model reaches below a predetermined value.

In another aspect, non-transitory computer readable storage media is described. The non-transitory computer readable storage media can store instructions that when executed by a system of one or more processors, cause the one or more processors to: receive a training data set including: a set of target wafer shape transformations corresponding to negatives of warpage signatures of semiconductor wafers, and a set of training corrective film patterns that reduce warpage signatures of semiconductor wafers; provide a surrogate machine learning model including: a forward model including a first neural network model configured to take as input a corrective film pattern and output a corresponding wafer shape transformation, and an inverse model including a second neural network model configured to take as input a wafer shape transformation and output a corresponding corrective film pattern; train the forward model using the set of training corrective film patterns; train the inverse model using the set of wafer shape transformations and the wafer shape transformations determined by the trained forward model, wherein to train the inverse model in instruction cause the one or more processors to determine a training loss associated with each wafer shape transformation input thereto and the corresponding corrective film pattern output therefrom, and perform a regularization process, including: determining one or more corrective film patterns of a set of corrective film patterns output by the inverse model to be outlier corrective film patterns that are outside of a main distribution of the corrective film patterns output by the inverse model, and applying a regularization penalty to the training loss associated with the outlier corrective film patterns; and continue to train the surrogate machine learning model until a difference between the wafer shape transformation output from the forward model and the wafer shape transformation input to the inverse model reaches below a predetermined value.

In another aspect, a method of generating corrective film patterns to reduce warpage of semiconductor wafers during manufacturing of integrated circuits is described. The method can include: receiving a warpage signature of a semiconductor wafer including a two dimensional height map; determining a target wafer shape transformation based on the warpage signature; providing the target wafer shape transformation to a surrogate machine learning model, wherein the surrogate machine learning model includes: a forward model including a first neural network model trained to take as input a corrective film pattern and output a corresponding wafer shape transformation, and an inverse model including a second neural network model trained to take as input a wafer shape transformation and output a corresponding corrective film pattern, wherein to train the inverse model one or more processors are configured to: determine a training loss associated with each wafer shape transformation input thereto and the corresponding corrective film pattern output therefrom, and perform a regularization process, including: determining one or more corrective film patterns of a set of corrective film patterns output by the inverse model to be outlier corrective film patterns that are outside of a main distribution of the corrective film patterns output by the inverse model, and applying a regularization penalty to the training loss associated with the outlier corrective film patterns; and receiving, from the surrogate machine learning model, one or more corrective film patterns associated with the warpage signature.

In another aspect, a system for generating corrective film patterns for semiconductor wafers is described. The system can include: one or more sensors configured to measure a warpage signature of a semiconductor wafer including a two dimensional height map; a memory storing the warpage signature; one or more processors; and non-transitory computer readable storage media storing instructions that when executed by the one or more processors, cause the one or more processors to: receive the warpage signature to correct from the memory; determine a target wafer shape transformation based on the warpage signature; provide the target wafer shape transformation to a surrogate machine learning model, wherein the surrogate machine learning model includes: a forward model including a first neural network model trained to take as input a corrective film pattern and output a corresponding wafer shape transformation, and an inverse model including a second neural network model trained to take as input a wafer shape transformation and output a corresponding corrective film pattern, wherein to train the inverse model a second one or more processors are configured to: determine a training loss associated with each wafer shape transformation input thereto and the corresponding corrective film pattern output therefrom, and perform a regularization process, wherein to perform the regularization process, the second one or more processors are configured to: determine one or more corrective film patterns of a set of corrective film patterns output by the inverse model to be outlier corrective film patterns that are outside of a main distribution of the corrective film patterns output by the inverse model, and apply a regularization penalty to the training loss associated with the outlier corrective film patterns; and receive, from the surrogate machine learning model, one or more corrective film patterns associated with the warpage signature.

In another aspect, non-transitory computer readable storage media is described. The non-transitory computer readable storage media can store instructions that when executed by a system of one or more processors, cause the one or more processors to: receive a warpage signature of a semiconductor wafer including a two dimensional height map; determine a target wafer shape transformation based on the warpage signature; provide the target wafer shape transformation to a surrogate machine learning model, wherein the surrogate machine learning model includes: a forward model including a first neural network model trained to take as input a corrective film pattern and output a corresponding wafer shape transformation, and an inverse model including a second neural network model trained to take as input a wafer shape transformation and output a corresponding corrective film pattern, wherein to train the inverse model a second one or more processors are configured to: determine a training loss associated with each wafer shape transformation input thereto and the corresponding corrective film pattern output therefrom, and perform a regularization process, including: determining one or more corrective film patterns of a set of corrective film patterns output by the inverse model to be outlier corrective film patterns that are outside of a main distribution of the corrective film patterns output by the inverse model, and applying a regularization penalty to the training loss associated with the outlier corrective film patterns; and receive, from the surrogate machine learning model, one or more corrective film patterns associated with the warpage signature.

In another aspect, a method of supervised training a surrogate machine learning model for generating corrective film patterns to reduce warpage of semiconductor wafers during manufacturing of integrated circuit devices is described. The method can include: receiving a training data set including: a set of target wafer shape transformation information including negatives of warpage signatures of semiconductor wafers, and a set of training corrective film pattern information to reduce warpage signatures of semiconductor wafers; providing the surrogate machine learning model including: a forward model including a first neural network model configured to take as input corrective film pattern information and output a corresponding wafer shape transformation information, and an inverse model including a second neural network model configured to take as input a wafer shape transformation information and output a corresponding corrective film pattern information; training the forward model using the set of corrective film pattern information, wherein training the forward model includes: configuring the input of corrective film pattern information, prior to processing through hidden layers of the first neural network model, into separate component inputs including a corrective film image and corrective film variables associated with a wafer coverage and a film thickness; obtaining the output of corresponding wafer shape transformation information as separate component outputs including a shape image and magnitudes of wafer warpage; and reducing a loss associated with each of the separate component outputs of the forward model; training the inverse model using the set of wafer shape transformation information and the wafer shape transformation information determined by the trained forward model, wherein training the inverse model includes: configuring the input of wafer shape transformation information, prior to processing through hidden layers of the second neural network model, into separate component inputs including the shape image and the magnitudes of wafer warpage; obtaining the output of corresponding corrective film pattern information as separate component outputs including the corrective film image and the corrective film variables associated with the wafer coverage and the film thickness; and reducing a loss associated with each of component outputs of the inverse model; and continuing to train the surrogate machine learning model until a difference between component outputs from the forward model and component inputs to the inverse model reaches below a predetermined value.

In another aspect, non-transitory computer readable storage media is described. The non-transitory computer readable storage media can store instructions that when executed by a system of one or more processors, cause the one or more processors to: receive a training data set including: a set of target wafer shape transformation information including negatives of warpage signatures of semiconductor wafers, and a set of training corrective film pattern information to reduce warpage signatures of semiconductor wafers; provide a surrogate machine learning model including: a forward model including a first neural network model configured to take as input corrective film pattern information and output a corresponding wafer shape transformation information, and an inverse model including a second neural network model configured to take as input a wafer shape transformation information and output a corresponding corrective film pattern information; train the forward model using the set of corrective film pattern information, wherein to train the forward model, the instruction cause the one or more processors to: configure the input of corrective film pattern information, prior to processing through hidden layers of the first neural network model, into separate component inputs including a corrective film image and corrective film variables associated with a wafer coverage and a film thickness; obtain the output of corresponding wafer shape transformation information as separate component outputs including a shape image and magnitudes of wafer warpage; and reduce a loss associated with each of component outputs of the forward model; train the inverse model using the set of wafer shape transformation information and the wafer shape transformation information determined by the trained forward model, wherein to train the inverse model, the instruction cause the one or more processors to: configure the input of wafer shape transformation information, prior to processing through hidden layers of the second neural network model, into separate component inputs including the shape image and the magnitudes of wafer warpage; obtain the output of corresponding corrective film pattern information as separate component outputs including the corrective film image and the corrective film variables associated with the wafer coverage and the film thickness; and reduce a loss associated with each of component outputs of the inverse model; and continue to train the surrogate machine learning model until a difference between component outputs from the forward model and component inputs to the inverse model reaches below a predetermined value.

In another aspect, a method of generating corrective film patterns to reduce warpage of semiconductor wafers during manufacturing of integrated circuits is described. The method can include: receiving a warpage signature of a semiconductor wafer including a two dimensional height map; determining a target wafer shape transformation information based on the warpage signature; configuring the target wafer shape transformation information into separate component inputs including a shape image and magnitudes of wafer warpage; providing the target wafer shape transformation to a surrogate machine learning model, wherein the surrogate machine learning model includes: a forward model including a first neural network model configured to take as input corrective film pattern information and output a corresponding wafer shape transformation information, and an inverse model including a second neural network model configured to take as input a wafer shape transformation information and output a corresponding corrective film pattern information, wherein, to train the forward model, one or more processors are configured to: configure the input of corrective film pattern information, prior to processing through hidden layers of the first neural network model, into separate component inputs including a corrective film image and corrective film variables associated with a wafer coverage and a film thickness; obtain the output of corresponding wafer shape transformation information as separate component outputs including a shape image and magnitudes of wafer warpage; and reduce a loss associated with each of component outputs of the forward model, and wherein, to train the inverse model, the one or more processors are configured to: configure the input of wafer shape transformation information, prior to processing through hidden layers of the second neural network model, into separate component inputs including the shape image and the magnitudes of wafer warpage; obtain the output of corresponding corrective film pattern information as separate component outputs including the corrective film image and the corrective film variables associated with the wafer coverage and the film thickness; and reduce a loss associated with each of component outputs of the inverse model; and receiving, from the surrogate machine learning model, one or more corrective film patterns information associated with the warpage signature.

In another aspect, a system for generating corrective film patterns for semiconductor wafers is described. The system can include: one or more sensors configured to measure a warpage signature of a semiconductor wafer including a two dimensional height map; a memory storing the warpage signature; one or more processors; and non-transitory computer readable storage media storing instructions that when executed by the one or more processors, cause the one or more processors to: receive a warpage signature of a semiconductor wafer including a two dimensional height map; determine a target wafer shape transformation information based on the warpage signature; configure the target wafer shape transformation information into separate component inputs including a shape image and magnitudes of wafer warpage; provide the target wafer shape transformation to a surrogate machine learning model, wherein the surrogate machine learning model includes: a forward model including a first neural network model configured to take as input corrective film pattern information and output a corresponding wafer shape transformation information, and an inverse model including a second neural network model configured to take as input a wafer shape transformation information and output a corresponding corrective film pattern information, wherein, to train the forward model, a second one or more processors are configured to: configure the input of corrective film pattern information, prior to processing through hidden layers of the first neural network model, into separate component inputs including a corrective film image and corrective film variables associated with a wafer coverage and a film thickness; obtain the output of corresponding wafer shape transformation information as separate component outputs including a shape image and magnitudes of wafer warpage; and reduce a loss associated with each of component outputs of the forward model, and wherein, to train the inverse model, the second one or more processors are configured to: configure the input of wafer shape transformation information, prior to processing through hidden layers of the second neural network model, into separate component inputs including the shape image and the magnitudes of wafer warpage; obtain the output of corresponding corrective film pattern information as separate component outputs including the corrective film image and the corrective film variables associated with the wafer coverage and the film thickness; and reduce a loss associated with each of component outputs of the inverse model; and receive, from the surrogate machine learning model, one or more corrective film patterns information associated with the warpage signature.

In another aspect, non-transitory computer readable storage media is described. The non-transitory computer readable storage media can store instructions that when executed by a system of one or more processors, cause the one or more processors to: receive a warpage signature of a semiconductor wafer including a two dimensional height map; determine a target wafer shape transformation information based on the warpage signature; configure the target wafer shape transformation information into separate component inputs including a shape image and magnitudes of wafer warpage; provide the target wafer shape transformation to a surrogate machine learning model, wherein the surrogate machine learning model includes: a forward model including a first neural network model configured to take as input corrective film pattern information and output a corresponding wafer shape transformation information, and an inverse model including a second neural network model configured to take as input a wafer shape transformation information and output a corresponding corrective film pattern information, wherein, to train the forward model, a second one or more processors are configured to: configure the input of corrective film pattern information, prior to processing through hidden layers of the first neural network model, into separate component inputs including a corrective film image and corrective film variables associated with a wafer coverage and a film thickness; obtain the output of corresponding wafer shape transformation information as separate component outputs including a shape image and magnitudes of wafer warpage; and reduce a loss associated with each of component outputs of the forward model, and wherein, to train the inverse model, the second one or more processors are configured to: configure the input of wafer shape transformation information, prior to processing through hidden layers of the second neural network model, into separate component inputs including the shape image and the magnitudes of wafer warpage; obtain the output of corresponding corrective film pattern information as separate component outputs including the corrective film image and the corrective film variables associated with the wafer coverage and the film thickness; and reduce a loss associated with each of component outputs of the inverse model; and receive, from the surrogate machine learning model, one or more corrective film patterns information associated with the warpage signature.

In another aspect, a method of predicting corrective film patterns to reduce warpage of semiconductor wafers during manufacturing of integrated circuit devices is described. The method can include: training a surrogate machine learning model, wherein training the surrogate machine learning model includes: receiving a training data set including: a set of target wafer shape transformation information including negatives of warpage signatures of semiconductor wafers, and a set of training corrective film pattern information to reduce warpage signatures of semiconductor wafers; providing the surrogate machine learning model including: a forward model including a first neural network model configured to take as input corrective film pattern information and output a corresponding wafer shape transformation information, the forward model including an optimizer algorithm, and an inverse model configured to take as input a wafer shape transformation information and output a corresponding corrective film pattern information, the inverse model including an optimizer algorithm, the optimizer algorithm configured determine errors associated with thicknesses of the output corresponding corrective film pattern information; receiving a particular warpage signature of a semiconductor wafer including a two dimensional height map; and determining, using the surrogate machine learning model, a particular corrective film pattern to reduce the particular warpage signature.

In another aspect, a method of generating corrective film patterns to reduce warpage of semiconductor wafers during manufacturing of integrated circuits is described. The method can include: receiving a warpage signature of a semiconductor wafer including a two dimensional height map; determining a target wafer shape transformation information based on the warpage signature; providing the target wafer shape transformation information to a surrogate machine learning model, wherein the surrogate machine learning model includes: a forward model including a neural network model configured to take as input corrective film pattern information and output a corresponding wafer shape transformation information, and an inverse model including an optimizer algorithm configured to take as input a wafer shape transformation information and output a corresponding corrective film pattern information, wherein, to output the corresponding corrective film pattern information the optimizer algorithm is configured to: for a film thickness, determine initial corrective film pattern information and subsequent corrective film pattern information based at least in part on a shape image of an input of wafer shape transformation information, for each of the initial corrective film pattern information and subsequent corrective film pattern information provide the initial corrective film pattern information or subsequent film information to the forward model to receive the corresponding wafer shape transformation information; and determine an optimizer loss associated with a difference between the wafer shape transformation information output from the forward model and the wafer shape transformation input to the optimizer, and output optimized film pattern information associated with the transformation information output from the forward model with a minimized optimizer loss; wherein, the surrogate model is configured to: provide a plurality of film thicknesses to the optimizer, provide the optimized film pattern information output by the optimizer for each of the plurality of film thicknesses to the forward model, and output final film pattern information associated with a minimized error between the output wafer shape transformation of the inverse model for each of the plurality of film thicknesses and the target wafer shape transformation provided to the surrogate model; and receiving, from the surrogate machine learning model, the final film pattern information associated with the warpage signature.

In another aspect, a system for generating corrective film patterns for semiconductor wafers is described. The system can include: one or more sensors configured to measure a warpage signature of a semiconductor wafer including a two dimensional height map; a memory storing the warpage signature; one or more processors; and non-transitory computer readable storage media storing instructions that when executed by the one or more processors, cause the one or more processors to: receive a warpage signature of a semiconductor wafer including a two dimensional height map; determine a target wafer shape transformation information based on the warpage signature; provide the target wafer shape transformation information to a surrogate machine learning model, wherein the surrogate machine learning model includes: a forward model including a neural network model configured to take as input corrective film pattern information and output a corresponding wafer shape transformation information, and an inverse model including an optimizer algorithm configured to take as input a wafer shape transformation information and output a corresponding corrective film pattern information, wherein, to output the corresponding corrective film pattern information the optimizer is configured to: for a film thickness, determine initial corrective film pattern information and subsequent corrective film pattern information based at least in part on a shape image of an input of wafer shape transformation information, for each of the initial corrective film pattern information and subsequent corrective film pattern information provide the initial corrective film pattern information or subsequent film information to the forward model to receive the corresponding wafer shape transformation information; and determine an optimizer loss associated with a difference between the wafer shape transformation information output from the forward model and the wafer shape transformation input to the optimizer, and output optimized film pattern information associated with the transformation information output from the forward model with a minimized optimizer loss; wherein, the surrogate model is configured to: provide a plurality of film thicknesses to the optimizer, provide the optimized film pattern information output by the optimizer for each of the plurality of film thicknesses to the forward model, and output final film pattern information associated with a minimized error between the output wafer shape transformation of the inverse model for each of the plurality of film thicknesses and the target wafer shape transformation provided to the surrogate model; and receive, from the surrogate machine learning model, the final film pattern information associated with the warpage signature.

In another aspect, non-transitory computer readable storage media is described. non-transitory computer readable storage media can store instructions that when executed by a system of one or more processors, cause the one or more processors to: receive a warpage signature of a semiconductor wafer including a two dimensional height map; determine a target wafer shape transformation information based on the warpage signature; provide the target wafer shape transformation information to a surrogate machine learning model, wherein the surrogate machine learning model includes: a forward model including a neural network model configured to take as input corrective film pattern information and output a corresponding wafer shape transformation information, and an inverse model including an optimizer algorithm configured to take as input a wafer shape transformation information and output a corresponding corrective film pattern information, wherein, to output the corresponding corrective film pattern information the optimizer is configured to: for a film thickness, determine initial corrective film pattern information and subsequent corrective film pattern information based at least in part on a shape image of an input of wafer shape transformation information, for each of the initial corrective film pattern information and subsequent corrective film pattern information provide the initial corrective film pattern information or subsequent film information to the forward model to receive the corresponding wafer shape transformation information; and determine an optimizer loss associated with a difference between the wafer shape transformation information output from the forward model and the wafer shape transformation input to the optimizer, and output optimized film pattern information associated with the transformation information output from the forward model with a minimized optimizer loss; wherein, the surrogate model is configured to: provide a plurality of film thicknesses to the optimizer, provide the optimized film pattern information output by the optimizer for each of the plurality of film thicknesses to the forward model, and output final film pattern information associated with a minimized error between the output wafer shape transformation of the inverse model for each of the plurality of film thicknesses and the target wafer shape transformation provided to the surrogate model; and receive, from the surrogate machine learning model, the final film pattern information associated with the warpage signature.

In another aspect, a method of supervised training a surrogate machine learning model for generating corrective film patterns to reduce warpage of semiconductor wafers during manufacturing of integrated circuit devices is described. The method can include: receiving a training data set including: a set of target wafer shape transformation information including negatives of warpage signatures of semiconductor wafers, and a set of training corrective film pattern information to reduce warpage signatures of semiconductor wafers; providing the surrogate machine learning model including: a forward model including a first neural network model configured to take as input corrective film pattern information and output a corresponding wafer shape transformation information, and an inverse model including a second neural network model configured to take as input a wafer shape transformation information and output a corresponding corrective film pattern information, wherein the corrective film pattern information output by the inverse model includes a film shape constructed using a predetermined shape function other than Zernike polynomials; training the forward model using the set of corrective film pattern information; training the inverse model using the set of wafer shape transformation information and the wafer shape transformation information determined by the trained forward model, wherein training the inverse model includes using parameters other than Zernike coefficient to construct the film shape; and continuing to train the surrogate machine learning model until a difference between output from the forward model and input to the inverse model reaches below a predetermined value.

### BRIEF DESCRIPTION OF THE DRAWINGS

Embodiments of this disclosure will be described, by way of non-limiting examples, with reference to the accompanying drawings.

FIGS. 1A, 1B, 1C show processing flow diagrams of an embodiment of the invention. The different arrow styles indicate different information flow. Thick solid arrows indicate the movement of physical wafers in a semiconductor fab. The thin solid arrows indicate transfer of two-dimensional (“2D”) array data, such as datasets of film patterns and wafer shape transformations. The dashed arrows indicate transfer of model parameter information, such as Zernike coefficients or machine learning model weights and biases.

FIG. 2 illustrates the linear elasticity problem as solved using FEM according to an embodiment of the invention.

FIG. 3 shows example results from film pattern optimization according to an embodiment of the invention.

FIG. 4 shows the impact of training dataset size on the validation error according to an embodiment of the invention.

FIG. 5 shows details of a surrogate model architecture according to an embodiment of the invention.

FIG. 6 shows a UNet architecture of forward component of surrogate model according to an embodiment of the invention.

FIG. 7 shows a Zernike CNN inverse model architecture according to an embodiment of the invention.

FIG. 8 shows an example of a film pattern and residual bow prediction, for the task of taking an input wafer bow signature and flattening the wafer, according to an embodiment of the invention.

FIG. 9 shows a schematic view of a system for training and implementing a surrogate machine learning model, according to various embodiments.

FIG. 10 illustrates and example corrective film pattern, according to various embodiments.

FIG. 11 is a chart depicting a Mahalanobis distance compared to a training data set.

FIGS. 12A and 12B are exemplary processes used in supervised training of a surrogate machine learning model.

FIG. 13 is an exemplary process of generating corrective film patterns to reduce warpage of semiconductor wafers during manufacturing of integrated circuits.

FIG. 14 illustrates an example film pattern generated by a surrogate model implemented with and without a Mahalanobis penalty and experimental results of film distributions generated by a surrogate model implemented with and without a Mahalanobis penalty compared to a film distribution used to train the surrogate models.

FIG. 15A is a schematic cross-sectional view of a semiconductor wafer illustrating an example warpage signature with a total bow, which includes a first order bow (FOB) component and a higher order bow (HOB) component, according to various embodiments.

FIG. 15B is a schematic cross-sectional view of a semiconductor wafer illustrating an example higher order bow (HOB) component of a warpage signature, according to an embodiment.

FIG. 16 illustrates an example modified forward model, according to an embodiment.

FIG. 17 illustrates an example determination of a first order bow (FOB) magnitude and a higher order bow (HOB) magnitude using the modified forward model, according to an embodiment.

FIG. 18 illustrates an example modified inverse model, according to an embodiment.

FIG. 19 illustrates an inference pipeline for suggesting a correction film and predicted bow using a modified trained forward and inverse models, according to various embodiments.

FIG. 20A is an example process used in training of a forward model of a surrogate machine learning model, according to various embodiments.

FIG. 20B is an example process used in training of an inverse model of a surrogate machine learning model, according to various embodiments.

FIG. 21 is an example process of generating corrective film patterns to reduce warpage of semiconductor wafers during manufacturing of integrated circuits, according to various embodiments.

FIG. 22 illustrates a difference in a higher order bow (HOB) shape generated by an unseparated forward model and HOB shape generated by a modified (e.g., separated) forward model and experimental results of film distributions generated by the separated and unseparated forward models.

FIG. 23 illustrates an example flow diagram for suggesting a corrective film using a trained forward model and an optimizer, according to various embodiments.

FIG. 24 is an example process of generating corrective film patterns to reduce warpage of semiconductor wafers during manufacturing of integrated circuits, according to other various embodiments.

FIG. 25 illustrates an example of a parameterized inverse model, according to an embodiment.

FIG. 26 illustrates example function and HOB shape parings that can be used to train an inverse model.

### DETAILED DESCRIPTION

### Definitions of Terms

Wafer bow signature (also referred to as the “wafer bow” or “warpage signature”): The height (z) of a semiconductor wafer for each horizontal position on the wafer. A wafer may be bowed due to various stresses accumulating during fabrication. The coordinate system to define a wafer bow signature can be parameterized and standardized to give a unique description. First, raw shape metrology data can be obtained, which can define a z position across the wafer with center at (x, y)=(0, 0). Then, the z data can be fit using parameter representations of the wafer bow (e.g., using Zernike polynomials, as described below). Then tilt can be removed by subtracting the Z₁¹ and Z₁⁻¹ modes from the shape. Then, minimum z is subtracted so that all z values are positive with minimum height of 0. Throughout this document we use “wafer bow signature” to refer to the wafer bow prior to deposition of a corrective film pattern.

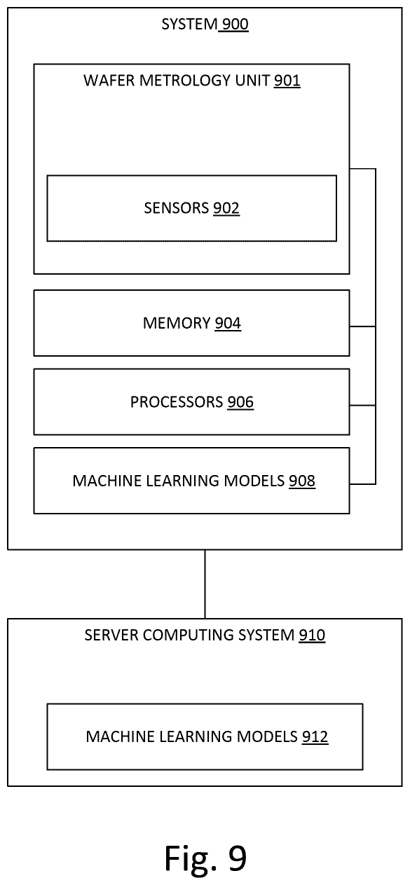

Corrective film pattern: A corrective film pattern is a pattern of a corrective film applied onto a wafer in order to modify the wafer bow signature. A pattern can be achieved by deposition of a uniformly thick film, then removing, e.g., selectively etching away, portions of the film, leaving parts of the original film in place. Because the density of the etched away areas of the pattern can vary across the surface, the average percent area covered by the film in localized regions can be a function of position on the surface of the film. For example, a 1 mm square region in one position on the surface may have 50% coverage by etching away 20 μm squares within the region to form a checkerboard where half of the 20 μm squares are etched away and half remain. Another 1 mm square region in another position on the surface may have 75% coverage by etching away a quarter of the squares. The corrective film can be applied on the front side or the back side of the wafer, and can be temporary or permanent. An example of a corrective film pattern is illustrated in FIG. 10.

Wafer shape transformation: The target change in wafer bow signature to negate the wafer bow signature, e.g., by deposition of a corrective film pattern. The wafer shape transformation can be the shape transformation that will make the wafer flat, which is the negative of the wafer bow signature prior to deposition of a corrective film pattern. However, other wafer shape transformation may be used. For example, the wafer shape transformation can be a shape to reduce higher order bow and/or minimize overlay error directly could be employed.

Residual bow: The height (z) of a semiconductor wafer for each horizontal position on the wafer after deposition of a corrective film pattern to modulate the wafer bow. The data preprocess to obtain a unique shape is analogous to that described for wafer bow signature.

Linear elasticity problem: A structural analysis problem where the linear elasticity mathematical model is assumed, i.e. strain (deformation) of an elastic object is proportional to applied stress. An elastic object is an object that would return to its original shape if the stress was removed (in contrast to yielding).

Neural network: a machine learning model formed by an arrangement of nodes and activation functions that can learn a nonlinear function between inputs and outputs.

Finite element method (“FEM”): A numerical approximation method for solving partial differential equations for two dimensional (“2D”) and three dimensional (“3D”) problems used in many engineering domains.

Optimization framework: a strategy to find a solution for the inverse of an FEM simulation by parameterizing a corrective film pattern with Zernike polynomials, and using an optimization algorithm to identify a suitable film pattern.

Active learning feedback: Using a machine learning model to choose a batch of unlabeled data points that would give maximum improvement to the neural network if they were labeled. Then labeling these data points (either using a simulator or experiments), and providing results to the neural network for improvement.

### Linear Elasticity and Wafer Bow

When a force is applied to a wafer and the wafer will often deform. The deformation can depend on the direction and magnitude of the applied forces as well as the geometry and material properties of the wafer. When considering infinitesimal strains on the wafer, with an assumption of a linear relationship between stress and strain, then the wafer constitutive equation can be approximated by Hooke's law, shown in equation (1):

$$σ = C ϵ \qquad ( 1 )$$

where σ is a Cauchy stress tensor, ϵ is a strain tensor and C is a fourth-order stiffness tensor. A strain-displacement relation can be expressed by equation (2):

$$ϵ = \frac{1}{2} [ ∇ u + {( ∇ u )}^{T} ] \qquad ( 2 )$$

where u is a displacement vector describing the change in position due to stress. If the wafer is at steady-state, the equation of motion can be expressed by equation (3):

$$∇ \cdot σ + F = 0 \qquad ( 3 )$$

where F is a body force per unit volume. For isotropic materials, the constitutive equation relating stress σ and strain ϵ can simplify and can depend on two scalar material properties, Young's modulus E and Poisson's ratio v. This is a linear, second order, elliptic partial differential equation in three dimensions, and there exists an analytical solution for the wafer bow problem only in very simple scenarios, such as the simple scenario where the Stoney equation is valid.

The Stoney equation, which relates the magnitude of the stress in the corrective film with the system curvature, is shown in equation (4):

$${σ}^{f} = \frac{{E}_{s} {h}_{s}^{2} κ}{6 {h}_{f} ( 1 - {v}_{s} )} \qquad ( 4 )$$

where σ^{ƒ} is a film stress, Eₛ is a Young's modulus of the substrate, vₛ is a Poisson's ratio of the substrate, h_{ƒ} and hₛ are a thickness of the film and substrate respectively, and κ is a curvature of the system. Several more sophisticated extensions to the Stoney model that relax some of the assumptions of the Stoney model, yet none are sophisticated enough to be valid for the real wafer bow problem with a non-uniform film. Although the Stoney equation and its extensions offer convenient analytical tools to build a qualitative view on how a film will stress and bow a wafer substrate, the real wafer bow problem violates many of the assumptions used by these models, and thus a computational approach to approximate the solution to the above partial differential equation may be used.
Solving Linear Elasticity Problem with FEM

Since the solution to the above partial differential equation for the sophisticated case of the bowed wafer problem can be complex and/or unsolvable, computational methods can be used to produce an approximate solution. Finite Element Method (FEM) is a powerful tool for solving partial differential equations in three dimensions for an arbitrary domain shape. A brief review of an FEM approximate solution is shown below. A basic form of the partial differential equation above is shown in equation (5):

$$- ∇ \cdot ( c ∇ u ) = f on domain Ω \qquad ( 5 )$$

By multiplying by test function v and integrating over domain Ω, equation (5), differential (strong) form in converted into equation (6), an integral (weak) form:

$$\begin{matrix}{\int }_{Ω} ( - ∇ \cdot ( c ∇ u ) - f ) v d Ω = 0 & ∀ v\end{matrix} \qquad ( 6 )$$

Two boundary conditions, a Dirichlet boundary condition u=r on ∂Ω_{D} and a Neumann condition on the boundary ∂Ω_{N}, can be applied. By applying Green's rule (integration by parts) and the boundary conditions we can rewrite equation (6) as equation (7):

$$\begin{matrix}{\int }_{Ω} ( c ∇ u \cdot ∇ v ) d Ω + {\int }_{\partial Ω} ( - c ∇ u ) \cdot nv d \partial Ω - {\int }_{Ω} fv d Ω = 0 & ∀ v\end{matrix} \qquad ( 7 )$$

The test function v and solution u belong to Hilbert spaces (an infinite dimensional function space). One component of the weak formulation is that it can hold for all test functions in the Hilbert space. Following the Galerkin method formulation, it can be assumed that the solution u belongs to the same Hilbert space as the test functions, then an approximate solution uₕ≈u in a finite-dimensional subspace of the Hilbert space can be used. The approximate solution can be expressed as a linear combination of a set of basis functions ϕᵢ in that subspace, shown in equation (8):

$${u}_{h} = {\sum }_{i} {u}_{i} {ϕ}_{i} \qquad ( 8 )$$

A discretized version of the above integral equation can become equation (9) for every test function ϕᵢ.

$${\sum }_{i} {u}_{i} {\int }_{Ω} ( c ∇ {ϕ}_{i} \cdot ∇ {ϕ}_{j} ) d Ω + {\sum }_{i} {\int }_{\partial Ω} ( - {cu}_{i} ∇ {ϕ}_{i} ) \cdot n {ϕ}_{j} d \partial Ω - {\int }_{Ω} f {\sum }_{i} {u}_{i} {ϕ}_{j} d Ω = 0 , \qquad ( 9 )$$

With n number of test functions, there can be n unknown coefficients uᵢ needed to attain the approximate solution uₕ. After the system is discretized and boundary conditions are applied, the above equation simplifies to Auᵢ=b, where A is an n×n matrix and b is a vector with length n, where both can be determined by simplifying the discretized equation (9) with n test functions and n uᵢ coefficients. The Auᵢ=b form can be solved with an appropriate solver for linear or non-linear problems.

In summary, finite element analysis allows one to take a system governed by a partial differential equation (here linear elasticity in three dimensions), then discretize the problem into elements to find an approximate solution by solving a linear set of equations. The finer the mesh, the greater the number of basis functions and the closer the approximate solution can be to the real solution.

### Neural Networks Background

Neural Networks can be general frameworks that arrange units or nodes in a pre-defined architecture to create a complex non-linear relationship between inputs and outputs. Each neural network has both an input and output layer where the layer shape is dictated by the input and output type. One example of a neural network is a fully connected, feed-forward network with hidden layers in addition to input and output layers (called a multi-layer perceptron). Values at each node are propagated to nodes in subsequent layers with an activation function that is parameterized with weights and biases. The hidden layers are not directly connected to inputs and outputs but are included to automatically extract features from the input layer which aid in output determination. In the process of training, a neural network is exposed to many labeled examples, or input examples where the correct output is known. In a training iteration, gradient calculations and backpropagation can modulate the weights and biases of each node to improve a predetermined loss function. After training, the weights and biases can remain fixed, and the network can perform inference on unseen data using the non-linear function learned in training.

Certain input and output types can benefit from more sophisticated network architectures than the simple multi-layer perceptron. For example, with a two-dimensional array of input data (such as an image), convolutions are typically used to extract features. In a convolutional neural network, filters can be used to transform 2D input data into feature maps with various channels. Multiple convolution layers can be employed to make feature maps from preceding feature maps, and a fully connected output architecture can be used to determine outputs from the final feature map layer. A convolutional neural network can be thought of as a regularized multi-layer perceptron; instead of each input pixel being fully connected to every node in the next layer, convolutions are used to extract features from an arrangement of the pixel with neighboring pixels.

### Zernike Polynomials

Zernike polynomials are a sequence of polynomials used to describe surfaces in a circular domain, developed originally for applications in optics. There are even and odd Zernike polynomials, where even polynomials are given by equation (10):

$${Z}_{n}^{m} ( r , θ ) = {R}_{n}^{m} ( r ) cos ( m θ ) \qquad ( 10 )$$

and odd Zernike polynomials are given by equation (11):

$${Z}_{n}^{- m} ( r , θ ) = {R}_{n}^{m} ( r ) sin ( m θ ) \qquad ( 11 )$$

$${R}_{n}^{m} ( r ) = {\sum }_{k = 0}^{\frac{n - m}{2}} \frac{{( - 1 )}^{k} ( n - k ) !}{k ! ( \frac{n + m}{2} - k ) ! ( \frac{n - m}{2} - k ) !} {r}^{n - 2 k} \qquad ( 12 )$$

where r is a radial position on a unit disk (0≤r≤1), θ is a azimuthal angle, m and n are non-negative integers unique to a particular Zernike polynomial and Rₙ^{m}(1)=1. Zernike polynomials can be used to parameterize a general wafer shape to describe wafer bow signatures, target wafer shape transformations, or residual bow. A general wafer shape can be defined as shown in equation (13):

$${u}_{z} ( r , θ ) = {\sum }_{a = 0}^{N} {c}_{a} {Z}_{n}^{m} \qquad ( 13 )$$

where a is an index of each Zernike polynomial (i.e., a=0, 1, 2, 3, 4, 5 . . . correspond to (n, m)=(0, 0), (−1,1), (1,1), (−2,2), (0,2), (2,2) . . . respectively). The coefficient cₐ represents a Zernike coefficient for each polynomial. Thus, an arbitrary wafer shape can be represented using the above general equation, and as N becomes larger the error between the true shape and the Zernike representation will decrease. Using the Zernike representation, a general wafer shape can be expressed in a parameterized way with N coefficients cₐ. Generally, wafer shapes are smooth, and a sufficient shape approximation can be obtained with an N of 20-50, however a higher or lower value of N may be used.

### Overview

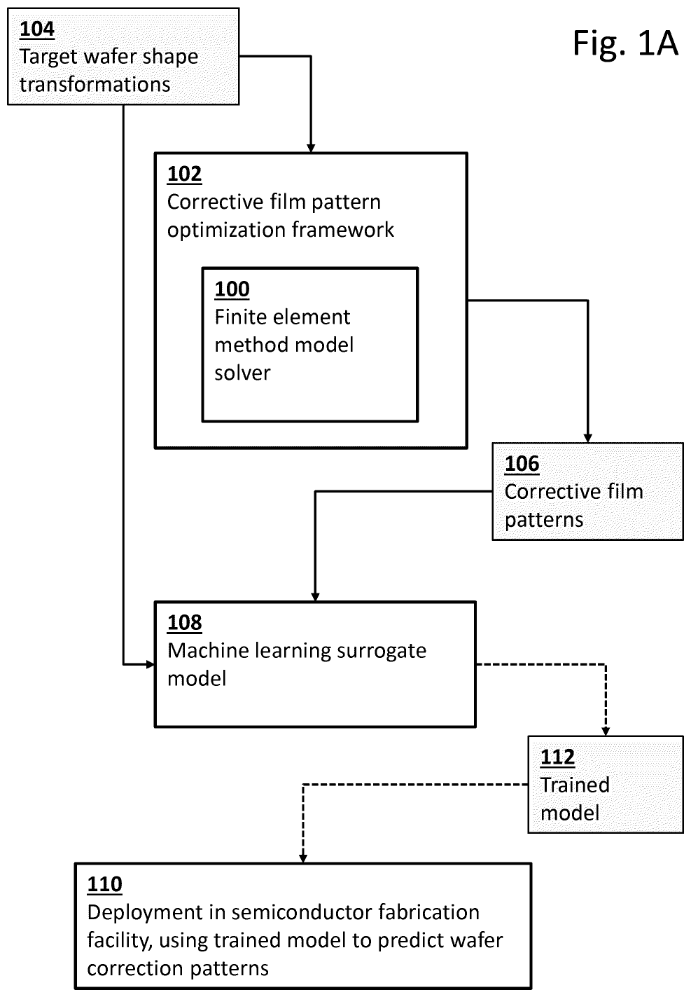

Embodiments of the disclosure provide a process utilizing a finite element method (FEM) along with machine learning to optimize the corrective film pattern with a computation time relevant for on-line deployment. FIGS. 1A, 1B, 1C show processing flow diagrams, according to various embodiments. The thick solid arrows indicate the movement of physical wafers in a semiconductor fab. The thin solid arrows indicate transfer of 2D array data, such as datasets of film patterns and wafer shape transformations. The dashed arrows indicate transfer of model parameter information, such as Zernike coefficients or machine learning model weights and biases. In the illustrated embodiment outlined in FIG. 1A, an FEM model solver 100 is built to solve the linear elasticity problem for the appropriate wafer and film geometry used in a particular semiconductor fabrication process step. A corrective film pattern optimization framework 102 is built on top of this FEM model solver 100 to optimize for the corrective film pattern that can result in the greatest reduction in wafer bow. This FEM model and optimization framework can be used to generate the corrective film patterns 106 from a dataset of corresponding target wafer shape transformations 104. The dataset generation can be accomplished by a simulation engineer using standard central processing unit. Dataset generation can be parallelized. In some embodiments, the dataset is generated, at least in part, by scanning, using one or more sensors, the wafer bow signature of a set of wafers. The corrective film patterns may be determined (e.g., using a simulation and/or optimizer, such as the corrective film patter optimization framework illustrated in FIG. 1B) from the sensed wafer bow signatures. In some embodiments, the wafer bow signature may be determined using metrology equipment and/or other equipment used in semiconductor fabrication or semiconductor inspection.

The dataset 106 can be used together with the dataset of target wafer shape transformations 104 to train a neural network in a machine learning surrogate model 108. Training the surrogate model 108 can benefit from graphical processing unit acceleration, so hardware that supports deep learning with graphical processing unit can be used. The surrogate model 108 can define a general model architecture, layer shapes, and hyperparameters, while the trained model 112 represents an instance of the surrogate model with the specific model weights that minimize the difference between predicted and actual wafer shape transformations (for the forward model) or minimize the residual wafer bow (for the compiled model). For example, in some instances, the surrogate model 108 may be trained using a system with a relatively large amount of processing, such as using a server and the trained model 112 may be a instance of the surrogate model 112 on and/or implemented by a specific device, such as a semiconductor fabrication and/or semiconductor inspection device.

This trained model 112 can be delivered to and deployed in a semiconductor fabrication facility 110 where it can be used to perform the same optimization task as the optimization framework, but in a small fraction of the computation time. The computing system used for this last step can include hardware that can integrate with the tools in the fabrication and have graphical processing unit capabilities for the retraining steps. While FIG. 1A illustrates a deployment to a semiconductor fabrication facility, it should be understood that other applications of the trained model 112 can occur. For example, the trained model 112 may be used in a semiconductor inspection system and/or any other application where determining corrective film patterns may be desirable. The trained model 112 may be integrated into semiconductor fabrication or inspection equipment, such as in software stored and/or installed in the equipment.

In some embodiments, the trained model 112 may be retrained during deployment using a validation dataset of physical wafers (not simulated) to learn any data distribution shift between the simulated and actual wafer shape transformations. A specialized active learning approach can be used to optimally choose validation sample points for this retraining step. Further, an on-line retraining scheme can be used to further reduce wafer bow or overlay error and account for any data drift.

In some embodiments, the corrective film pattern optimization framework 102 and the finite element solver can be used to determine the dataset 106 from the set of target wafer shape transformations, shown in more detail in FIG. 1B.

### FEM Simulations for Wafer Bow

As described above, a linear elasticity partial differential system of equations can be solved using FEM. According to various embodiments, the FEM model solver 100 can take a non-uniform film pattern 120, solve the linear elasticity partial differential equations 122 to determine the stresses that applying such a corrective film has on a wafer, then determine the wafer shape transformation 124 undergone by the wafer due to those stresses. The wafer and corrective film can be modeled as a disk with non-uniform film, and the film stress can be modeled by defining a temperature change and setting the coefficient of thermal expansion offset by calibrating to known uniform film stress using Stoney's equation. The maximum film thickness in the simulation can be set using the full thickness of the printed corrective film, and the thickness pattern of corrective film across the wafer in the simulation can be defined to replicate the percent coverage pattern of printed corrective film. The film can be discretized using a matrix and a smooth cubic interpolation function can be used on this discretized pattern to determine precise thickness at each node in FEM simulation. The matrix dimensions can be chosen based on the desired spatial resolution. For example, dimensions on the order of 10-100, 100-1000, or larger can be used. However, it should be understood, that in various circumstances, smaller or larger dimensions than those described may be used.

As discussed above, in finite element analysis (FEA) an approximate solution to a partial differential equation can be obtained by discretizing the domain into finite elements. The mesh can be obtained using Delaunay triangulation, and second order (quadratic) elements can be used (e.g., with nodes located at both vertices and edge midpoints of each tetrahedra). The target maximum and minimum element lengths can be set to obtain a structure with ˜10,000 elements. The number of elements can be increased to reduce the approximation error up until the memory constraint of the hardware used.

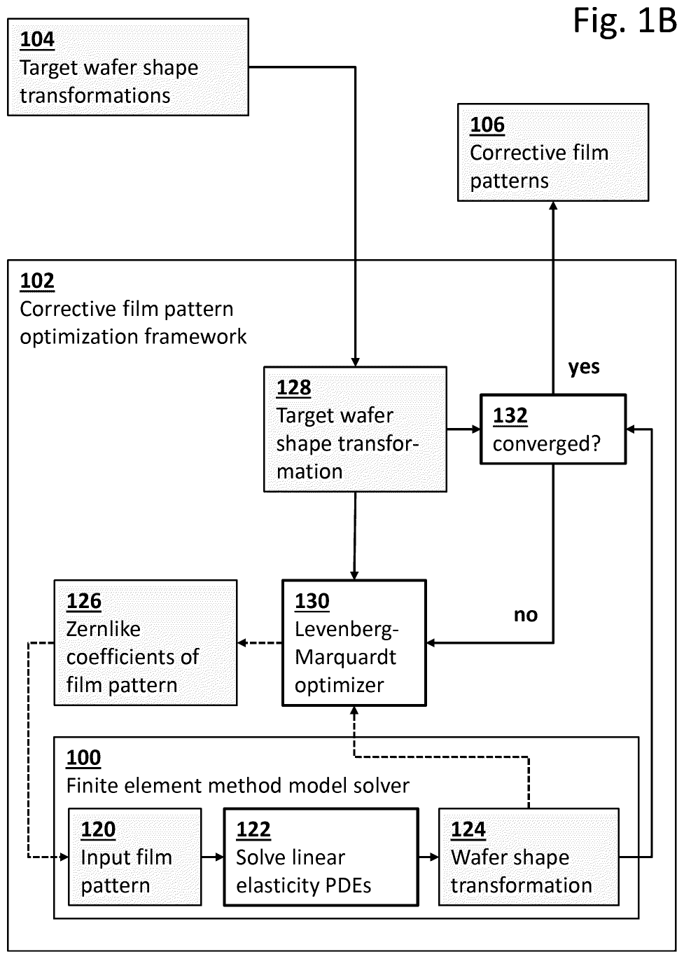

FIG. 2 illustrates a meshed representation 200 of a wafer disk with a thin film coating. Also shown is a plot of in-plane displacement (the magnitude of the position change in the z=0 plane) as a function of position 202 for an example wafer bow signature (Z exaggeration by 1000×).

A FEA system can be specified using the partial differential equation system described above. A single Dirichlet boundary condition can be provided at a point, uₓ(0,0)=0; u_{y}(0,0)=0; u_{z}(0,0)=0, and the Neumann condition can be determined from the thermal boundary load (by defining a thermal expansion coefficient offset between the wafer and corrective film). A nonlinear solver employing the Gauss-Newton iteration scheme can solve the FEM system and give an approximate result. Note that specifying only a point Dirichlet condition can lead to an infinite solution set because the solution could be tilted in an arbitrary direction. We account for this and provide a unique solution by tilting the solution until the cₐ coefficients for the Z₁⁻¹ and Z₁¹ modes are precisely zero.

The FEM model can incorporate knowledge from the specific silicon wafer used and information about the corrective film. The stiffness tensor C can use published material properties for the silicon crystal structure of interest, (e.g. c-Si(100) or c-Si(111)). Note that the wafer crystal structure is cubic and thus has anisotropic structural behavior, and the stiffness tensor can be described with three parameters (rather than simply the elastic modulus and Poisson's ratio as in isotropic materials). The wafer dimensions (thickness and radius) can be specified based on the wafer used in the process of interest. Also, the corrective film stress value can be specified using the corrective film of interest in the process. The stress value can be calibrated using an experiment with deposition of a uniform film at several known thicknesses and defining the temperature difference-coefficient of thermal expansion product that achieves the measured wafer bow. Finally, the printable area can be specified using the limitations of the corrective film deposition tool (e.g., using a region near the perimeter of the wafer where it is not feasible to deposit corrective film).

### Corrective Film Pattern Optimization Framework

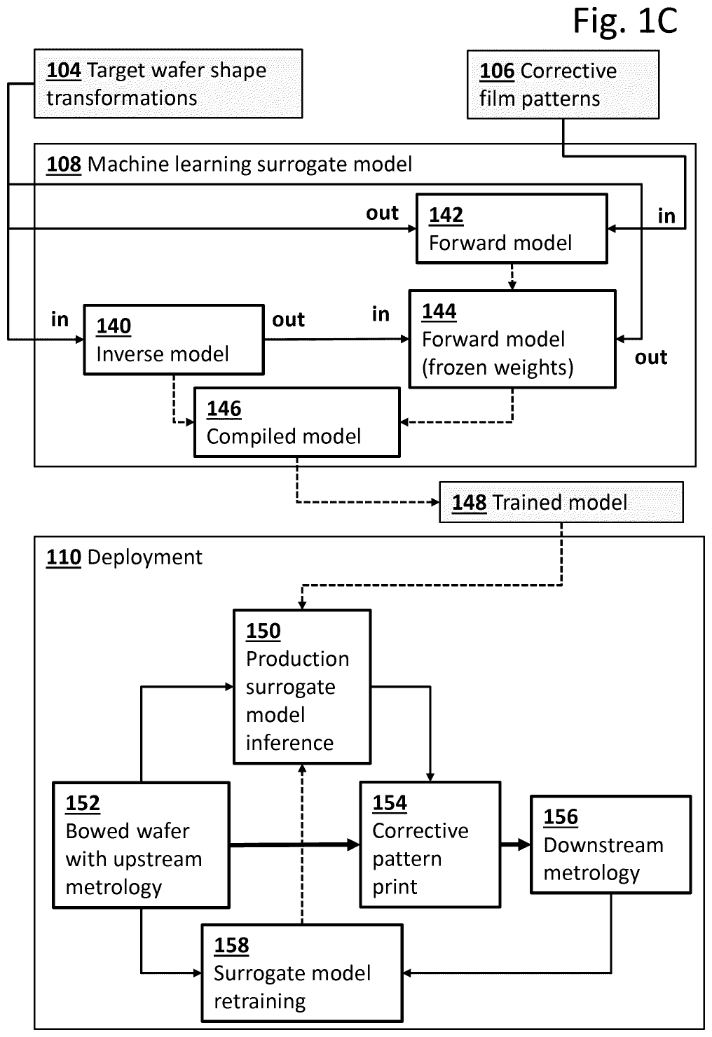

The corrective film pattern optimization framework 102 can be built on top of an FEM solver 100, as shown in FIG. 1B. The optimization framework can take a dataset of wafer shapes 104 as input. For each target wafer shape transformation 128 in dataset 104, the optimization framework can find the best corrective film pattern (parameterized by Zernike coefficients 126) as predicted by the FEM solver 100 that will achieve this shape transformation. In this way, the optimization framework generates from the dataset 104 of wafer shape transformations a dataset 106 of corresponding corrective film patterns. The target wafer shape transformation 128 can be the transformation that will minimize total wafer bow (negative of the wafer bow signature prior to corrective film deposition), or a shape transformation known to minimize overlay error. While the corrective film pattern is illustrated as parameterized using a defined number of Zernike polynomials 126, other parametrization can be used. However, for simplicity, parameterization using Zernike polynomials is used in description. For the defined number of Zernike polynomials 126, the cₐ coefficients are the parameters defining the corrective film pattern. The framework can check in block 132 if the current predicted wafer shape transformation 124 from the FEM solver 100 has converged sufficiently close to the target shape transformation 128. The cost function to minimize during the optimization can be defined as the absolute difference between the target shape transformation 128 and the shape transformation achieved with the predicted wafer shape transformation 124. The Zernike coefficients input to the FEM solver 100 can be optimized using the Levenburg-Marquardt algorithm 130, though other suitable optimizers may be used. After each iteration of the algorithm, the resulting wafer shape transformation difference cost function can be evaluated using the present film pattern. If the cost function has converged within acceptable criteria, the optimizer stops and the current film pattern (e.g., the film patter with the current Zernike polynomials 126) is saved in the dataset of corrective film patterns 106, with an index corresponding to a wafer shape in 104. Otherwise, the Zernike coefficients are modified as dictated by the Levenberg-Marquardt algorithm and the optimizer continues. An example result is presented in FIG. 3, which shows an initial target wafer shape transformation 300, input wafer shape transformation with first order bow component subtracted 302, and film pattern solution returned by film pattern optimization 304.

### Training Dataset Generation

The optimization framework 102 described above is one strategy to generate a dataset that is used to train the surrogate model 108. More generally, the training dataset can be a) generated from real wafer measurements, b) generated from FEM wafer bow simulations, c) generated using the corrective film optimization framework 102 and/or d) otherwise generated. For (a) and (b), a list of film patterns can be generated and/or given. In some embodiments, the film patterns may be generated randomly using a Zernike coefficient basis and could have some bias towards the film patterns most likely to be employed during production. The advantage of (a) is that the data distribution will more closely resemble that of production. However, obtaining a large enough dataset to train the deep surrogate model from scratch using only experimental data may be infeasible in some instance, so strategy (b) and/or (c) may be used to supplement the dataset or make up the dataset entirely.

In some instances, datasets generated using strategies (a) and (b) may not enumerating the space of possible wafer shape transformations directly; instead the possibilities may be sampled in “inverse space”, or in the film pattern space. Strategy c) allows target wafer shape transformations to be specified directly, which could also be accomplished using a random distribution of Zernike coefficients with bias toward the shape transformations most likely to be required in production. For example, if 20 Zernike polynomials are used and the Levenberg-Marquardt algorithm takes on average 10 iterations to converge, strategy c) may take ˜200 times as long to generate a dataset of the same size as strategy b).

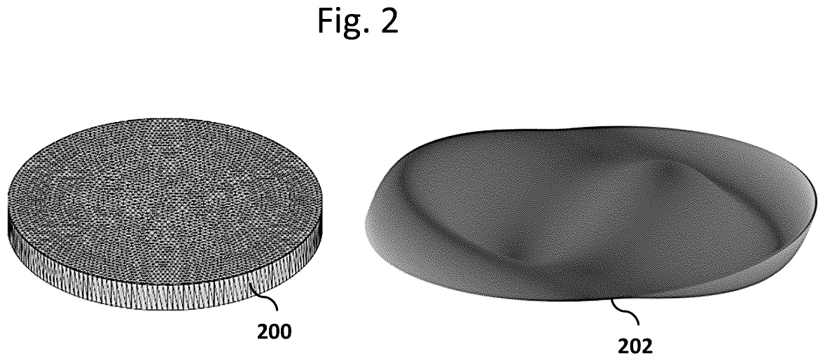

A train-validation-test split strategy may be used to estimate the performance of the surrogate model on unseen data. FIG. 4 illustrates evaluation results for validation error for various dataset sizes for a forward model (predicting wafer bow from film pattern) of the surrogate model. Graphs 400, 402, 404, 406, 408, 410 show the validation error vs epoch for training sizes of 125, 250, 500, 1000, 2000, 4000, respectively. For this task, a training dataset of ˜4000 allows for a mean absolute percentage error of less than 1%, while the surrogate model overfits to the training data when a dataset size of <1000 is used. The train-validation strategy gives confidence that the model will generalize well to unseen data. However, the training dataset should be chosen with care such that all examples expected to be observed in production will come from the same distribution. If the training set contains wafers with first order bow of 100-500 μm and maximum absolute higher order bow of 0-30 μm, then it would perform well on wafer examples within the ranges (even if the exact shape has not been observed previously), yet it may perform poorly on corrections for wafers that have bow signatures that fall well outside of these ranges.

In some embodiments, a dataset may be generated by combining two or more of the above approaches. For example, a dataset containing corrective film patterns and corresponding wafer shape transformations from the simulation (either in strategy (b) or (c)) can be used to initially train the surrogate model from scratch. Then, a smaller “validation dataset” of real wafers can be used to understand the differences between the real and simulated scenarios. More details on how the validation dataset can be chosen to maximize performance for a limited dataset will be described in a later section below.

### Machine Learning Surrogate Model

FIG. 1C shows details of the machine learning surrogate model training 108 and deployment 110 of that trained model 112 in production (or another application, such as inspection and/or testing). The surrogate model employed can be a deep neural network based upon the convolutional neural network architecture discussed below, or another machine learning model. In the deployment 110, the input is a wafer bow shape at block 152, and the model 148 can be used to infer 150 the best corrective film 154 that will minimize overlay error when applied to the wafer shape. For example, in some instances, it may be desirable to make the wafer as flat as possible to reduce overlay error.

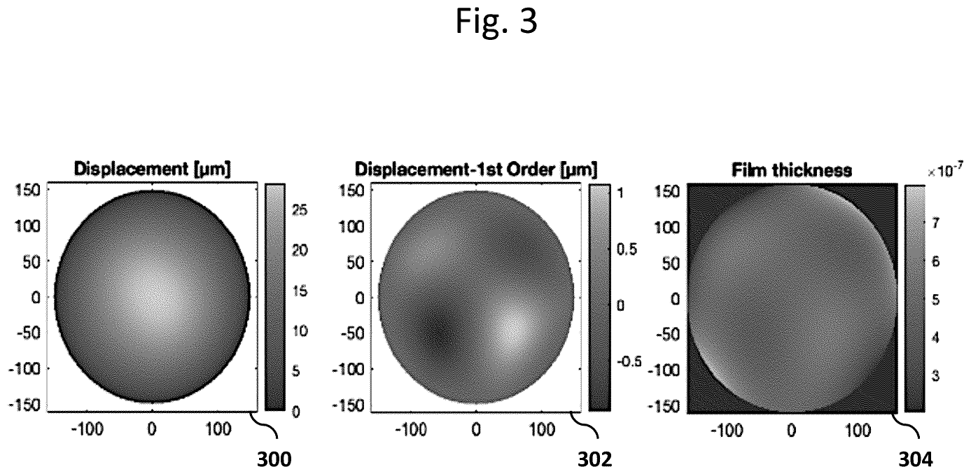

As FEM (or other) simulations can predict a wafer shape transformation based on a given corrective film, determining the corrective film from the target wafer shape transformation can be considered the inverse problem. As such, a model that can input a target wafer shape transformation, then output the corrective film pattern as well as the predicted actual shape transformation may be desirable. According to various embodiments, a model with an inverse model-forward model architecture is described. The model can have an inverse model 140 that determines film pattern as output based on wafer shape transformation input and one or more forward models 142, 144 that determine wafer shape transformation output based on the film pattern input. FIG. 5 provides additional details of a surrogate model architecture that can be used. The illustrated inverse model 500 uses a convolutional neural network 506 to output corrective film pattern 508 based on wafer shape transformation 504. The forward model 502 uses a convolutional neural network 510 to output wafer shape transformation 512 based on corrective film pattern 508.

Returning to FIG. 1C, during inference (e.g., in production), a target wafer shape transformation can be input to the surrogate model 150, where the target wafer shape transformation is simply the negative of the wafer bow signature measured in at block 152 (if the objective is to make the wafer flat). The measured wafer bow signature at block 152 may be measured and/or determined using one or more measuring systems or equipment. For example, the measured wafer bow signature may be received from one or more sensors of a device (e.g., metrology or other sensing equipment).

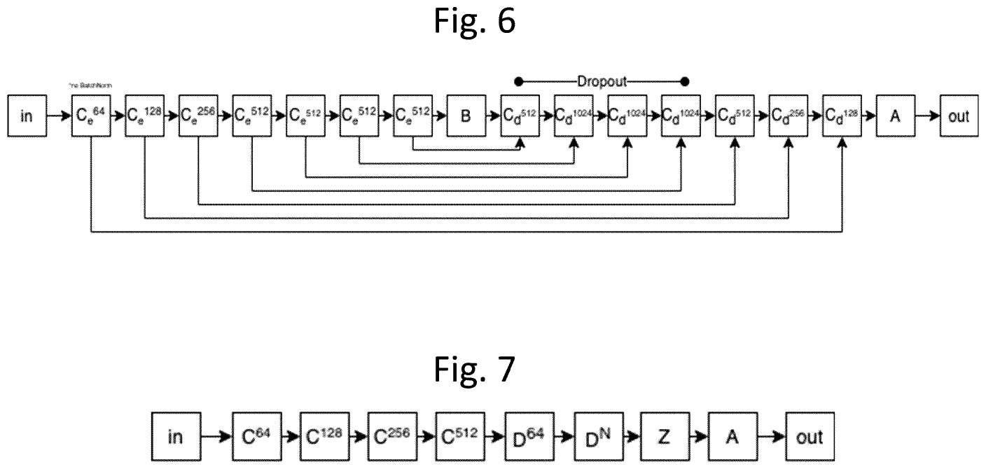

The model can return both the recommended corrective film pattern and the resulting shape transformation predicted upon application of that corrective film pattern. The corrective film pattern can then be used in the semiconductor process (e.g., the corrective film pattern may be used to apply a corrective film 154 (see FIG. 8.) to a semiconductor wafer). In some instances, there may be a residual bow after deposition of corrective film, which can be predicted from the difference between input and output shapes.

According to various embodiments, the forward models 142, 144 can use a convolutional UNet and the inverse model 140 can use a Zernike CNN. For illustration, both are described in detail below. However, other suitable machine learning models may be used in the surrogate model 108.

### Forward Model Details

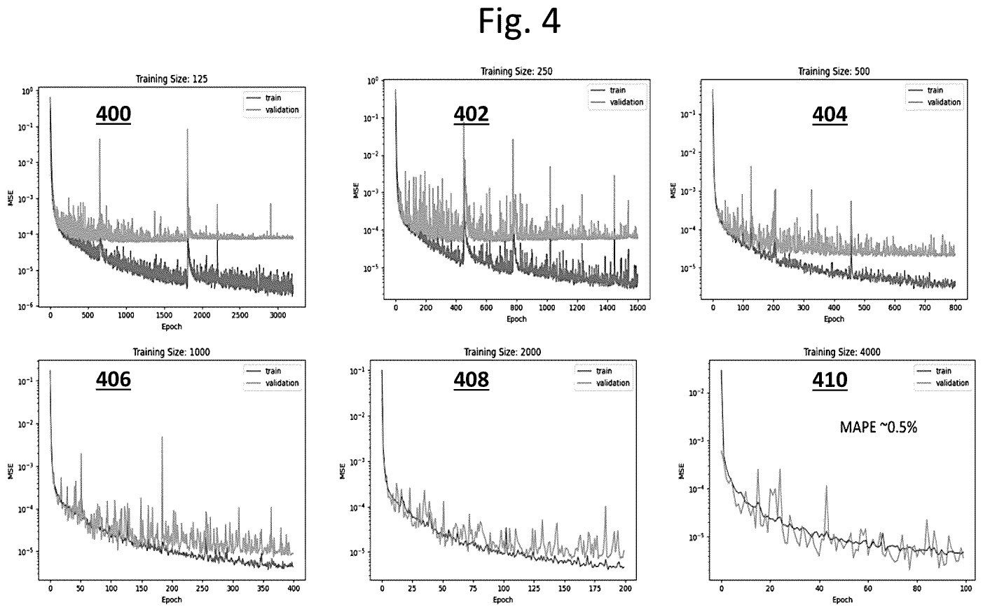

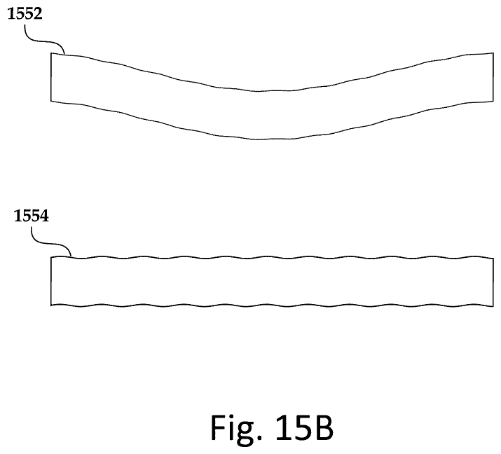

According to various embodiments, the architecture used for the forward model 142, 144 (predicting wafer shape transformation from film pattern) can be Zernike convolution neural network (see for example FIG. 16, 1602), a convolutional UNet (see for example, FIG. 5, 502), or other suitable machine learning architecture. This structure can be considered a specialized case of an encoder-decoder model where the encoder down-samples into the bottleneck and the decoder up-samples to the resulting output array. The encoder part can function similarly to a typical convolutional neural network (CNN) with a series of convolution operations to extract features from the inputs. FIG. 6 details the UNet architecture of the forward model in the surrogate model. As illustrated in FIG. 6 the UNet architecture can include symmetric skip connections at each layer which enable low frequency information to pass through from input to output. In the encoder/down-sampling section, in the first three layers the number of features is doubled each layer. In the decoder section, each step up-samples the feature map followed by an up-convolution to reduce the number of feature channels and then concatenates with the skip connection from its sibling layer in the encoder section. Collectively, the UNet architecture can yield faster training and better performance with smaller datasets than alternative architectures for many tasks including image-to-image translation and image segmentation.

As shown in FIG. 6, each of the encoder and decoder units is denoted with subscript “e” and “d” respectively. The encoder unit Cₑ⁶⁴ denotes a 2D convolution layer with 64 filters, kernel size of 4×4, stride length of 2 (in each dimension), followed by batch normalization and Leaky ReLU activation. Batch normalization (standardization of inputs to a layer by mini-batches during training) can be useful for deep neural networks as it can accelerate training (e.g., by preventing internal covariate shift) and provide some regularization (note that the very first encoder layer does not employ batch normalization). The decoder unit C_{d}⁵¹² denotes a transposed 2D convolution layer with 512 filters, kernel size of 4×4, stride length of 2, followed by batch normalization and ReLU activation. The first several decoder layers also employ dropout for further regularization. The B layer denotes the bottleneck (a simple convolution layer) and the A denotes tanh activation to output. All layers can have weights initialized with a random normal distribution.

In some embodiments, the above general architecture can be used with specific hyperparameters tuned by running many experiments with train-validation dataset split and choosing the set of hyperparameters that minimize the validation set error. In some instances, the mean of the mean squared error can be used in network training (e.g., by taking the difference between predicted shape and actual shape, squaring it, taking mean across shape, and taking a mean across samples). An Adam optimizer can be used for optimizing the network. Some hyperparameters than can be tuned by validation error examination include number of decoder and encoder layers, number of filters in each layer, dropout fraction in dropout layers, Leaky slope of Leaky ReLU, batch size, and the learning rate and beta parameters for the Adam optimizer.

The compiled surrogate model 146 at inference time can send inputs to the inverse model 140 then to the forward model 144. However, in training the overall surrogate model, the desired dataset (e.g., the target wafer shape transformations 104 and the corrective film patterns 106) can be provided to the forward model first, where the corrective film patterns are the input to the UNet and the target wafer shapes are the output. Then, the hyperparameters can be tuned and the forward model can be trained until the forward model performance is satisfactory. The weights of the forward model can then be frozen, and the model can be used to train the inverse and compiled models as described below.

### Inverse Model Details

In various embodiments, the forward model 142 is first trained using the corrective film patterns as the input and the target wafer shape transformations as the output. Then, the inverse 140 and compiled 146 models are trained by loading the pre-trained forward model, freezing the weights in the forward model layers 144, then training the compiled model using the wafer shape transformation as both input and output. A Zernike CNN can be used as the inverse model. A Zernike CNN, is, is similar to, a CNN with multiple convolutional layers with a fully connected output, which is similar to a CNN that could be used for image classification. One difference is that the units in the last dense layer in the fully connected output provide the Zernike coefficients that are used to build the film pattern shape according to equation (13) above. The Zernike CNN strategy can allow for regularization of the film pattern output to bias towards smooth film patterns that are practically attainable (e.g., are able to be reasonably implemented in semiconductor fabrication).

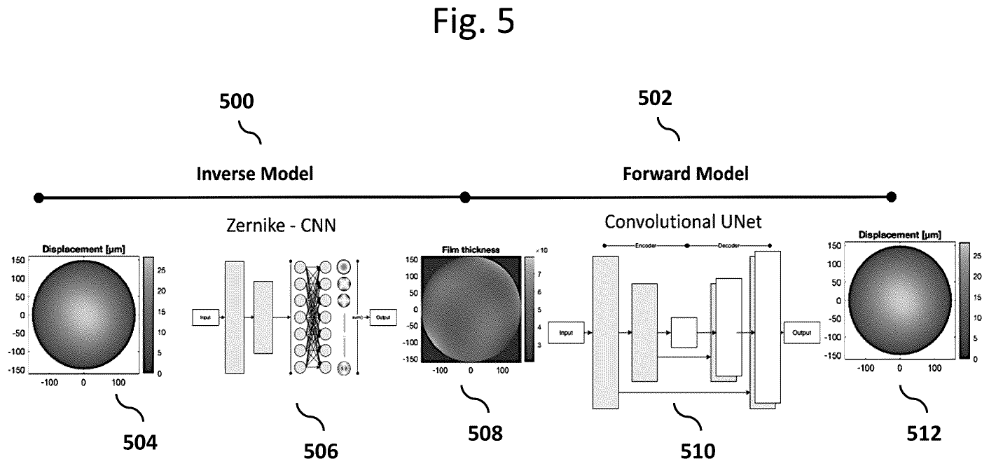

The details of an example Zernike CNN inverse model are shown in FIG. 7. In the example, the input wafer shape transformation is sent to a series of convolution layers to create feature maps, where here C⁶⁴ denotes a 2D convolution layer with 64 filters, kernel size of 3×3, stride length of 1 (in each dimension), with ReLU activation and 2D max pooling with pool size of 2. After the last convolution layer, the output is flattened then fully connected to a dense layer, where D⁶⁴ denotes a dense layer with 64 units and dropout. The D⁶⁴ is fully connected to a second dense layer which contains N Zernike coefficients (the cₐ coefficients in equation 13). The “Z” layer constructs a wafer shape transformation using equation (13) with the cₐs from the previous layer. The result is sent to a hyperbolic tangent (“tanh”) activation and output.

The Zernike CNN returns a film pattern given a wafer shape transformation. During training, for each input wafer shape transformation, the resulting film pattern is then sent into the pre-trained forward model (which returns a wafer shape transformation given a film pattern). The compiled model is trained by minimizing the difference between the input shape of the inverse model and the output shape from the forward model (again, the mean of the mean squared error can be used as the error function). The forward model weights are frozen during training of the compiled model so that only the weights in the inverse model are modulated. The inverse/compiled model also uses a training-validation split to choose a set of hyperparameters to minimize validation error. Some hyperparameters that can be optimized in the inverse model include number of convolution layers, number of convolution filters in each layer, number of dense layers and units, dropout fraction in the fully connected layers, number of Zernike modes (which dictates number of units in last dense layer), and learning rate and beta parameters for the Adam optimizer. According to some embodiments, the corrective film patterns can be regularized during training of the inverse model. The regularization may identify the inverse model from outputting corrective film patterns that deviate too much from the training set of corrective film patterns. Regularizing the corrective film patterns is described in more detail later below.

FIG. 8 illustrates an example of a wafer bow signature 800 input and the corrective film pattern 802 and the predicted residual bow output 804 generated by the surrogate model. In the illustrated example, the surrogate model prediction time for a single instance is ˜0.1 seconds (3-4 orders of magnitude faster than FEM), and the prediction time is even faster when many wafer shape transformations are processed at the same time.

### Alternative Model Architectures

The models described above provide just one surrogate model concept which has demonstrated excellent performance for the described tasks. However, there are other model concepts that may also be used as the surrogate model for wafer bow corrective film pattern determination, including alternative UNet/Zernike-CNN designs, generative adversarial networks, or probabilistic encoder-decoder networks.

For example, while UNet is described above as the forward model and a Zernike CNN is described above as the inverse model, other models may be used. Some examples of other models include using a UNet as both the forward and inverse model, using a Zernike CNN as both the forward and inverse model, or using a UNet as the inverse model and a Zernike CNN as the forward model, or using other model configurations. In some situations, the Zernike CNN may provide greater shape regularization (bias towards smooth shapes) while the UNet may be more versatile to fit a 2D function with higher variance/noise. Generally, experiments show that both the UNet and Zernike-CNN will perform well as the forward model where the output directly impacts the network cost function, and thus the best choice may depend on training dataset size and compute resources. In general, if the dataset size and compute resources are not limiting, then the UNet may allow for a closer fit to a greater variety of wafer shape transformations. In contrast, in the mode the inverse model is trained (where the inverse model output does not directly impact the cost function), the regularization and bias toward smooth 2D functions that the Zernike CNN provides may be beneficial, but this could also depend on the precise dataset.

In some embodiments, a conditional generative adversarial network (cGAN), such as the pix2pix model may be used. A GAN model has a different training strategy where a generator and discriminator model try to fool each other, and both get better over time. In training, the generator model can generate an image that is a realistic pair to some input image, and the discriminator can classify input image pairs as real or fake (where the fake pairs are provided by the generator). The generator could have a UNet architecture, and the discriminator could have a simple CNN architecture for binary classification (real or fake). Another training strategy is to use patches so that rather than determining if an entire image pair is real or fake, the determination is done on small patches across the image. The cGAN strategy has many benefits for image-to-image translation tasks (which can be used in translating film pattern to wafer shape transformation or wafer shape transformation to film pattern). The adversarial loss can preserve high frequency “sharpness” in the images, in contrast to models that are trained using mean squared error which can blur high frequency information. Another advantage is that in cases where there are multiple plausible result images that are equally valid (as perhaps in the case of the inverse wafer bow problem), the cGAN can provide one distinct good solution rather than an average of various possible good solutions. Despite these theoretical benefits, experimental results indicate that the UNet and Zernike CNN models trained with mean squared error give better results and have more stable training than cGAN approaches when used to determine corrective wafer films.

In some embodiments, a probabilistic encoder-decoder may be used. Examples of probabilistic encoder-decoders include a conditional variational autoencoder and a probabilistic UNet. In these approaches, results are probability distributions at each position on the resulting 2D array rather than a precise shape. The compiled model strategy described above can involve taking the expected value of film pattern and wafer shape transformation calculations. As such, the benefit of a probabilistic approach is not directly evident. However, using a probabilistic model could enable benefits in the active learning and on-line retraining steps described below.

### Active Learning for Further Wafer Bow Reduction

According to some embodiments, after the compiled surrogate model is trained from scratch using the FEM dataset, the model can be further improved through re-training using data from actual wafers. These improvements can be realized either pre-production using a validation dataset or on-line in production. Both are described below.

Model Improvements Using Active Learning with a Validation Dataset

As discussed in section above, a secondary dataset containing metrology on physical wafers can be used to learn any differences between the simulated wafer bow behavior and the behavior of real wafers. In this mode, the dataset may be much smaller than the simulated dataset because the cost per sample is much greater. Thus, a specialized active learning approach can be used to choose the best film patterns that can result in the greatest model improvement for a small number of examples in the validation dataset.

Active learning can be used in machine learning models. In active learning unlabeled data may be abundant but labeled examples may be scarce. An uncertainty estimator can be used to determine the unlabeled examples with maximum uncertainty, and these are chosen to be labeled by an oracle with the assumption that these examples will provide the maximum benefit to the model. In some embodiments, active learning used to improve the models may differ from the above description because a) the distribution of data can be different between original training and new labels from the oracle and b) the compiled surrogate model can be deterministic (no probability distribution available). Thus, a batch mode “auxiliary model” may be used, where a probabilistic auxiliary model can be trained on the error in the validation dataset, and samples chosen for the next batch using a combination of high error and high uncertainty. In some implementations, the active learning model suggests batches of film patterns to print for validation, then updates the surrogate model with this new validation data, then suggests a new batch for validation. This process can repeat until model performance on the validation data is satisfactory.

### Model Improvements On-Line During Production

According to various embodiments, when used in production, the surrogate model retraining 158 can be provided with consistent feedback in the form of downstream metrology results 156 from a subset of wafers. This data can be used to monitor the surrogate model performance and retrain and update the production model 150 as necessary. A retraining policy can be implemented that specifies batch size, sample weight, and model training hyperparameters (e.g. optimizer learning rate, number of training epochs, model freeze layers, etc.). As metrology data is sent to the model, re-training can occur following the retraining policy, and training-validation-test splits within the new data can be used to determine benefit over currently deployed models (where validation is used to determine best re-training policy, then test set is used to estimate performance of new model on unseen data). When a significant benefit is detected, the process owner can be alerted that the new model is available and can decide when to deploy the update. This process enables a surrogate model that is robust to dataset drift in a dynamic fabrication environment.

### Example System

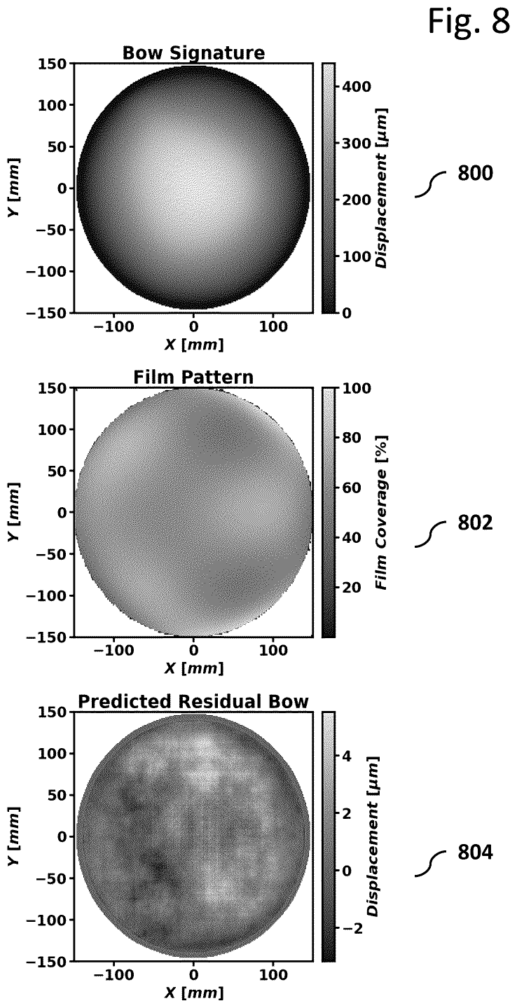

FIG. 9 is a schematic diagram of an example system 900 for training and/or implementing the surrogate model described above. According to various embodiments, the system 900 may be used in training and/or retraining a surrogate model for generating corrective film patterns to reduce warpage of semiconductor wafers during manufacturing of integrated circuit devices. The system 900 may also be used to implement a trained surrogate model, such as in semiconductor fabrication or testing to determine corrective film patterns. The system 900 can include wafer metrology unit 901, which can include one or more sensors 902. The system 900 additionally includes a memory 904 (which can include nonvolatile memory and/or storage), one or more processors 906, and one or more edge machine learning models 908. While system 900 is illustrated as a single system, the various components illustrated in the system 900 may be implemented as separate systems or subsystems.

The wafer metrology unit 901 can include various components for handling semiconductor wafers. For example, the wafer metrology unit 901 can include components to transport, hold, test, load, unload, or otherwise handle wafers. In some embodiments, wafer metrology unit 901 can be an integral part of a processing line including equipment for processing semiconductor devices using semiconductor wafers, such as various stations for depositing and etching layers, applying masks, photolithography equipment, and/or other suitable semiconductor manufacturing equipment.

The wafer metrology unit 901 can include the sensors 902. The sensors 902 can include various sensors used to sense and/or determine properties of semiconductor wafers. According to embodiments of this disclosure, the sensors 902 include sensors configured to sense and/or determine a wafer bow signature. For example, the sensors 902 can include optical sensors (e.g., laser displacement sensors, interferometric sensors, confocal microscopy sensors, chromatic confocal sensors, and/or other optical sensors), capacitive sensors and/or other suitable sensors for sensing and/or determining wafer bow signature.

The processors 906 can include one or more central processing units (“CPUs”), graphics processing units (“GPUs”), tensor processing units (TPUs), neural processing units (NPUs), and/or other processing units suitable for machine learning and any combination thereof. The memory 904 can include computer readable medium may be computer-readable storage devices, such as high density disks (“IHDDs”), solid state drives (“SDDs”), flash drives, and/or other persistent non-transitory computer-readable media. The computer readable medium may have stored therein computer program instructions that the computer processor(s) 906 execute(s) in order to implement one or more embodiments of this disclosure. For example, the computer readable medium can store one or more machine learning models, such as surrogate models described herein, and one or more datasets such as target wafer shape transformations, training corrective film patterns, or other information used in training and implementing the surrogate model. The computer-readable medium can store an operating system that provides computer program instructions for use by the computer processor(s) 906 in the general administration and operation of the system 900. The computer readable medium can store instructions for training, retraining, and/or implementing a surrogate model. The computer-readable medium can also include FPGA instructions for programming a field-programmable gate array (“FPGA”).

The edge machine learning models 908 can include any of the machine learning models disclosed herein. In some embodiments, the system 900 may train the machine learning models 908 using information stored in the memory 904, received from the wafer processing 901 (such as from the sensors 902), or received from an external system such as a server or cloud computing system 910. In some embodiments, some of, or all of, the edge machine learning models 908 may be received from an external system, such as a server computing system 910. According to some embodiments, some or all of the edge machine learning models 908 may be trained by an outside computing system 910 and communicated and/or loaded on the system 900. For example, the server computing system 910 may train one or more machine learning models 912 and communicate them to the system 900 (e.g., the machine learning models 912 may be general models and the edge machine learning models 908 may be specified implementations of the general models). The system 900 may retrain the machine learning models 908 and/or communicate with external systems to retrain the machine learning models 908.

The server computing system 910 may be an external system in communication with the system 900. In some embodiments, the server computing system 910 may be a system with a relatively high computing capacity. For example, the server computing system 910 may include a relatively large number of CPUs. TPUs and NPUs and/or GPUs that allow the server computing system to perform high computational tasks in a relatively reduced timeframe. As described above, training the surrogate models, performing, FEM or FEA, or other computational tasks described herein may be a high computational tasks and may benefit from utilizing the server computing system 910. In some embodiments, the system 900 may not be in communication with an external computing system and all computations and tasks described herein may be performed on the system 900.

According to various embodiments, the system 900 can receive a warpage signature from the sensors 902 and determine a target wafer shape transformation from the warpage signature (e.g., as an inverse of the warpage signature). The system 900 can provide the target wafer shape transformation to a surrogate machine learning model in the machine learning models 908 and receive one or more corrective film patterns that can compensate for the warpage signature from the surrogate machine learning model.

### Example Corrective Film Pattern

FIG. 10 illustrates and example corrective film pattern according to various embodiments. As described in more detail elsewhere in this disclosure, a corrective film pattern may be applied to a surface of a semiconductor wafer to correct or compensate for warpage of the semiconductor wafer. One way to implement a corrective film pattern is to apply the film based on a percentage of film coverage that varies across a surface, e.g., the front surface or the back surface. In some implementations, applying the corrective film in repeating uniform shapes (e.g., square islands or holes) can be advantageous. For example, it can simplify and/allow for a film to be applied and the repeated uniform shapes be removed (e.g., through etching or other techniques). It will be appreciated that other suitable non uniform or uniform patterns can be used, including other polygonal, circular or elliptical partially or fully formed islands or holes. The film pattern may exert tensile or compressive stress on the wafer to at least partially compensate preexisting compressive or tensile stress, respectively.

In the illustrated example, a total film pattern 1002 is shown on the left. The total film pattern 1002 has film coverages ranging from 100% coverage to about 25% coverage. The detailed film pattern 1004 is shown on the right. In the detailed film pattern 1004, a small portion of the total film pattern 1002 is illustrated. The detailed film pattern 1004 illustrates some squares, such as square 1006 with a film applied and some squares, such as square 1008 where no film is present. The film coverage percentage for a given area can be determined by dividing the number of squares with film applied a given area by the total number of squares in the area.

### Film Pattern Regularization

According to embodiments of this disclosure, the system 900 may be adapted for supervised machine learning. In supervised machine learning, a model may be trained using example input vectors and corresponding target vectors. During training, the model can attempt to find functions in data that describe relationships between the input vectors and the corresponding target vectors. However, models trained this way can be limited by the data used to train them and may not perform well during inference when used for data outside the model training distribution. For example, a model trained to predict the house prices in the city of New York may not give accurate results when used to predict the house prices in Mumbai due to the differences between both the locations.

As mentioned above, an inverse model for determining corrective film patterns can be trained by loading a pre-trained forward model and weights, and using a wafer shape as both the input (e.g., a set of target wafer shape transformations) and output (e.g., wafer shape transformations output by the forward model from a set of corrective film patterns) of the inverse model. During inference, the compiled surrogate model can take a wafer shape as an input and suggests a corrective film pattern as an output. However, as the problem the model is solving is an inverse problem, there can be multiple corrective films that can cause the same bow signature. As such, the model may suggest a corrective film that is drawn from a distribution outside the corrective films in the training distribution (e.g., the suggested corrective film may be an outlier that is outside a main distribution of corrective films), which can adversely affect the performance of the forward model. Moreover, the outputted predicted film patterns can be a function of the specific parameterization method (e.g., Zernike polynomials), which may not recreate the most accurate wafer bow in the physical space.

Aspects of the disclosure relate to the regularization of film patterns during inverse model training to help overcome the above described, and other, limitations of inverse models. According to various aspects, regularizing the film patterns can limit or force film patterns suggested by a model (e.g., the inverse model) to be drawn from the training dataset (or close to the training data set). In some embodiments, a distance is used to regularize the film patterns. For example, the Mahalanobis distance can be used as a metric to calculate a distance between a point (e.g., a parameterized corrective film) and a distribution (e.g., a parameterized set of training corrective films) in multivariate space and can be used to detect outliers from the training set and in classification done by the models. It will be appreciated that Mahalanobis distance is sometimes used for regularizing Bayesian neural networks. Under Bayes' theorem, the prior probability is incorporated in the likelihood to generate the posterior probability. The Mahalanobis distance has been sometimes used to calculate an analytically possible prior distribution, which is consistent with prior beliefs about neural network parameters as well as the desired predictive functions. However, unlike prior use of Mahalanobis distance in the context of Bayesian neural networks, according to various embodiments, an autoencoder-style framework may be used for regularization. In particular, the inventors have discovered that it can be particularly effective for regularization where the forward model is frozen while inverse model is trained. The distance (e.g., a Mahalanobis distance) is calculated between the film patterns in the training set and the predicted corrective film and used for regularization.

According to various aspects, a distance, such as a Mahalanobis distance, can be used to create a distance-based penalty for regularizing the film distribution space during training of the inverse model (which can be referred to herein as a “regularization penalty”). While a Mahalanobis distance between Zernike coefficients is described below, it can be appreciated that other techniques for detecting and handling outliers in a parameterized representation of film patterns may be used without departing from this disclosure. For example, other distance metrics may be used such as Euclidean distances, Manhattan distances, Cosine distances, and/or any other suitable distance calculation suitable for identifying outliers of film patterns (e.g., in a parameterized film patter space) from a main distribution of corrective film patterns, and assigning a suitable penalty.

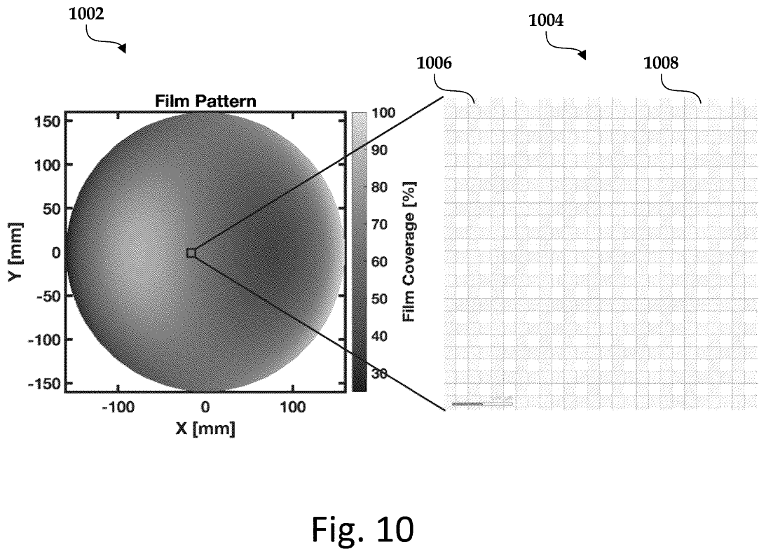

In various embodiments, a parametric representation of corrective film patterns is determined. For example, all the Zernike coefficients, N*cₐ, of each corrective film can be calculated, which can together create a high dimensional parametric representation of the corrective film pattern. The Zernike coefficients of the corrective films in the training set can be then used to calculate features, such as a sample mean, μ=(μ₁, . . . , μ_{N})^{T}, and a covariance matrix, S, which can contain a record of the covariance between each pair of Zernike coefficients in the distribution. In some implementations, a shrinkage-based covariance matrix can be used, which can make the calculation robust to outliers and reduce estimation error. As shown in FIG. 11, the sample mean, μ, and covariance matrix, S, can be used to calculate the Mahalanobis distance, D, between the Zernike coefficients for a random suggested corrective film (which may correspond to a corrective film suggested by the inverse model), x=(x₁, . . . , x_{N})^{T}, and the mean, μ, given by equation (14).

$$D = \sqrt{{( \underline{x} - \underline{μ} )}^{T} {S}^{- 1} ( \underline{x} - \underline{μ} )} \qquad ( 14 )$$

In various embodiments, during training of the inverse model, the Mahalanobis distance, D, can be added as a regularization penalty to the training loss (e.g., a loss associated with each wafer shape transformation input into the inverse model and the corresponding corrective film pattern output from the inverse model) using a scaling factor, SF, so it is applied only if it exceeds a specified distance threshold, T, for the dataset, as shown in equation (15). The scaling factor, SF, can be set or determined during hyperparameter tuning of the inverse model. Considerations for the scaling factor, SF, can include balancing the distance penalty with other training losses (e.g., reconstruction loss), such that the distance penalty and/or the other training losses are not over accounted for in the total training loss.

$$\begin{matrix}If D > T , & New Training Loss = Training Loss + D \times SF \\ Otherwise , & New Training Loss = Training Loss\end{matrix} \qquad ( 15 )$$

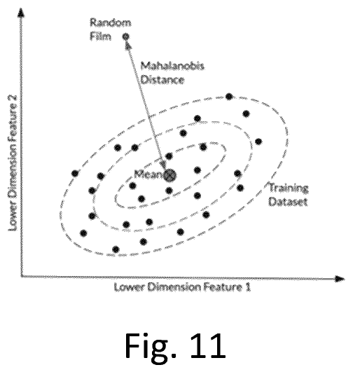

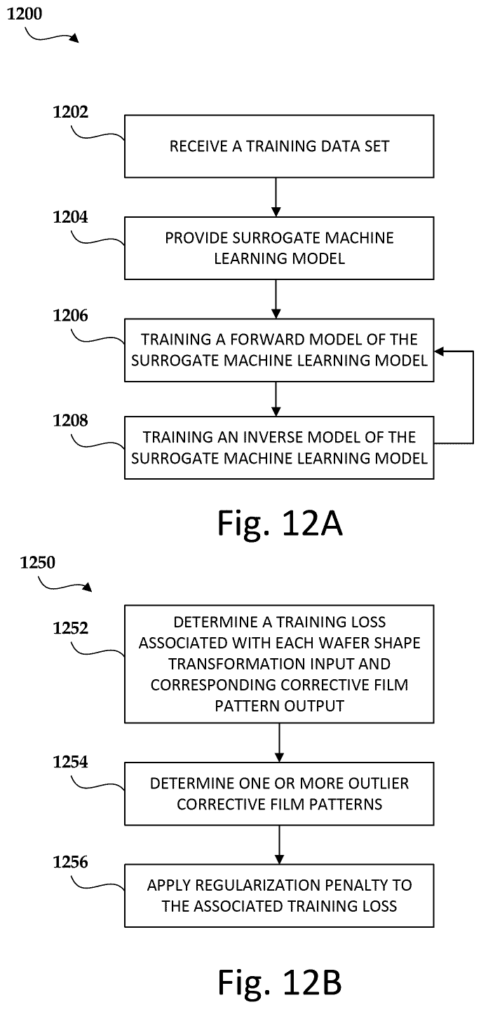

FIGS. 12A, 12B, and 13 are exemplary processes of training and/or using a surrogate machine learning model trained with the film pattern regularization described above, according to various embodiments. The processes may be performed by systems with one or more processors, such as the system 900 and/or the server computing system 910 described above with respect to FIG. 9. The processes may contain more, or fewer, steps than illustrated in FIGS. 12A, 12B, and 13. Some of the steps of processes may be repeated. Further, the steps of the processes may be performed in other orders than those illustrated in FIGS. 12A, 12B, and 13.

FIG. 12A is an example process 1200 used in supervised training of a surrogate model. At block 1202, the system receives a training data set. The training data set includes a set of target wafer shape transformations corresponding to negatives of warpage signatures of semiconductor wafers and a set of training corrective film patterns that reduce warpage signatures of semiconductor wafers. In some embodiments, some, or all, of the set of target wafer shape transformations may correspond to warpage signatures of semiconductor wafers that were determined from measurements of semiconductor wafers (e.g., using the wafer metrology unit 901). In some embodiments, some, or all, of the set of target wafer shape transformations may be associated with simulations of semiconductor wafer surfaces. In some embodiments, some, or all, of the set of training corrective film patterns were generated by simulation using numerical analysis. For example, in some embodiments the set of training corrective film patterns were generated based on an FEM simulation using the set of target wafer shape transformations and/or other wafer shape transformations. In other embodiments, some, or all, of the set of training corrective film patterns may come from other sources.

At block 1204, the system is provided with a surrogate machine learning model. In some instances, the surrogate machine learning model may be previously stored on the system and provided to one or more processors of the system for training. In some instances, the surrogate machine learning model may be provided from an outside system. The surrogate machine learning model can include a forward model comprising a neural network configured to take as input a corrective film pattern and output a corresponding wafer shape transformation. For example, the forward model may comprise the forward model 142, 144 and associated neural network described above with respect to FIG. 1C. The surrogate machine learning model can include an inverse model comprising neural network model configured to take as input a wafer shape transformation and output a corresponding corrective film pattern. For example, the inverse model may comprise the inverse model 140 and associated neural network described above with respect to FIG. 1C.

At block 1206, the system trains the forward model of the surrogate machine learning model using the set of training corrective film patterns as input and the set of target wafer shape transformations as output. The system can train the forward model (e.g., by tuning hyperparameters) until the performance of the forward model is satisfactory. After the training of the forward model is completed, the weights of the forward model can be frozen while the inverse model is trained.

At block 1208, the system trains the inverse model of the surrogate machine learning model using the set of wafer shape transformations and the wafer shape transformations determined by the trained forward model. More detail of training the inverse model is described below in process 1250. According to some embodiments, the system can continue to train the surrogate machine learning model (e.g., repeat one or both of block 1206 and block 1208) until a difference between the wafer shape transformation output from the forward model and the wafer shape transformation input to the inverse model reaches below a predetermined value. For example, in some embodiments, the surrogate model machine learning model includes a compiled model (e.g., compiled model 146) that is trained by minimizing the difference between the input shape of the inverse model and the output shape from the forward model.

FIG. 12B is an example process 1250 of training an inverse model of a surrogate machine learning model, according to various embodiments. In some embodiments, process 1250 corresponds to block 1208 of FIG. 12A. As described above, the inverse model is trained to receive the set of target wafer shape transformation as input and output a corrective film. The inverse model can be initially trained by providing the set of target wafer shape transformations and the output wafer shape transformations from the frozen forward model to the inverse model. At block 1252, the system determines a training loss, using a suitable training loss function (e.g., a mean square error (MSE) function, and mean absolute error (MAE) function or another suitable loss function), associated with each wafer shape transformation input into the inverse model and the corresponding corrective film pattern output from the inverse model.

At block 1254, the system determines one or more corrective film patterns of the corrective film patterns output by the inverse model to be outlier corrective film patterns that are outside of a main distribution of the corrective film patterns output by the inverse model. According to various embodiments, to determine the outlier corrective film patterns, the system may parameterize the corrective film patterns (e.g., by determining coefficients of Zernike polynomials, as described above). The outlier corrective film patterns can include those with a Mahalanobis distance outside a main distribution, as defined by the parameters of each corrective film pattern (e.g., using equation (14)).

At block 1256, the system applies a regularization penalty to the training loss associated with the outlier corrective film patterns. According to some embodiments, the regularization penalty may scale as the deviation from the main distribution increases (e.g., the Mahalanobis distance increases). In some embodiments, the regularization penalty is only applied to the outlier corrective film patterns and no regularization penalty is applied to the main distribution of corrective film patterns outputted by the inverse model. In these embodiments, the regularization penalty may follow equation (15).

FIG. 13 is an example process 1300 of generating corrective film patterns to reduce warpage of semiconductor wafers during manufacturing of integrated circuits, according to various embodiments. At block 1302, the system receives a warpage signature (of a semiconductor wafer. The warpage signature may comprise a two-dimensional height map of the surface of the wafer. The warpage signature may be determined by the system (e.g., using the wafer metrology unit 901) by measuring the wafer using one or more sensors (e.g., sensors 902). The warpage signature may also be determined outside the system and communicated to the system.

At block 1304, the system determines a target wafer shape transformation based on the warpage signature received at block 1302. The target wafer shape transformation may depend on a target wafer shape. For example, if a target wafer shape is a flat surface, the target wafer shape transformation may correspond to an inverse of the warpage signature.

At block 1306, the system provides the target wafer shape transformation to a surrogate machine learning model. The surrogate machine learning model can be trained to receive as input a target wafer shape transformation and provide as output a corresponding corrective film pattern and can include multiple machine learning models, such as the inverse and forward models described herein. The surrogate machine learning model may be trained using process 1200 and/or process 1250 of FIGS. 12A and 12B.

At block 1308, the system receives one or more corrective film patterns associated with the warpage signature from the surrogate machine learning model. The corrective film patterns may be configured to correct the warpage signature such that the surface of the wafer matches, or approximates, the target wafer shape. The corrective film patterns can comprise different coverage ratios across a surface of the wafer. An example corrective film pattern is illustrated in FIG. 10. According to various embodiments, the corrective film patterns can be used in a fabrication process to deposit a corrective film onto a surface of a wafer. For example, a blanket film may be deposited and selectively removed, e.g., etched, according to the corrective film patterns. In some embodiments the corrective film may be for application on a backside of a semiconductor wafer opposite a front side on which integrated circuit devices are at least partially fabricated.

At block 1310, the system may optionally retrain a forward model and inverse model of the surrogate machine learning model using the target wafer shape transformation and corrective film patterns. For example, the target wafer shape transformation may be added to a set of target wafer shape transformations used to train the forward and inverse models and the corrective film patterns may be added to a set of training corrective film patterns used to train the forward model.

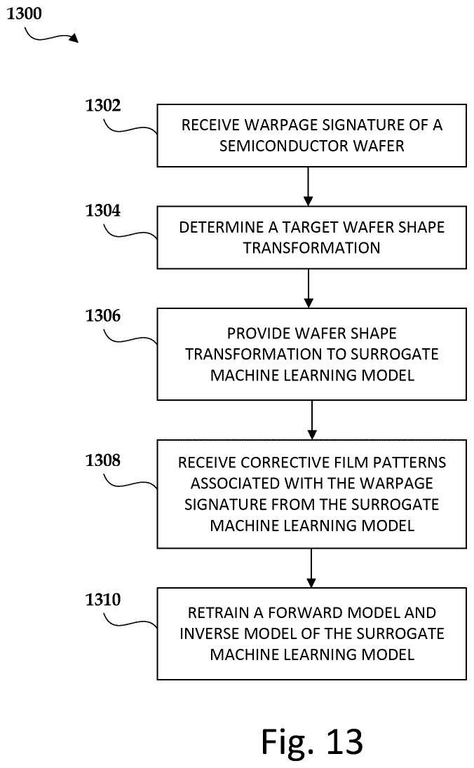

FIG. 14 illustrates the impact of Mahalanobis penalty on the predicted films from the compiled model. Portion (A) of FIG. 14 shows an example of a predicted film without applying the Mahalanobis penalty and portion (B) of FIG. 14 shows a film pattern for the same wafer bow after applying the penalty. As illustrated in FIG. 14, it can be observed that the film with the Mahalanobis penalty has a smoother surface which can be easier to print. Portion (C) of FIG. 14 shows histograms of film patterns from the training set, and predicted film patterns in the test set without applying the Mahalanobis penalty. Portion (D) of FIG. 14 shows the histograms of film patterns from the training set and predicted film patterns in the test set after applying Mahalanobis regularization. As illustrated in FIG. 14, the Mahalanobis distances (x-axis) for the predicted films with penalty are much lower than for the films without the penalty with a significant overlap between the training and predicted film distributions. This shows that the films predicted during inference with Mahalanobis regularization are drawn from the same distribution as the training dataset. As such, regularizing the film distribution using a Mahalanobis penalty during training of the inverse model is shown to help the surrogate model produce film patterns with similar characteristics to the training set. This can help ensure film outputted by the surrogate model are applicable in real world scenarios (e.g., practical to create using fabrication equipment).

Modified Surrogate Model with Separation of Variables

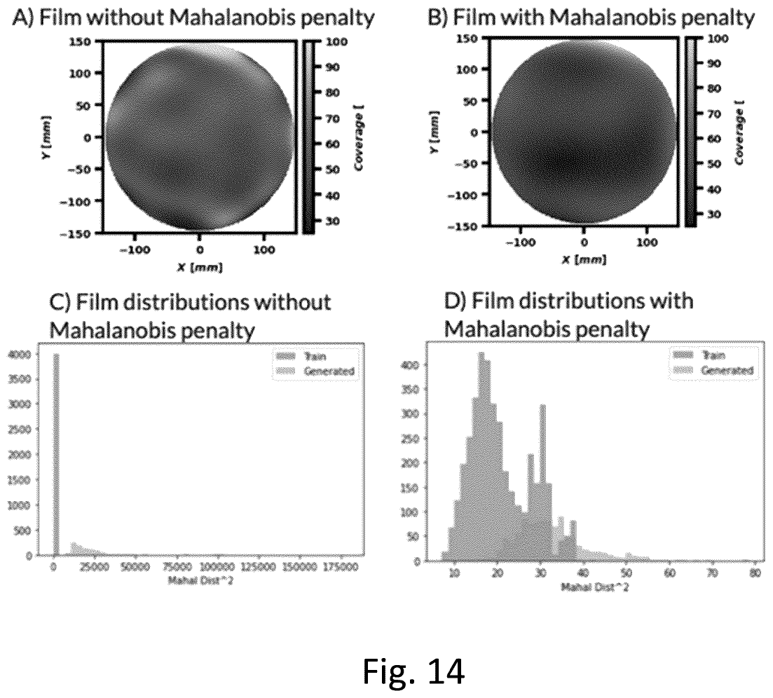

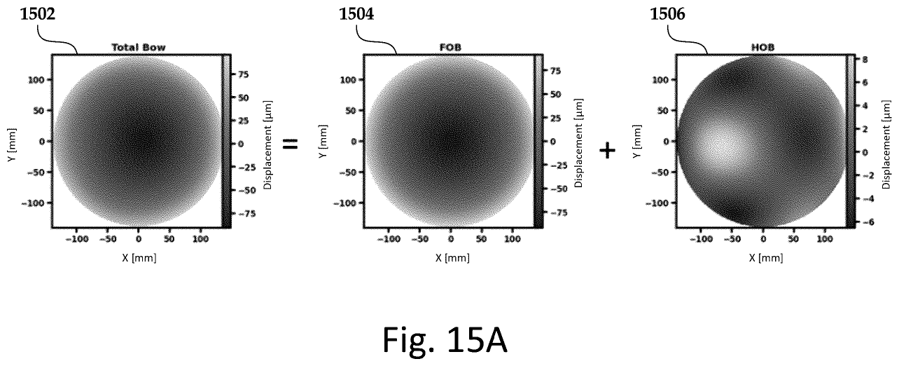

According to embodiments of this disclosure, the system 900 may be adapted for training and implementing surrogate machine learning using separated variable representations of a total wafer bow signature of semiconductor wafers (e.g., the warpage signatures of the semiconductor wafers) and corrective film patterns that reduce the total wafer bow signature. As shown in equation (16) below, the total wafer bow signature can be decomposed to be the sum of a first order bow (“FOB”) and a higher order bow (“HOB”). The FOB component of the warpage signature of a semiconductor wafer can represent a generalized shape of the warpage signature. For example, the FOB component may indicate the warpage signature is generally hemispheric (e.g., “bowl” shaped), may be generally parabolic (e.g., “saddle” shaped), may have other FOB component warpage shapes, or may be a combination of various general shapes. The HOB component of the warpage signature can represent finer shapes within the warpage signature when the FOB component is removed. Put in another way (and as illustrated in FIGS. 15A and 15B) the FOB component can be the warpage of the semiconductor defined by a first magnitude and a first characteristic lateral scale and the HOB component can be the warpage of the semiconductor that remains if the FOB component is subtracted and can be defined by a second magnitude and a second characteristic lateral scale, as follows:

$$Total bow = FOB + HOB \qquad ( 16 )$$

The first lateral scale can be substantially greater than the second lateral scale, e.g., by more than 2×, more than 5×, more than 10×, more than 100×, or value in a range defined by any of these values. Generally, both of the first magnitude and the first characteristic lateral scale are greater in magnitude are greater than the corresponding second magnitude and the second characteristic scale. However, examples are not so limited, and in some cases, the first magnitude may be smaller than the second magnitude.

As described above, the warpage signature of a semiconductor can be parameterized. The parameter representations of the warpage signature can be broken into the FOB component and the HOB component. For example, when the warpage signature is parameterized into Zernike polynomials, the FOB component can correspond to a Zernike pattern where (n, m)=(2, 0), and the HOB can correspond to a sum of the higher order components of (n, m) after the FOB component.

FIG. 15A illustrates a schematic cross-sectional view of an example warpage signature of a semiconductor wafer with a total bow 1502, which includes a FOB component 1504 and a HOB component 1506. As shown in FIG. 15A, the FOB component 1504 and the HOB component 1506 can have different shapes and bow magnitudes (difference between maximum and minimum displacement value). For example, as illustrated in FIG. 15A, the FOB component 1504 has a bow magnitude of approximately 200 μm and the HOB component has a bow magnitude of approximately 15 μm. As further illustrated in FIG. 15A, when scaled to the bow magnitude of the total bow 1502, the HOB component 1506 can be dominated by the FOB component 1504. Despite this, the HOB component 1506 can have negative impacts to the semiconductor wafer. For example, the HOB component 1506 can cause alignment errors during a fabrication process.

In the illustrated example, the FOB component 1504 has a bowl-shaped pattern that can be corrected using the magnitude of the FOB component 1504. However, the shape of the HOB component 1506 can vary according to various factors, such as the film pattern complexity and the stress induced by it, to list a few. During training of a surrogate machine learning model, the mean square error (MSE) of the total bow 1502 can be dominated by the FOB component 1504. As such, a base forward model, which predicts the total bow, can find it difficult to predict higher frequency components in the bow signature (like the HOB component 1506) accurately. Since the HOB component of a semiconductor wafer varies for different corrective film shapes, accurate HOB component prediction can be of particular interest. According to various embodiments, the systems disclosed herein can improve the accuracy of wafer warpage prediction by separating the HOB and FOB components of warpage signatures while training and/or implementing a surrogate machine learning model. In various aspects, the separation of the HOB and FOB components can ease and/or improve accurate HOB component prediction by the surrogate machine learning model.

FIG. 15B illustrates example cross section of a partial surface of a semiconductor wafer showing a HOB component 1554 of a total bow 1552 (such as the total bow 1502 shown in FIG. 15A). The total bow 1552 illustrates an example summation of the HOB component 1554 and a FOB component. For illustrative purposes only, the total wafer bow 1552 of the partial surface and a HOB component 1554 are shown to have sinusoidal wafer bow patterns. As illustrated in FIG. 15B, even though the HOB component 1554 is part of the total wafer bow 1552, the total wafer bow 1552 is mostly dominated by the higher amplitude, lower frequency shape of a FOB component. When that FOB component is removed, the shape of the higher frequency, lower amplitude HOB component 1554 is easily detected and thereby accounted for in training and implanting a surrogate model.

Different types of film chemistries can have different relationships between the corrective film and the wafer bow variables. Equations (17a) and (17b) show one linear relationship suggested by physics. In equation (17a) the FOB magnitude is determined by a linear function (ƒ1) of film thickness (FT), a film coverage mean (Fₘₑₐₙ), and a film coverage range (Fₘₐₓ-Fₘᵢₙ). In equation (17b) the HOB magnitude is determined by a linear function (ƒ2) of film thickness (FT), and film coverage range (Fₘₐₓ-Fₘᵢₙ). In Equations (17a) and (17b) a₁, b₁, a₂, b₂ are constants for a corrective film shape.

$$FOB magnitude = {a}_{1} * f 1 [ FT , ( {F}_{max} - {F}_{min} ) , {F}_{mean} ] + {b}_{1} \qquad ( 17 a )$$

$$HOB magnitude = {a}_{2} * f 2 [ FT , ( {F}_{max} - {F}_{min} ) ] + {b}_{2} \qquad ( 17 b )$$

When considering all possible FOB component shapes and all possible HOB component shapes, the number of possible total wafer bow signature can become too large to practically train a surrogate machine learning model. For example, both the forward and the inverse base models of the surrogate machine learning model would likely need a large dataset of film-wafer pairs for each new type of corrective film during retraining to get accurate predictions. Each corrective film could have multiple combinations of film coverage ranges, film thicknesses, and bow magnitudes for the same shape. As such, the large training data sets may include up to 100,000,000 or more film-wafer pairs, which can be impractical to generate and implement. Various embodiments of the disclosure separate the HOB component shape and magnitude predictions and use the linear relationships between HOB components and FOB components, thereby substantially reducing the amount of data required to train the forward and inverse model.

Various embodiments described herein use Zernike coefficients to characterize (e.g., parameterize) the wafer bow. Using the Zernike coefficients, the total bow can be separated into FOB shape, FOB magnitude, HOB shape, and HOB magnitude components. The FOB shape, and the HOB shape can be scaled (e.g., normalized), such that the total bow can be characterized using Equation (18).

$$Total bow = scaled FOB shape \times FOB magnitude + scaled HOB shape \times HOB magnitude \qquad ( 18 )$$

The physics-based bow-film relationships (e.g., those shown in Equations (17a) and (17b) can then be used to construct deep learning models that can predict, A) the total and higher order wafer bow for a given film shape, thickness, and coverage range (forward model), and B) a correction film shape, a thickness and a coverage range for an input wafer bow using the total bow and HOB component information (inverse model).

### Modified Forward Model Based on Separation of Variables

According to various embodiments, the forward model of the surrogate machine learning model can be modified to separately predict FOB magnitudes, HOB magnitudes, and HOB shapes (scaled). As shown in Equation (18) above, these predictions from the forward model can then be recombined to form the total bow. The FOB shape, when known, can be fixed and omitted from being predicted by the forward model (e.g., the FOB shape can correspond to known Zernike indices, (n, m)=(2, 0), for a bowl shape). The FOB shape, when known, can be fixed and omitted from being predicted by the forward model. For example, when wafer bow is represented using Zernike coefficients, the FOB shape can correspond to known Zernike indices, (n, m)=(2, 0).

This strategy can leverage the physical relationships between the FOB & HOB magnitudes and film variables such as the film thickness and the film coverage range (such as shown in Equations (17a) and (17b)), which can reduce the need for a larger dataset with multiple combinations of bow warpage and corrective film variables for the same shape. According to various embodiments, A modified version of the forward model can be used. FIG. 16 illustrates an example modified forward model 1602, according to an embodiment. In the illustrated example, a Zernike CNN structure is used for the modified forward model The modified forward model 1602 has three inputs: a corrective film image 1604 (scaled from [−1,1]), and two scalar inputs film_variable1 and film_variable2 (e.g., parameters associated with wafer coverage) which can be functions of film properties like film thickness (FT), and the mean (Fₘₑₐₙ), minimum (Fₘᵢₙ) and maximum (Fₘₐₓ) of the percent film coverage as shown by Equations (19a) and (19b).

$$film\_variable1 = \frac{( {F}_{mean} + 1 ) \times ( {F}_{max} - {F}_{min} ) \times FT}{2} + ( {F}_{min} \times FT ) \qquad ( 19 a )$$

$$film\_variable2 = ( {F}_{max} - {F}_{min} ) \times FT \qquad ( 19 b )$$

The outputs of the modified forward model can be configured into an HOB shape image 1606 (scaled from [−1,1]), and scalar outputs for FOB magnitude and HOB magnitude. As described above, a wafer shape transformation can be constructed from the HOB shape image. 1606 (scaled from [−1,1]), and scalar outputs for FOB magnitude and HOB magnitude. The modified forward model 1602 can be trained by calculating the losses for all three outputs separately, which can be used to create a total loss which can be modified by varying the loss weight factor for individual losses during hyperparameter tuning.

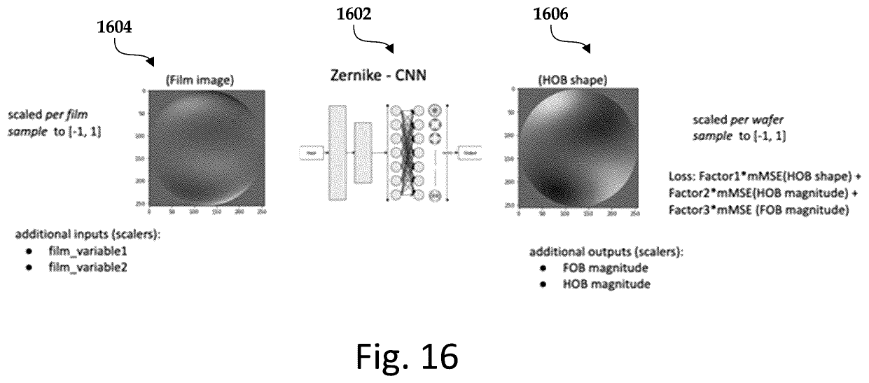

FIG. 17 illustrates an example determination of an FOB magnitude and a HOB magnitude using the modified forward model 1602. As shown in FIG. 17, the FOB and the HOB magnitudes can be calculated inside the forward model by creating a shape factor from the film image using a regression-style CNN, which can then be multiplied with the scalar inputs, film_variable1 or film_variable2 respectively, using the relationship between the bow magnitudes, corrective film variables and the corrective film shape (or image). The shape factor can be a unitless parameter that scales a linear relationship between film variables (e.g., film_variable1 and/or film_variable2) and bow magnitudes (e.g., FOB and HOB magnitudes) appropriately for a given bow shape. For example, a first corrective film pattern with a first shape and a second corrective film pattern with a second shape different from the first shape may have the same film thickness and coverage range. However, the second corrective film pattern might have higher, e.g., a 2× higher, induced HOB magnitude relative to the induced HOB magnitude of the first corrective film pattern, due to a different arrangement of film on the wafer. Thus, while the HOB magnitudes for both corrective films follow a linear behavior with respect to, e.g., film_variable2, the shape factor for the second corrective film pattern might be double that of the shape factor for the first corrective film pattern. The shape factors can be learned via neural network training. At inference time, the shape factor can be inferred for an arbitrary shape, even for shapes not specifically included in the training dataset.

### Modified Inverse Model Based on Separation of Variables

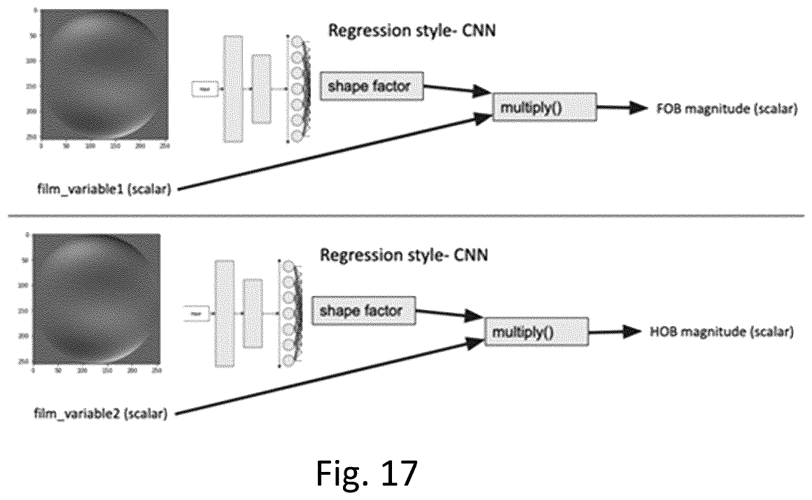

According to various embodiments, the inverse model of the surrogate machine learning model can be correspondingly modified according to the modified forward model. The base inverse model (e.g., the unmodified inverse model) returns a corrective film output for a given wafer shape input. The base inverse model can be modified to take three inputs. FIG. 18 illustrates an example modified inverse model 1802, according to an embodiment. In the illustrated embodiment, a Zernike CNN structure is used in modified inverse model 1802. The modified inverse model 1802 can take an HOB shape 1804 (scaled from [−1,1]), and scalars HOB magnitude, and FOB magnitude. The modified inverse model 1802 can return a corrective film image 1806 (scaled from [−1,1]), and scalars of film thickness and film coverage range.

The modified inverse model can be trained by passing predictions received by the inverse model through the frozen forward model and minimizing a difference between the input and predicted values of HOB shape, HOB magnitude, and FOB magnitude. A total loss can be calculated and minimized during training. The total loss can be a combination of an HOB shape reconstruction loss, an HOB magnitude reconstruction loss, and an FOB magnitude reconstruction loss. In some embodiments, the total loss can also include a Mahalanobis (or other) distance penalty for film regularization (such as the distance penalty discussed above. The weights of the individual losses can be modified during hyperparameter tuning to achieve the most accurate predictions.

Inside the modified inverse model, a regression-style CNN can be used similar to the modified forward model (and illustrated in FIG. 17) to calculate a shape factor from the input HOB shape. The FOB magnitude and HOB magnitude can be divided by this shape factor to calculate film_variable1 and film_variable2 respectively (e.g., corrective film variables), which are then used to determine the film thickness and film coverage range. In some embodiments, further rules can be added inside the inverse model during training. For example, rules can be added that clip the predictions for the scalar outputs if they exceed the minimum or maximum threshold. In some embodiments, the rules can be provided based on user input.

The modified forward and inverse models can be continually trained until a difference between component outputs from the forward model and the component inputs to the inverse model reach a predetermined value. For example, at least a portion of a training set of corrective film pattern information used in training the forward model may have known counterparts in the training set of wafer shape information used in training the inverse model (e.g., they from the same known semiconductor wafer bow shape and corrective film used to reduce the wafer bow shape). The predetermined value can be based on a target level of precision for the result. For example, corrections at some stages of fabrication, e.g., lithography, may have a higher level of precision than other stages of fabrication, e.g., thin film deposition. By way of one example, in an application, a HOB correction may be targeted to be 90% or greater. In such application, the predetermined value may be set such that the mean absolute percentage error (MAPE) is less than or equal to 10%.

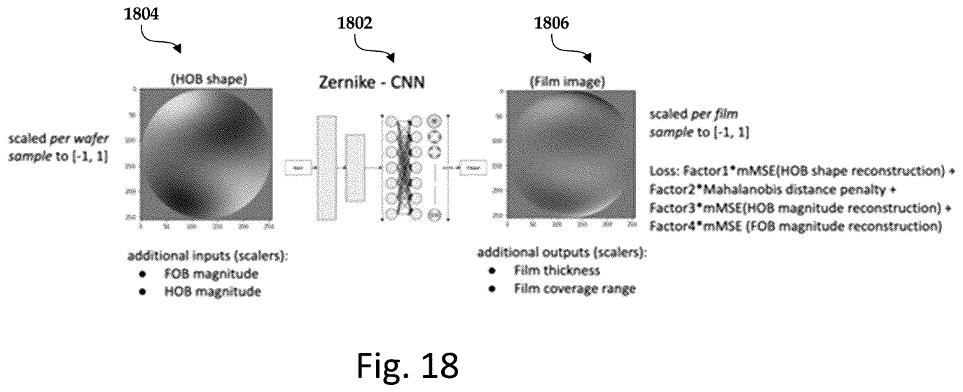

FIG. 19 illustrates an inference pipeline for suggesting a corrective film and predicted bow using the modified trained forward and inverse models, according to various embodiments. In the illustrated example, the total wafer bow 1902 to be corrected is first processed to split into FOB and HOB components and then the HOB shape, HOB magnitude, and FOB magnitude are scaled for ingestion into the inverse model 1904. The inverse model 1904 can predict a corrective film shape, film thickness, and film coverage range. The corrective film shape can be scaled by the film coverage range. In some embodiments, one or more of the (scaled) corrective film shape, film thickness, and film coverage range can be saved (e.g., the predicted correction film as a general station description (“GDS”) file or another format). The outputs from the inverse model 1904 can be used to calculate a film_variable1 and a film_variable2, and along with the film shape, can be sent through the forward model to predict a HOB shape, HOB magnitude, and FOB magnitude. The HOB shape, HOB magnitude, and FOB magnitude can be rescaled to real units (e.g., nonscaled units), and can be recombined to form the predicted total and HOB transformations that will be achieved for the particular predicted film. The predicted total bow and HOB transformations can be compared with the input bow values to calculate metrics for understanding the accuracy of correction.

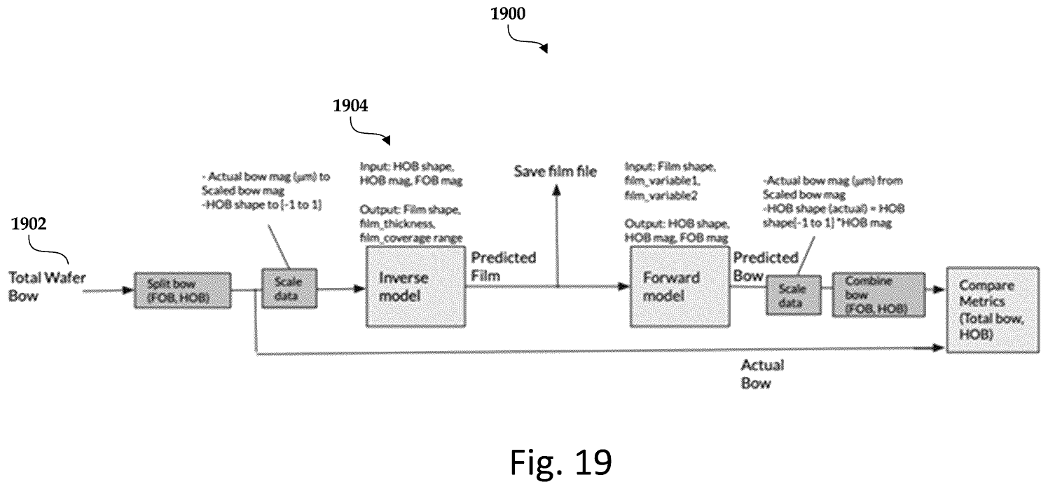

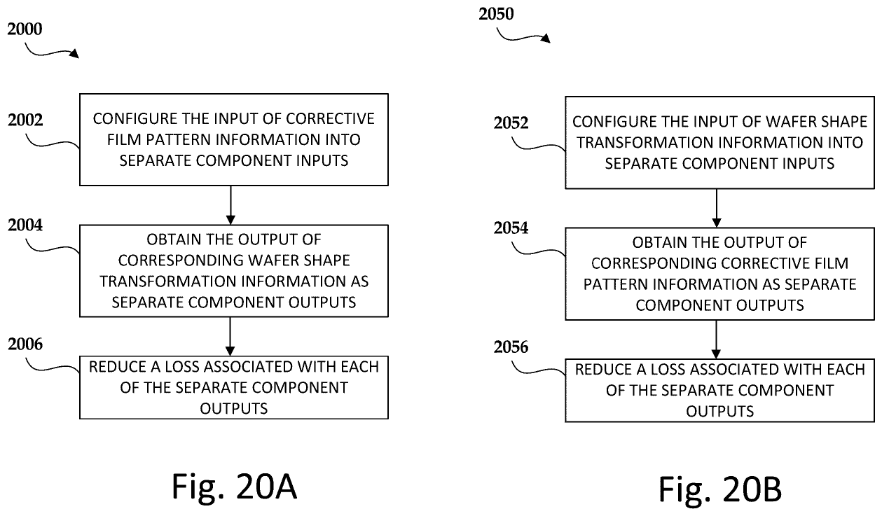

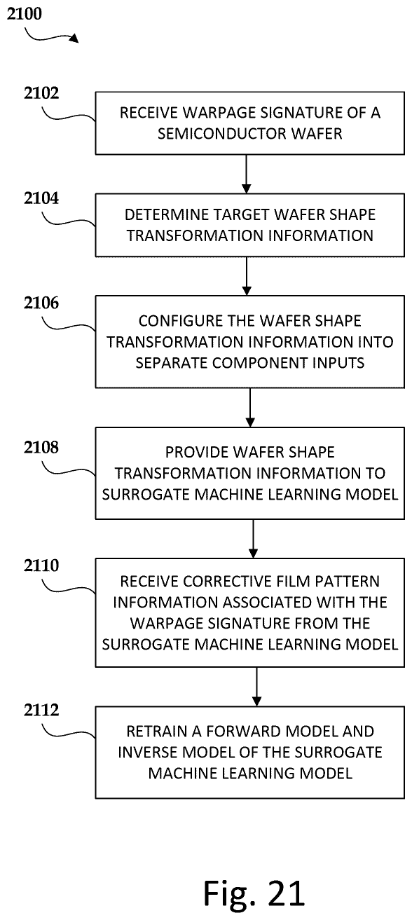

FIGS. 20A, 20B, and 21 are exemplary processes of training and/or using a surrogate machine learning model trained with the separated variables described above, according to various embodiments. The processes may be performed by systems with one or more processors, such as the system 900 and/or the server computing system 910 described above with respect to FIG. 9. The processes may contain more, or fewer, steps than illustrated in FIGS. 20A, 20B, and 21. Some of the steps of processes may be repeated. Further, the steps of the processes may be performed in other orders than those illustrated in FIGS. 20A, 20B, and 21.

FIG. 20A is an example process 2000 used in training a forward model of a surrogate machine learning model. The process 2000 may be used to train a forward model as part of a surrogate model training process. For example, the process 2000 may be used at block 1206 of process 1200 described above with respect to FIG. 12A. At block 2002, the system can configure input of corrective film pattern information into separate component inputs. The input of corrective film pattern information may be part of a training set of corrective film patterns. The separate components can include a corrective film image (e.g., the FOB component 1504 of a corrective film image described above) and corrective film variables associated with a wafer coverage and a film thickness (e.g., the film_variable1 and the film_variable2 described above). According to various embodiments, the forward model may confirm (e.g., using a caller) that the inputs are correctly formatted for the inverse model and/or the current application. Before input is received by the forward model, appropriate data preprocessing may consider a target shape transformation and film type (e.g., compressive or tensile) and film orientation (e.g., frontside or backside of wafer), then processes the data appropriately. For example, if a goal is to make a bowed wafer flat, the preprocessing may consider the target shape transformation, film type, and film orientation to induce a shape transformation that is the negative of a wafer bow signature. In some instances, the preprocessing may determine whether a corrective film pattern or an associated corrective film image is used (e.g., the negative of the corrective film pattern) by the inverse model.

At block 2004, the system obtains output of corresponding wafer shape transformation information as separate component outputs. The separate component outputs can include a shape image (e.g., HOB shape image 1606, described above) and magnitudes of wafer warpage (e.g., the HOB magnitude and FOB magnitude described above).

At block 2006, the system reduces a loss associated with each of the separate component outputs. According to some implementations, reducing the loss associated with each of the separate component outputs can include reducing: a loss associated with second order components associated with the shape images (e.g., the HOB shape image 1606 described above) of wafer shape transformation information output from the forward model, a loss associated with the magnitude of wafer warpage of the second order components (e.g., the HOB magnitude described above), and a loss associated with the magnitude of wafer warpage of the first order components (e.g., the FOB magnitude described above) associated with the shape images of wafer shape transformation information output from the forward model.

FIG. 20B is an example process 2050 used in training of an inverse model of a surrogate machine learning model. The process 2050 may be used to train an inverse model as part of a surrogate model training process. For example, the process 2050 may be used at block 1208 of process 1200 described above with respect to FIG. 12A. At block 2052, the system can configure input of wafer shape transformation information into separate component inputs. The input of wafer shape transformation information may be part of a training set of wafer shape transformations. The separate components can include a shape image (e.g., the HOB shape 1704 described above) and magnitudes of wafer warpage (e.g., FOB magnitude and HOB magnitude described above). According to various embodiments, the inverse model may confirm (e.g., using a caller) that the inputs are correctly formatted for the inverse model and/or the current application (e.g., in some instances, the inverse model may only accept positive HOB and FOB magnitudes). Before input is received by the inverse model, appropriate data preprocessing may consider the target shape transformation and film type (e.g., compressive or tensile) and film orientation (e.g., frontside or backside of wafer), then processes the data appropriately. For example, if a goal is to make a bowed wafer flat, the preprocessing may consider the target shape transformation, film type, and film orientation to induce a shape transformation that is the negative of the wafer bow signature. In some instances, the preprocessing may determine whether a target wafer shape transformation or the associated wafer bow signature is used by the inverse model.

At block 2054, the system obtains output of corresponding corrective film patterns as separate component outputs. The separate component outputs can include a corrective film image (e.g., the corrective film image 1806, described above) and corrective film variables associated with the wafer coverage and the film thickness (e.g., the scaler film thickness and film coverage ranges described above).

At block 2056, the system reduces a loss associated with each of the separate component outputs. According to some implementations, reducing the loss associated with each of the separate component outputs can include reducing: a loss associated with a reconstruction of second order components associated with wafer shape transformation information (e.g., the HOB shape 1804 described above), a loss associated with a reconstruction of magnitudes of wafer warpage of the second order components (e.g., the HOB magnitude described above), and a loss associated with a reconstruction of magnitudes of wafer warpage of first order components the associated with wafer shape transformation information (e.g., the FOB magnitudes described above).

FIG. 21 is an example process 2100 of generating corrective film patterns to reduce warpage of semiconductor wafers during manufacturing of integrated circuits, according to various embodiments. At block 2102, the system receives a warpage signature of a semiconductor wafer. The warpage signature may comprise a two dimensional height map of the surface of the wafer. The warpage signature may be determined by the system (e.g., using the wafer metrology unit 901) by measuring the wafer using one or more sensors (e.g., sensors 902). The warpage signature may also be determined outside the system and communicated to the system.

At block 2104, the system determines wafer shape transformation information based on the warpage signature received at block 2102. The wafer shape transformation information may depend on a target wafer shape. For example, if a target wafer shape is a flat surface, the wafer shape transformation information may correspond to an inverse of the warpage signature.

At block 2106, the system configures the wafer shape transformation information into separate component inputs including a shape image (e.g., the HOB shape 1804 described above) and magnitudes of wafer warpage (e.g., the HOB and FOB magnitudes described above)

At block 2108, the system provides the wafer shape transformation information to a surrogate machine learning model (e.g., as the component inputs). The surrogate machine learning model can be trained to receive as input a target wafer shape transformation and provide as output a corresponding corrective film pattern and can include multiple machine learning models, such as the inverse and forward models described herein. The surrogate machine learning model may be trained using process 1200, process 2000 and/or process 2050 of FIGS. 12A, 20A, and 20B.

At block 2110, the system receives corrective film pattern information associated with the warpage signature from the surrogate machine learning model. The corrective film pattern information may include information configured to correct the warpage signature such that the surface of the wafer matches, or approximates, the target wafer shape. The corrective film patterns can comprise different coverage ratios across a surface of the wafer. An example corrective film pattern that can be included in the corrective film pattern information is illustrated in FIG. 10. According to various embodiments, the corrective film patterns can be used in a fabrication process to deposit a corrective film onto a surface of a wafer. For example, a blanket film may be deposited and selectively removed, e.g., etched, according to the corrective film patterns. In some embodiments the corrective film may be for application on a backside of a semiconductor wafer opposite a front side on which integrated circuit devices are at least partially fabricated.

At block 2112, the system may optionally retrain a forward model and inverse model of the surrogate machine learning model using the wafer shape transformation information and corrective film pattern information. For example, the wafer shape transformation information may be added to a set of wafer shape transformation information used to train the forward and inverse models and the corrective film pattern information may be added to a set of corrective film pattern information used to train the forward model.

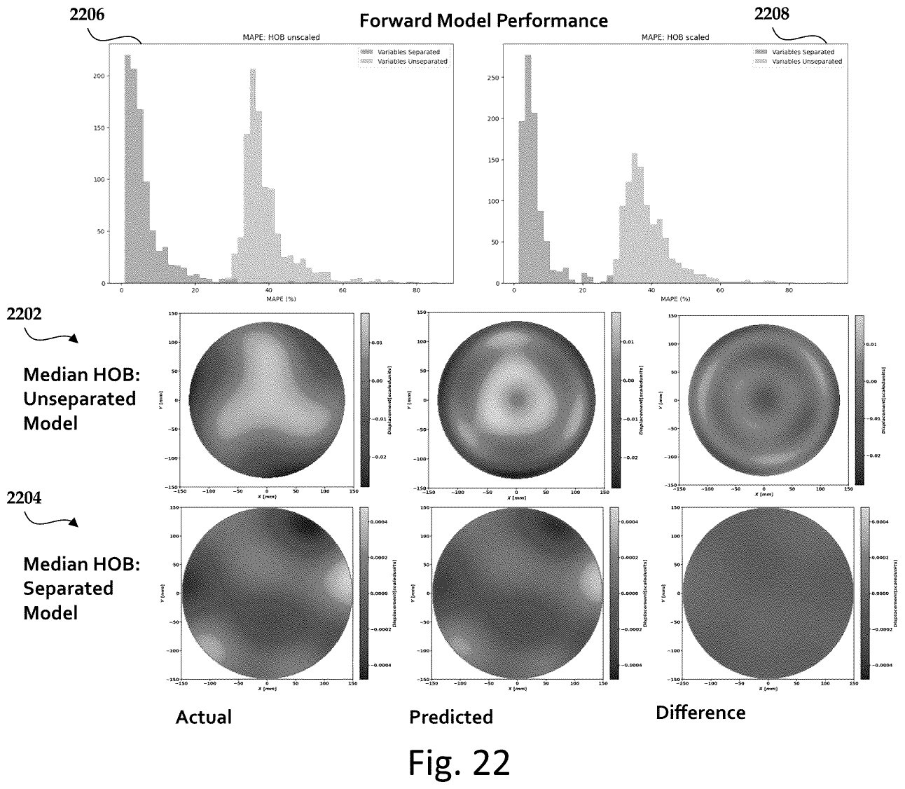

FIG. 22 illustrates a difference in HOB shape generated by an unseparated forward model and HOB shape generated by a modified (e.g., separated) forward model and experimental results of film distributions generated by the separated and unseparated forward models. The first results 2202 illustrates an actual HOB shape, a predicted HOB shape, and a difference between the actual and predicted HOB shape for the unseparated forward model. The second results 2204 illustrates an actual HOB shape, a predicted HOB shape, and a difference between the actual and predicted HOB shape for the modified inverse model.

A model trained on total bow may be associated with a loss dominated by the first order component, which can be particularly problematic in applications interested in minimizing higher order bow component. This effect is illustrated in FIG. 22, which demonstrates the difference in HOB bow predictions with a forward model trained on total bow vs. a forward model trained with FOB magnitude, HOB magnitude, and HOB shape components of loss separated. As illustrated by the first results 2202, the HOB shape predicted by the unseparated forward model differs noticeably from the actual HOB shape, indicating the forward model did not precisely predict the HOB shape. In contrast, the second results 2204 illustrates that the separated forward model was able to predict an HOB shape that varies only slightly from the actual HOB shape.

The chart 2206 illustrates an unscaled validation set of HOB mean absolute percentage error (MAPE) for the unseparated and separated loss implementations. The chart 2208 illustrates a scaled validation set of HOB MAPE. The scaled metric illustrated by chart 2208 demonstrates performance on just the HOB shape prediction task while unscaled metric illustrated by chart 2206 demonstrates performance on the HOB shape and magnitude together. As illustrated in FIG. 22, the model with variables separated in the loss achieves a much more accurate HOB prediction (both scaled and unscaled). The wafers shown in FIG. 22 demonstrate the instance with median HOB for the separated and unseparated variable models. The median instance for the unseparated model has a relatively high MAPE of 37.1%, demonstrating that the unseparated variable model does not precisely predict the HOB shape. In contrast, the median instance of the separated variable model has a substantially lower MAPE of 4.6%, and demonstrates excellent reconstruction of both HOB shape and magnitude.

Alternative Surrogate Model with Optimizer Algorithm

In some methods, Zernike polynomials have been used to fit certain data by solving for the Zernike coefficients with algorithms such as the least squares method, Gram-Schmidt orthogonalized method, Householder transformation, and singular value decomposition (SVD). The inventors have recognized, however, that using such algorithms in the context predicting corrective films for wafer warpage can have unacceptably low accuracy, at least in part because the number of coefficient terms being predicted is relatively high. The inventors have discovered that, when the number of coefficient terms of the Zernike polynomials is high, e.g., greater than 20, 30, 40, 50, 55, 65, or a number in a range defined by any of these numbers, certain optimizer algorithms can substantially enhance the accuracy of neural network models for predicting corrective films for reducing wafer warpage as described herein.

According to embodiments of this disclosure, to further improve the accuracy of the neural network models, an alternative and/or additional method for predicting the correction film can implement an inverse model comprising an optimization algorithm. For example, unlike some inverse models described above, e.g., inverse models based on a ZCNN structure, an inverse model according to alternative embodiments include an optimization algorithm for the final predictions. This optimization method can take a wafer bow signature (or target wafer shape transformation) and suggest a film shape for specific film thickness and coverage range values. In some instances, replacing a neural network with an optimizer algorithm in the inverse model can simplify and/or reduce the model training time and data requirements. The simplified and/or reduced model training time and data requirements can come at the expense of inference time. Example training and inference times for both approaches are shown in Table 1, where GPU acceleration is used for training. As shown in Table 1, in the optimizer approach according to embodiments, the inverse model does not include a neural network, thereby saving time and data requirements used to train an inverse model. At inference a correction calculation can take more time (e.g., a 1000× longer time) due to an increase in a performance time of the inverse model with the optimizer algorithm.

TABLE 1

| | Training | | | | Inference | | | |
|---|---|---|---|---|---|---|---|---|
| | Forward | | Inverse | | Forward | | Inverse | |
| Neural Network | 8 | hours | 12 | hours | 0.1 | s | 0.1 | s |

| Forward and Inverse | | | | | | | |
|---|---|---|---|---|---|---|---|
| Model | | | | | | | |
| Neural Network | 8 | hours | n/a | 0.1 | s | 200 | s |

Forward model;
Optimizer Algorithm
Inverse Model

Because the number of parameters of neural network models described herein including the coefficient terms of Zernike polynomials can be high, employing the right optimization algorithm can be critical for efficient and accurate training. The inventors have discovered that certain optimization algorithms can be particularly effective in the context of the disclosed technology where Zernike polynomials are employed, and where the number of coefficient terms is high. In this context, embodiments can include, e.g., use of optimization algorithms (also referred to herein as “optimizer algorithms” or “optimizers”) such as Levenberg-Marquardt (LM) or Trust Region Reflective (TRF) and determine an optimal film pattern for a given wafer bow. These optimizers used in the inverse model can be relatively fast, memory-efficient, and accurate, as compared to other optimizers. For example, LM may be relatively fast, memory-efficient, and accurate in small unconstrained curve-fitting problems and TRF may be relatively fast, memory-efficient, and accurate in large sparse fitting problems. Further, optimizers used in the inverse model can be robust enough for relatively high dimensions (e.g., when the number of coefficient terms of the Zernike polynomials is high, as described above). The optimizer can find optimum parameters (e.g., Zernike film coefficients), x, by minimizing a cost function C(x), e.g., an absolute error between the input HOB and predicted HOB (e.g., as shown in Equation (20).

$$C ( x ) = min ( abs ( Input HOB - Predicted HOB ) ) \qquad ( 20 )$$

In some embodiments, the optimizer can account for variable film thickness (e.g., parameters, x, in Equation (20) can account for the variable film thickness). In other embodiments, the film thickness can be fixed and the optimizer and the optimization function can be run in a loop for different target film thickness values (e.g., 100 nm, 150 nm, 200 nm etc.) for a fixed film coverage range. In some embodiments, the optimizers used in the inverse model can be robust enough to localized minima. For example, the optimizer may be robust enough to navigate when error at particular thickness value appears to be minimized compared to errors of adjacent thickness values, but is not the minimized error when all thickness values are considered.

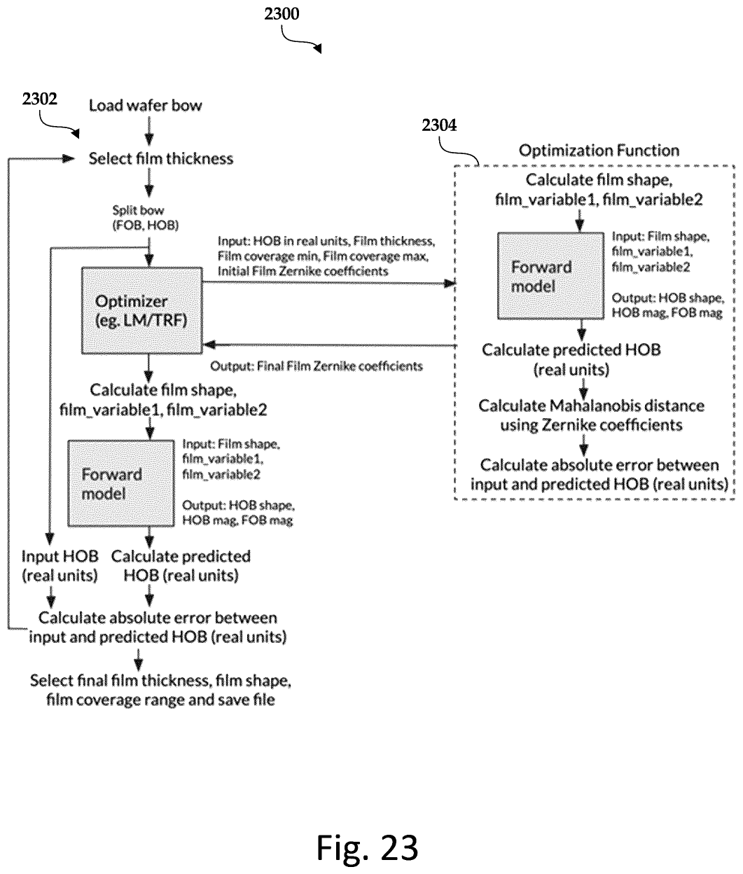

FIG. 23 illustrates an example flow diagram 2300 for determining a corrective film (e.g., a final film thickness, film shape, and film coverage) using a trained forward model and an inverse model comprising an optimizer, according to various embodiments. FIG. 23 shows an example pipeline, illustrating how an optimization function can be run in a loop. In the illustrated example, the absolute error between a predicted HOB for each thickness (e.g., each iteration of the feedback loop) and the input HOB can be used to determine an optimal film thickness and the corresponding film pattern.

In the illustrated example, a wafer bow associated with a semiconductor wafer is input into the flow diagram 2300. The wafer bow can be determined using any technique described herein (e.g., measured from a semiconductor wafer, simulated, etc.). For each iteration of a loop 2302 (the steps illustrated between “Select film thickness” and “calculate absolute error between input and predicted HOB (real units)”, inclusively), a film thickness is fixed. At the beginning of the loop 2302, the total bow is split into FOB and HOB components. Next, an unscaled HOB (e.g., the HOB in real units), and film variables (e.g., the fixed film thickness for the current iteration of the loop 2302, a maximum film coverage, and a minimum film coverage) are input to the optimizer along with initial parameters (e.g., initial Zernike coefficients). Some of the film variables (e.g., the maximum film coverage and minimum film coverage) may be defined by limits of a particular fabrication system and/or input by a user.

Inside the optimization function 2304, the initial Zernike coefficients for the film can be loaded either from a previously predicted film, randomized values, or zeros. The Zernike coefficients can be used to construct a film pattern, and calculate film_variable1 and film_variable2 (e.g., using Equations 19a and 19b). The film shape, film_variable1, and film_variable2 can be sent through a forward model (e.g., the modified version of the pretrained frozen ZCNN forward model described above) to predict a scaled HOB shape (e.g., [−1, 1]), the HOB magnitude and the FOB magnitude. The predicted scaled HOB shape can be rescaled to real units using the scaled HOB shape and the HOB magnitude, as given in Equation (21).

$$HOB {shape}_{real units} = HOB {shape}_{scaled} \times \frac{HOB magnitude}{2} \qquad ( 21 )$$

The predicted HOB and the input HOB can then be used to calculate the cost function C(x) during the optimization (e.g., determining optimal parameters that minimize the cost function). Additionally, in some embodiments, the parameters (e.g., the Zernike coefficients) can also be used to calculate a regularization penalty (e.g., a penalty based on Mahalanobis distance as described herein) for regularizing the film during optimization. The optimization function 2304 may be iteratively performed using different subsequent Zernike coefficients. The Zernike coefficients associated with the solution to the cost function C(x) can be output from the optimization function as final film Zernike coefficients.

The optimized parameters (e.g., the final film Zernike coefficients from the optimization function) can be used to construct an optimized film shape, film_variable1 and film_variable2, which can then be sent through the forward model (e.g., the pretrained ZCNN). The forward model can output an HOB shape, an HOB magnitude, and a FOB magnitude which can be used to calculate the optimized predicted HOB (in real units) for the fixed film thickness of the current iteration of loop 2302. A loss of each iteration of loop 2302 (e.g., the least absolute error between the input HOB and the predicted HOB for each fixed film thickness) can be compared to determine an optimal film thickness. The optimal film thickness and associated film shape, and film coverage range can be used to construct a final corrective film for the semiconductor wafer. The final corrective film can be output and used (e.g., in semiconductor fabrication processes).

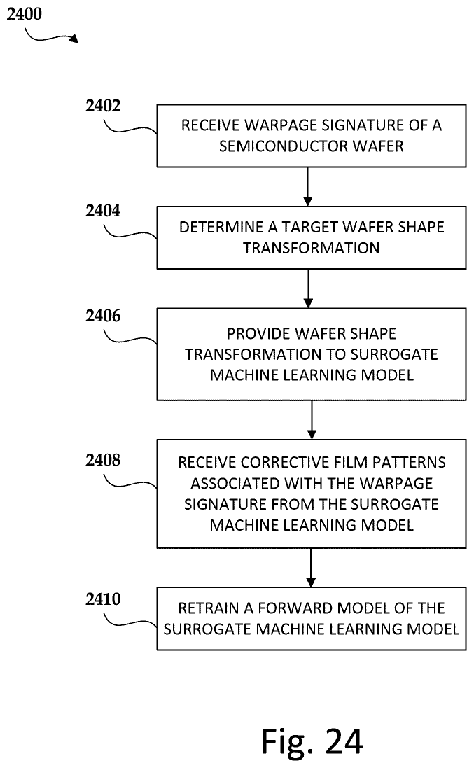

FIG. 24 is an example process 2400 of generating corrective film patterns to reduce warpage of semiconductor wafers during manufacturing of integrated circuits, according to various embodiments. The process 2400 may be performed by systems with one or more processors, such as the system 900 and/or the server computing system 910 described above with respect to FIG. 9. The process 2400 may contain more, or fewer, steps than illustrated in FIG. 24. Some of the steps of process 2400 may be repeated. Further, the steps of the process 2400 may be performed in other orders than those illustrated in FIG. 24.

At block 2402, the system receives a warpage signature of a semiconductor wafer. The warpage signature may comprise a two-dimensional height map of the surface of the wafer. The warpage signature may be determined by the system (e.g., using the wafer metrology unit 901) by measuring the wafer using one or more sensors (e.g., sensors 902). The warpage signature may also be determined outside the system and communicated to the system.

At block 2404, the system determines wafer shape transformation information based on the warpage signature received at block 2402. The wafer shape transformation information may depend on a target wafer shape. For example, if a target wafer shape is a flat surface, the wafer shape transformation information may correspond to an inverse of the warpage signature. In some embodiments, the system can configure the wafer shape transformation information into separate component inputs including a shape image (e.g., the HOB shape 1804 described above) and magnitudes of wafer warpage (e.g., the HOB and FOB magnitudes described above).

At block 2406, the system provides the wafer shape transformation information to a surrogate machine learning model (e.g., as the component inputs). The surrogate machine learning model can be trained to receive as input a target wafer shape transformation and provide as output a corresponding corrective film pattern and can include one or more machine learning models, such as the inverse model described herein. The surrogate machine learning model may be trained using all, or a portion, of the process 1200, process 2000 and/or process 2050 of FIGS. 12A, 20A, and 20B (for example, when the surrogate machine learning model only includes a forward model only the processes describing training the forward model may apply).

According to various embodiments, the surrogate machine learning model may include an optimizer. In some such embodiments, the surrogate machine learning model may be configured to fix a film thickness and determine an optimized film pattern using an inverse model including the optimizer. The surrogate machine learning model may then determine an optimal final film pattern associated with a film thickness that has reduced, e.g., minimal error between the input wafer transformation information and output wafer transformation information of the forward model. An example of a surrogate machine learning model that includes an optimizer is described above with respect to FIG. 23.

At block 2408, the system receives corrective film pattern information associated with the warpage signature from the surrogate machine learning model. The corrective film pattern information may include information configured to correct the warpage signature such that the surface of the wafer matches, or approximates, the target wafer shape. The corrective film patterns can comprise different coverage ratios across a surface of the wafer. An example corrective film pattern that can be included in the corrective film pattern information is illustrated in FIG. 10. According to various embodiments, the corrective film patterns can be used in a fabrication process to deposit a corrective film onto a surface of a wafer. For example, a blanket film may be selectively deposited or deposited and selectively removed, e.g., etched, according to the corrective film patterns. In some embodiments the corrective film may be for application on a backside of a semiconductor wafer opposite a front side on which integrated circuit devices are at least partially fabricated.

At block 2412, the system may optionally retrain a forward model of the surrogate machine learning model using the wafer shape transformation information and corrective film pattern information. For example, the wafer shape transformation information may be added to a set of wafer shape transformation information and the corrective film pattern information may be added to a set of corrective film pattern information used to train the forward model.

### Alternative Parameters for Inverse Model

According to embodiment, a method for predicting correction film using alternative parameters (e.g., other than the Zernike polynomials and other parameters described above) in an inverse model is described. In a ZCNN structure, the units in the last dense layer in the fully connected output can provide the N Zernike coefficients (where N=a number of Zernike modes) that are used to build the film pattern shape. Using the Zernike polynomials as parameters for constructing the correction films can allow smooth attainable films for random HOB shapes. However, if the HOB to be predicted has a known specific shape, then alternative parameters, other than Zernike polynomials, can be used that can be targeted to the known specific shape. This can enable a surrogate model, and in particular, an inverse model within the surrogate model to provide predictions while using less data to train effectively.

As an example, one or more functions can be used to parameterize a film with approximately a “saddle” shape. For example, the film can be parameterized using a stripe, an hourglass, or a symmetrical second degree polynomial, to list a few nonlimiting example functions.

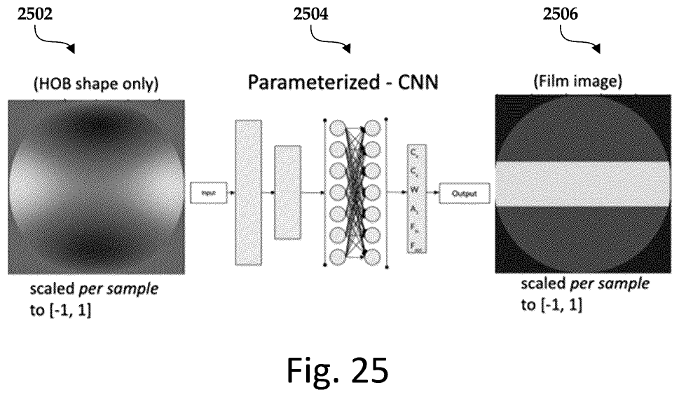

FIG. 25 shows an example of a parameterized CNN inverse model using a stripe as a target film pattern. In the illustrated example, a wafer image 2502 can be input into a CNN 2504 and output a stripe film pattern 2506. The parameters for the stripe film pattern 2506 can form the last layer (e.g., replacing the layer of Zernike coefficients in a ZCNN structure), to build the film pattern shape. During training of the inverse model, the predicted stripe film pattern 2506 can then be sent through a frozen forward model to get a predicted bow for the generated film associated with the stripe parameters.

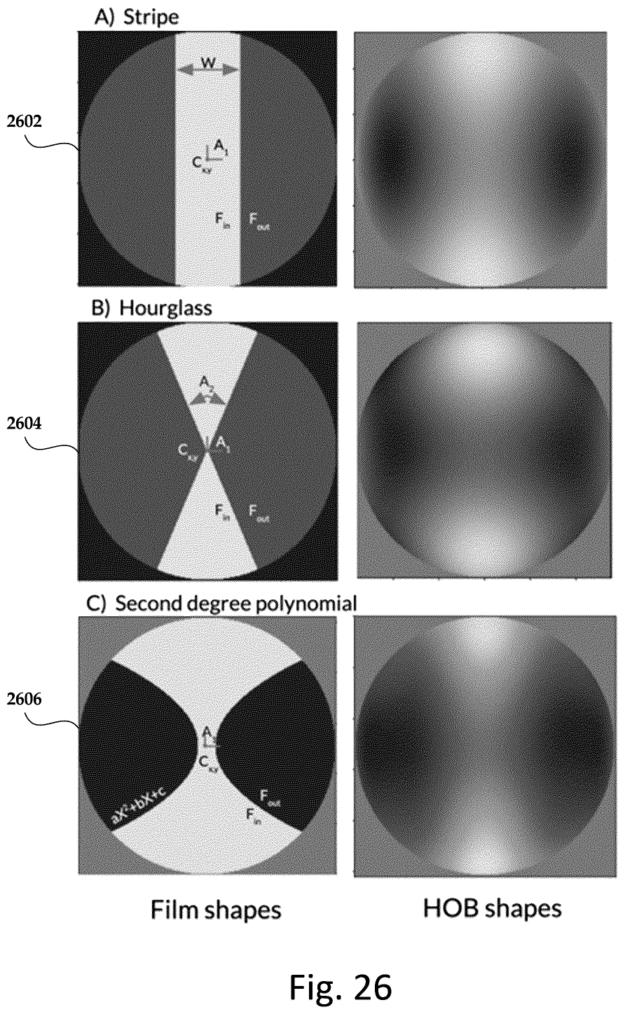

FIG. 26 illustrates example function and HOB shape pairings that can be used to train the inverse model. The parameters that can be used for each of the functions are described below.

Stripe Film Shape 2602: Some of the geometric parameters that can describe a stripe film shape 2602 are x and y coordinates of the center of the film (Cₓ, C_{y}), a width of the stripe (W), and a rotation angle with respect to the x-axis (A₁). The center parameter can help allow film shapes that may be off-center, and along with the width and rotation angle parameters can help predict bow shapes with different shapes and orientations.

Hourglass Film Shape 2604: An hourglass film shape 2604 with ends oriented radially outward from a center. The hourglass film shape can be described with parameters of x and y coordinates of the center (Cₓ, C_{y}) and rotation angle (A₁). The hourglass film shape 2604 can have an additional parameter describing the angle of the hourglass (A₂; e.g., a vertex angle) instead of the width used to describe the stripe film shape 2602 (e.g., the angle of the hourglass defines a radial width).

Second Degree Polynomial Film Shape 2606: A second degree polynomial film shape 2606 (e.g., a shape formed by a second degree polynomial, aX²+bX+c or, in other words a “polynomic shape) has three parameters a, b, c characterizing the shape of the polynomial function, where a≠0. The second degree polynomial film shape 2606 can be applied symmetrically on both sides of the corrective film with ends oriented outward across the center coordinates (Cₓ, C_{y}). A higher value of the second-degree parameter a can leads to sharper curves for the edge of the polynomial shape. The parameter A₁ describes the angle of rotation of the shape with respect to the x-axis.

The film shapes illustrated in FIG. 26 can have constant film coverage, with two parameters used for the values of the percent film coverage inside (Fᵢₙ) and outside (Fₒᵤₜ) of the shape. The film shapes can also be parameterized by allowing varying coverage range across the shape.

According to various embodiments, As an alternative to the parameterized CNN, the optimization method described above (e.g., the use of an optimizer in a surrogate machine learning model) can also be used to predict the film parameters. The optimizer can iterate through the values of the function parameters (instead of the Zernike coefficients) to obtain the optimal film for predicting the specific HOB shape.

### Additional Examples I

1. A method of supervised training a surrogate machine learning model for generating corrective film patterns to reduce warpage of semiconductor wafers during manufacturing of integrated circuit devices, the method comprising:
   receiving a training data set comprising:
      a set of target wafer shape transformations corresponding to negatives of warpage signatures of semiconductor wafers, and
      a set of training corrective film patterns that reduce warpage signatures of semiconductor wafers;
   providing the surrogate machine learning model comprising:
      a forward model comprising a first neural network model configured to take as input a corrective film pattern and output a corresponding wafer shape transformation, and
      an inverse model comprising a second neural network model configured to take as input a wafer shape transformation and output a corresponding corrective film pattern;
   training the forward model using the set of training corrective film patterns;
   training the inverse model using the set of wafer shape transformations and the wafer shape transformations determined by the trained forward model,
   wherein training the inverse model comprises determining a training loss associated with each wafer shape transformation input thereto and the corresponding corrective film pattern output therefrom, and wherein training the inverse model further comprises a regularization process, comprising:
      determining one or more corrective film patterns of a set of corrective film patterns output by the inverse model to be outlier corrective film patterns that are outside of a main distribution of the set of corrective film patterns output by the inverse model, and
      applying a regularization penalty to the training loss associated with the outlier corrective film patterns; and
   continuing to train the surrogate machine learning model until a difference between the wafer shape transformation output from the forward model and the wafer shape transformation input to the inverse model reaches below a predetermined value.
2. The method of Embodiment 1, wherein the regularization processes further comprises parameterizing the set of corrective film patterns output by the inverse model.
3. The method of Embodiment 2, wherein parameterizing the set of corrective film patterns output by the inverse model comprises determining coefficients of Zernike polynomials of the set of corrective film patterns output by the inverse model.
4. The method of Embodiment 2, wherein determining the one or more corrective film patterns output by the inverse model to be outlier corrective film patterns comprises:
   based on the parameterized set of corrective film patterns output by the inverse model, determining a Mahalanobis distance of the one or more corrective film patterns exceeds a threshold.
5. The method of Embodiment 4, wherein the regularization penalty increases as the Mahalanobis distance increases.
6. The method of Embodiment 4, wherein no regularization penalty is applied to the main distribution of the corrective film patterns output by the inverse model.
7. The method of Embodiment 1, wherein the set of corrective film patterns comprises the set of corrective film patterns output by the inverse model and the set of training corrective film patterns.
8. The method of Embodiment 1, wherein the warpage signatures of semiconductor wafers are determined from measurements from semiconductor wafers using one or more sensors.
9. The method of Embodiment 1, wherein the negatives of warpage signatures of semiconductor wafers are associated with simulations of semiconductor wafer surfaces.
10. The method of Embodiment 1, further comprising
   receiving a new desired wafer shape transformation;
   inputting the new desired wafer shape transformation into the surrogate machine learning model to determine one or more new corrective film patterns;
   retraining the forward model and inverse model, using the one or more new corrective film patterns. 111. The method of Embodiment 1, wherein the set of corrective film patterns were generated using an optimizer configured to output an optimized corrective film pattern from a given target wafer shape transformation. 12. The method of Embodiment 1, wherein the corrective film patterns comprise different coverage ratios across a wafer surface.
13. The method of Embodiment 1, wherein the corrective film patterns are to be applied on a backside of a semiconductor wafer opposite a front side on which integrated circuit devices are at least partially fabricated.
14. The method of Embodiment 1, wherein the set of training corrective film patterns comprises a film pattern parametrized to reflect a specific film pattern shape and wherein a last layer of the second neural network is formed using parameters associated with the film pattern.
15. The method of Embodiment 14, wherein the film pattern comprises a stripe oriented across a center of the semiconductor wafer, and wherein the parameters associated with the film pattern comprise a center coordinate, a width and an orientation angle.
16. The method of Embodiment 14, wherein the film pattern comprises an hourglass with ends oriented radially outward from a center of the semiconductor wafer, and wherein the parameters associated with the film pattern comprise a center coordinate, an hourglass angle defining a radial width of each end of the hourglass, and an orientation angle.
17. The method of Embodiment 14, wherein the film pattern comprises a polynomic shape with ends oriented across a center of the semiconductor wafer, and wherein the parameters associated with the film pattern comprise a center coordinate, polynomial coefficients defining parabolic portions of the semiconductor wafer not covered by the film pattern, and an orientation angle.
18. The method according to any one of the above Embodiments, wherein the method is further according to any one of Embodiments in Additional Examples III, VI, VIII, XI, XII, or XV.

### Additional Examples II

1. Non-transitory computer readable storage media storing instructions that when executed by a system of one or more processors, cause the one or more processors to:
   receive a training data set comprising:
      a set of target wafer shape transformations corresponding to negatives of warpage signatures of semiconductor wafers, and
      a set of training corrective film patterns that reduce warpage signatures of semiconductor wafers;
   provide a surrogate machine learning model comprising:
      a forward model comprising a first neural network model configured to take as input a corrective film pattern and output a corresponding wafer shape transformation, and
      an inverse model comprising a second neural network model configured to take as input a wafer shape transformation and output a corresponding corrective film pattern;
   train the forward model using the set of training corrective film patterns;
   train the inverse model using the set of wafer shape transformations and the wafer shape transformations determined by the trained forward model,
   wherein to train the inverse model in instruction cause the one or more processors to determine a training loss associated with each wafer shape transformation input thereto and the corresponding corrective film pattern output therefrom, and perform a regularization process, comprising:
      determining one or more corrective film patterns of a set of corrective film patterns output by the inverse model to be outlier corrective film patterns that are outside of a main distribution of the corrective film patterns output by the inverse model, and
      applying a regularization penalty to the training loss associated with the outlier corrective film patterns; and
   continue to train the surrogate machine learning model until a difference between the wafer shape transformation output from the forward model and the wafer shape transformation input to the inverse model reaches below a predetermined value.
2. The non-transitory computer readable storage media of Embodiment 1, wherein the regularization processes further comprises parameterizing the set of corrective film patterns output by the inverse model.
3. The non-transitory computer readable storage media of Embodiment 2, wherein parameterizing the set of corrective film patterns output by the inverse model comprises determining coefficients of Zernike polynomials of the set of corrective film patterns output by the inverse model.
4. The non-transitory computer readable storage media of Embodiment 2, wherein determining the one or more corrective film patterns output by the inverse model to be outlier corrective film patterns comprises:
   based on the parameterized set of corrective film patterns output by the inverse model, determining a Mahalanobis distance of the one or more corrective film patterns exceeds a threshold.
5. The non-transitory computer readable storage media of Embodiment 4, wherein the regularization penalty increases as the Mahalanobis distance increases.
6. The non-transitory computer readable storage media of Embodiment 4, wherein no regularization penalty is applied to the main distribution of the corrective film patterns output by the inverse model.
7. The non-transitory computer readable storage media of Embodiment 1, wherein the set of corrective film patterns comprises the set of corrective film patterns output by the inverse model and the set of training corrective film patterns.
8. The non-transitory computer readable storage media of Embodiment 1, wherein the warpage signatures of semiconductor wafers are determined from measurements from semiconductor wafers using one or more sensors.
9. The non-transitory computer readable storage media of Embodiment 1, wherein the negatives of warpage signatures of semiconductor wafers are associated with simulations of semiconductor wafer surfaces.
10. The non-transitory computer readable storage media of Embodiment 1, wherein the instruction further cause the one or more processors to:
   receive a new desired wafer shape transformation;
   input the new desired wafer shape transformation into the surrogate machine learning model to determine one or more new corrective film patterns;
   retrain the forward model and inverse model, using the one or more new corrective film patterns.
11. The non-transitory computer readable storage media of Embodiment 1, wherein the set of corrective film patterns were generated using an optimizer configured to output an optimized corrective film pattern from a given target wafer shape transformation.
12. The non-transitory computer readable storage media of Embodiment 1, wherein the corrective film patterns comprise different coverage ratios across a wafer surface.
13. The non-transitory computer readable storage media of Embodiment 1, wherein the corrective film patterns are to be applied on a backside of a semiconductor wafer opposite a front side on which integrated circuit devices are at least partially fabricated.
14. The non-transitory computer readable storage media according to any one of the above Embodiments, wherein the non-transitory computer readable storage media is further according to any one of Embodiments in Additional Examples V, VII, X, or XIV.

### Additional Examples III

1. A method of generating corrective film patterns to reduce warpage of semiconductor wafers during manufacturing of integrated circuits, the method comprising:
   receiving a warpage signature of a semiconductor wafer comprising a two dimensional height map;
   determining a target wafer shape transformation based on the warpage signature;
   providing the target wafer shape transformation to a surrogate machine learning model, wherein the surrogate machine learning model comprises:
      a forward model comprising a first neural network model trained to take as input a corrective film pattern and output a corresponding wafer shape transformation, and
      an inverse model comprising a second neural network model trained to take as input a wafer shape transformation and output a corresponding corrective film pattern, wherein to train the inverse model one or more processors are configured to:
         determine a training loss associated with each wafer shape transformation input thereto and the corresponding corrective film pattern output therefrom, and
         perform a regularization process, comprising:
         determining one or more corrective film patterns of a set of corrective film patterns output by the inverse model to be outlier corrective film patterns that are outside of a main distribution of the corrective film patterns output by the inverse model, and
         applying a regularization penalty to the training loss associated with the outlier corrective film patterns; and
   receiving, from the surrogate machine learning model, one or more corrective film patterns associated with the warpage signature.
2. The method of Embodiment 1, wherein the regularization processes further comprises parameterizing the set of corrective film patterns output by the inverse model.
3. The method of Embodiment 2, wherein parameterizing the set of corrective film patterns output by the inverse model comprises determining coefficients of Zernike polynomials of the set of corrective film patterns output by the inverse model.
4. The method of Embodiment 2, wherein determining the one or more corrective film patterns output by the inverse model to be outlier corrective film patterns comprises:
   based on the parameterized set of corrective film patterns output by the inverse model, determining a Mahalanobis distance of the one or more corrective film patterns exceeds a threshold.
5. The method of Embodiment 4, wherein the regularization penalty increases as the Mahalanobis distance increases.
6. The method of Embodiment 4, wherein no regularization penalty is applied to the main distribution of the corrective film patterns output by the inverse model.
7. The method of Embodiment 1, further comprising:
   providing the one or more corrective film patterns associated with the warpage signature to the surrogate machine learning model,
   wherein the one or more processors are configured to retrain the forward model and inverse model using the one or more corrective film patterns associated with the warpage signature.
8. The method according to any one of the above Embodiments, wherein the method is further according to any one of Embodiments in Additional Examples I, VI, VIII, XI, XII, or XV.

### Additional Examples IV

1. A system for generating corrective film patterns for semiconductor wafers, the system comprising:
   one or more sensors configured to measure a warpage signature of a semiconductor wafer comprising a two dimensional height map;
   a memory storing the warpage signature;
   one or more processors; and
   non-transitory computer readable storage media storing instructions that when executed by the one or more processors, cause the one or more processors to:
      receive the warpage signature to correct from the memory;
      determine a target wafer shape transformation based on the warpage signature;
      provide the target wafer shape transformation to a surrogate machine learning model, wherein the surrogate machine learning model comprises:
         a forward model comprising a first neural network model trained to take as input a corrective film pattern and output a corresponding wafer shape transformation, and
         an inverse model comprising a second neural network model trained to take as input a wafer shape transformation and output a corresponding corrective film pattern, wherein to train the inverse model a second one or more processors are configured to:
         determine a training loss associated with each wafer shape transformation input thereto and the corresponding corrective film pattern output therefrom, and
         perform a regularization process, wherein to perform the regularization process, the second one or more processors are configured to:
         determine one or more corrective film patterns of a set of corrective film patterns output by the inverse model to be outlier corrective film patterns that are outside of a main distribution of the corrective film patterns output by the inverse model, and
         apply a regularization penalty to the training loss associated with the outlier corrective film patterns; and
   receive, from the surrogate machine learning model, one or more corrective film patterns associated with the warpage signature.
2. The system of Embodiment 1, wherein the surrogate machine learning model is stored and executed outside of the system.
3. The system of Embodiment 1, wherein the non-transitory computer readable storage media stores the surrogate machine learning model and instructions that when executed by the one or more processors, cause the one or more processors to execute the surrogate machine learning model.
4. The system of Embodiment 1, wherein the one or more processors comprises at least one processor of the second one or more processors.
5. The system of Embodiment 1, wherein to perform the regularization process, the second one or more processors are configured to parameterize the set of corrective film patterns output by the inverse model.
6. The system of Embodiment 5, wherein to parameterize the training set of corrective film patterns, the second one or more processors are configured to determine coefficients of Zernike polynomials of the set of corrective film patterns output by the inverse model
7. The system of Embodiment 5, wherein to determine the one or more corrective film patterns output by the inverse model to be outlier corrective film patterns, the second one or more processors are configured to:
   based on the parameterized set of corrective film patterns output by the inverse model, determine a Mahalanobis distance of the one or more corrective film patterns exceeds a threshold.
8. The system of Embodiment 7, wherein the regularization penalty increases as the Mahalanobis distance increases.
9. The system of Embodiment 7, wherein no regularization penalty is applied to the main distribution of the corrective film patterns output by the inverse model.
10. The system of Embodiment 1, wherein the instructions further cause the one or more processors to:
   provide, the one or more corrective film patterns associated with the warpage signature to the surrogate machine learning model,
   wherein the second one or more processors are configured to retrain the forward model and inverse model using the one or more corrective film patterns associated with the warpage signature.
11. The system according to any one of the above Embodiments, wherein the system is further according to any one of Embodiments in Additional Examples IX or XIII.

### Additional Examples V

1. Non-transitory computer readable storage media storing instructions that when executed by a system of one or more processors, cause the one or more processors to:
   receive a warpage signature of a semiconductor wafer comprising a two dimensional height map;
   determine a target wafer shape transformation based on the warpage signature;
   provide the target wafer shape transformation to a surrogate machine learning model, wherein the surrogate machine learning model comprises:
      a forward model comprising a first neural network model trained to take as input a corrective film pattern and output a corresponding wafer shape transformation, and
      an inverse model comprising a second neural network model trained to take as input a wafer shape transformation and output a corresponding corrective film pattern, wherein to train the inverse model a second one or more processors are configured to:
         determine a training loss associated with each wafer shape transformation input thereto and the corresponding corrective film pattern output therefrom, and
         perform a regularization process, comprising:
         determining one or more corrective film patterns of a set of corrective film patterns output by the inverse model to be outlier corrective film patterns that are outside of a main distribution of the corrective film patterns output by the inverse model, and
         applying a regularization penalty to the training loss associated with the outlier corrective film patterns; and
   receive, from the surrogate machine learning model, one or more corrective film patterns associated with the warpage signature.
2. The non-transitory computer readable storage media of Embodiment 1, wherein the one or more processors comprises at least one processor of the second one or more processors.
3. The non-transitory computer readable storage media of Embodiment 1, wherein the regularization processes further comprises parameterizing the set of corrective film patterns output by the inverse model
4. The non-transitory computer readable storage media of Embodiment 3, wherein parameterizing the set of corrective film patterns output by the inverse model comprises determining coefficients of Zernike polynomials of the set of corrective film patterns output by the inverse model.
5. The non-transitory computer readable storage media of Embodiment 3, wherein determining the one or more corrective film patterns output by the inverse model to be outlier corrective film patterns comprises:
   based on the parameterized set of corrective film patterns output by the inverse model, determining a Mahalanobis distance of the one or more corrective film patterns exceeds a threshold.
6. The non-transitory computer readable storage media of Embodiment 5, wherein the regularization penalty increases as the Mahalanobis distance increases.
7. The non-transitory computer readable storage media of Embodiment 5, no regularization penalty is applied to the main distribution of the corrective film patterns output by the inverse model.
8. The non-transitory computer readable storage media of Embodiment 1, wherein the instructions further cause the one or more processors to:
   provide, the one or more corrective film patterns associated with the warpage signature to the surrogate machine learning model,
   wherein the second one or more processors are configured to retrain the forward model and inverse model using the one or more corrective film patterns associated with the warpage signature.
9. The non-transitory computer readable storage according to any one of the above Embodiments, wherein the non-transitory computer readable storage is further according to any one of Embodiments in Additional Examples II, VII, X, or XIV.

### Additional Examples VI

1. A method of supervised training a surrogate machine learning model for generating corrective film patterns to reduce warpage of semiconductor wafers during manufacturing of integrated circuit devices, the method comprising:
   receiving a training data set comprising:
      a set of target wafer shape transformation information comprising negatives of warpage signatures of semiconductor wafers, and
      a set of training corrective film pattern information to reduce warpage signatures of semiconductor wafers;
   providing the surrogate machine learning model comprising:
      a forward model comprising a first neural network model configured to take as input corrective film pattern information and output a corresponding wafer shape transformation information, and
      an inverse model comprising a second neural network model configured to take as input a wafer shape transformation information and output a corresponding corrective film pattern information;
   training the forward model using the set of corrective film pattern information, wherein training the forward model comprises:
      configuring the input of corrective film pattern information, prior to processing through hidden layers of the first neural network model, into separate component inputs including a corrective film image and corrective film variables associated with a wafer coverage and a film thickness;
      obtaining the output of corresponding wafer shape transformation information as separate component outputs including a shape image and magnitudes of wafer warpage; and
      reducing a loss associated with each of the separate component outputs of the forward model;
   training the inverse model using the set of wafer shape transformation information and the wafer shape transformation information determined by the trained forward model, wherein training the inverse model comprises:
      configuring the input of wafer shape transformation information, prior to processing through hidden layers of the second neural network model, into separate component inputs including the shape image and the magnitudes of wafer warpage;
      obtaining the output of corresponding corrective film pattern information as separate component outputs including the corrective film image and the corrective film variables associated with the wafer coverage and the film thickness; and
      reducing a loss associated with each of component outputs of the inverse model; and
   continuing to train the surrogate machine learning model until a difference between component outputs from the forward model and component inputs to the inverse model reaches below a predetermined value.
2. The method of Embodiment 1, wherein the warpage signatures of semiconductor wafers comprise a first order component having warpage feature size comparable to a size of the semiconductor wafers and a second order component having warpage feature size substantially smaller than a size of the semiconductor wafers.
3. The method of Embodiment 2,
   wherein the first order component is modeled using a first order Zernike pattern of the warpage signatures; and
   wherein the second order component is modeled using a difference between the first order component and a total warpage signature.
4. The method of Embodiment 2, wherein configuring the input of corrective film pattern information into separate component inputs for the forward model comprises:
   determining the corrective film variables based on the film thickness and percentages of the wafer coverage; and
   scaling the corrective film image based on the corrective film variables.
5. The method of Embodiment 2, wherein obtaining the output of corresponding wafer shape transformation information as separate component outputs of the forward model during training comprises:
   obtaining a second order component associated with the shape image of the corresponding wafer shape transformation information;
   obtaining a magnitude of wafer warpage of the second order component; and
   obtaining a magnitude of wafer warpage of a first order component associated with the shape image of the corresponding wafer shape transformation information.
6. The method of Embodiment 5, wherein the second order component associated with the shape image of the corresponding wafer shape transformation information is scaled based on the magnitude of wafer warpage of the second order component
7. The method of Embodiment 2, wherein configuring the input of wafer shape transformation information into separate component inputs for the inverse model during training comprises:
   determining a second order component associated with the shape image of the wafer shape transformation information;
   determining a magnitude of wafer warpage of the second order component; and
   obtaining a magnitude of wafer warpage of a first order component associated with the shape image of the wafer shape transformation information.
8. The method of Embodiment 2, wherein obtaining the output of corresponding corrective film pattern information as separate component outputs of the inverse model during training comprises:
   obtaining the corresponding corrective film image; and
   obtaining the film thickness and wafer coverage associated with the corresponding corrective film image.
9. The method of Embodiment 8, wherein the corresponding corrective film image is scaled based on the film thickness and wafer coverage associated with the corresponding corrective film image.
10. The method of Embodiment 5, wherein reducing the loss during training the forward model comprises reducing:
   a loss associated with second order components associated with the shape images of wafer shape transformation information output from the forward model;
   a loss associated with the magnitude of wafer warpage of the second order components; and
   a loss associated with the magnitude of wafer warpage of the first order components associated with the shape images of wafer shape transformation information output from the forward model.
11. The method of Embodiment 2, wherein reducing the loss during training the inverse model comprises reducing:
   a loss associated with a reconstruction of second order components associated with wafer shape transformation information;
   a loss associated with a reconstruction of magnitudes of wafer warpage of the second order components; and
   a loss associated with a reconstruction of magnitudes of wafer warpage of first order components associated with wafer shape transformation information.
12. The method of Embodiment 11, wherein reducing the loss during training the inverse model further comprises reducing a loss associated with a regularization penalty.
13. The method of Embodiment 1, wherein the warpage signatures of semiconductor wafers are determined from measurements from semiconductor wafers using one or more sensors.
14. The method of Embodiment 1, wherein the warpage signatures of semiconductor wafers are associated with simulations of semiconductor wafer surfaces.
15. The method of Embodiment 1, further comprising:
   receiving new target wafer shape transformation information;
   configuring the new target wafer shape transformation information into separate component inputs including the shape image and the magnitudes of wafer warpage;
   inputting the new target wafer shape transformation information into the surrogate machine learning model to determine one or more new corrective film pattern information; and
   retraining the forward model and inverse model, using the one or more new corrective film pattern information.
16. The method of Embodiment 1, wherein the corrective film pattern information comprises different coverage ratios across a wafer surface.
17. The method of Embodiment 1, wherein the corrective film pattern information is used to determine film patterns to be applied on a backside of a semiconductor wafer opposite a front side on which integrated circuit devices are at least partially fabricated.
18. The method of Embodiment 1, wherein the set of training corrective film pattern information comprises a film pattern parametrized to reflect a specific film pattern shape and wherein a last layer of the second neural network is formed using parameters associated with the film pattern.
19. The method of Embodiment 18, wherein the film pattern comprises a stripe oriented across a center of the semiconductor wafer, and wherein the parameters associated with the film pattern comprise a center coordinate, a width and an orientation angle.
20. The method of Embodiment 18, wherein the film pattern comprises an hourglass with ends oriented radially outward from a center of the semiconductor wafer, and wherein the parameters associated with the film pattern comprise a center coordinate, an hourglass angle defining a radial width of each end of the hourglass, and an orientation angle.
21. The method of Embodiment 18, wherein the film pattern comprises a polynomic shape ends oriented across a center of the semiconductor wafer, and wherein the parameters associated with the film pattern comprise a center coordinate, polynomial coefficients defining parabolic portions of the semiconductor wafer not covered by the film pattern, and an orientation angle.
22. The method according to any one of the above Embodiments, wherein the method is further according to any one of Embodiments in Additional Examples I, III, VIII, XI, XII, or XV.

### Additional Examples VII

1. Non-transitory computer readable storage media storing instructions that when executed by a system of one or more processors, cause the one or more processors to:
   receive a training data set comprising:
      a set of target wafer shape transformation information comprising negatives of warpage signatures of semiconductor wafers, and
      a set of training corrective film pattern information to reduce warpage signatures of semiconductor wafers;
   provide a surrogate machine learning model comprising:
      a forward model comprising a first neural network model configured to take as input corrective film pattern information and output a corresponding wafer shape transformation information, and
      an inverse model comprising a second neural network model configured to take as input a wafer shape transformation information and output a corresponding corrective film pattern information;
   train the forward model using the set of corrective film pattern information, wherein to train the forward model, the instruction cause the one or more processors to:
      configure the input of corrective film pattern information, prior to processing through hidden layers of the first neural network model, into separate component inputs including a corrective film image and corrective film variables associated with a wafer coverage and a film thickness;
      obtain the output of corresponding wafer shape transformation information as separate component outputs including a shape image and magnitudes of wafer warpage; and
      reduce a loss associated with each of component outputs of the forward model;
   train the inverse model using the set of wafer shape transformation information and the wafer shape transformation information determined by the trained forward model, wherein to train the inverse model, the instruction cause the one or more processors to:
      configure the input of wafer shape transformation information, prior to processing through hidden layers of the second neural network model, into separate component inputs including the shape image and the magnitudes of wafer warpage;
      obtain the output of corresponding corrective film pattern information as separate component outputs including the corrective film image and the corrective film variables associated with the wafer coverage and the film thickness; and
      reduce a loss associated with each of component outputs of the inverse model; and
   continue to train the surrogate machine learning model until a difference between component outputs from the forward model and component inputs to the inverse model reaches below a predetermined value.
2. The non-transitory computer readable storage media of Embodiment 1, wherein the warpage signatures of semiconductor wafers comprise a first order component having warpage feature size comparable to a size of the semiconductor wafers and a second order component having warpage feature size substantially smaller than a size of the semiconductor wafers.
3. The non-transitory computer readable storage media of Embodiment 2,
   wherein the first order component is modeled using a first order Zernike pattern of the warpage signatures; and
   wherein the second order component is modeled using a difference between the first order component and a total warpage signature.
4. The non-transitory computer readable storage media of Embodiment 2, wherein to configure the input of corrective film pattern information into separate component inputs for the forward model the instructions cause the one or more processors to:
   determine the corrective film variables based on the film thickness and percentages of the wafer coverage; and
   scale the corrective film image based on the corrective film variables.
5. The non-transitory computer readable storage media of Embodiment 2, wherein to obtain the output of corresponding wafer shape transformation information as separate component outputs of the forward model during training the instructions cause the one or more processors to:
   obtain a second order component associated with the shape image of the corresponding wafer shape transformation information;
   obtain a magnitude of wafer warpage of the second order component; and
   obtain a magnitude of wafer warpage of a first order component associated with the shape image of the corresponding wafer shape transformation information.
6. The non-transitory computer readable storage media of Embodiment 5, wherein the second order component associated with the shape image of the corresponding wafer shape transformation information is scaled based on the magnitude of wafer warpage of the second order component
7. The non-transitory computer readable storage media of Embodiment 2, wherein to configure the input of wafer shape transformation information into separate component inputs for the inverse model during training the instructions cause the one or more processors to:
   determine a second order component associated with the shape image of the wafer shape transformation information;
   determine a magnitude of wafer warpage of the second order component; and
   obtain a magnitude of wafer warpage of a first order component associated with the shape image of the wafer shape transformation information.
8. The non-transitory computer readable storage media of Embodiment 2, wherein to obtain the output of corresponding corrective film pattern information as separate component outputs of the inverse model during training the instructions cause the one or more processors to:
   obtain the corresponding corrective film image; and
   obtain the film thickness and wafer coverage associated with the corresponding corrective film image.
9. The non-transitory computer readable storage media of Embodiment 8, wherein the corresponding corrective film image is scaled based on the film thickness and wafer coverage associated with the corresponding corrective film image.
10. The non-transitory computer readable storage media of Embodiment 5, wherein to reduce the loss during training the forward model the instructions cause the one or more processors to reduce:
   a loss associated with second order components associated with the shape images of wafer shape transformation information output from the forward model;
   a loss associated with the magnitude of wafer warpage of the second order components; and
   a loss associated with the magnitude of wafer warpage of the first order components associated with the shape images of wafer shape transformation information output from the forward model.
11. The non-transitory computer readable storage media of Embodiment 2, wherein to reduce the loss during training the inverse model the instructions cause the one or more processors to reduce:
   a loss associated with a reconstruction of second order components associated with wafer shape transformation information;
   a loss associated with a reconstruction of magnitudes of wafer warpage of the second order components; and
   a loss associated with a reconstruction of magnitudes of wafer warpage of first order components associated with wafer shape transformation information.
12. The non-transitory computer readable storage media of Embodiment 11, wherein to reduce the loss during training the inverse model the instructions cause the one or more processors to reduce a loss associated with a regularization penalty.
13. The non-transitory computer readable storage media of Embodiment 1, wherein the warpage signatures of semiconductor wafers are determined from measurements from semiconductor wafers using one or more sensors.
14. The non-transitory computer readable storage media of Embodiment 1, wherein the warpage signatures of semiconductor wafers are associated with simulations of semiconductor wafer surfaces.
15. The non-transitory computer readable storage media of Embodiment 1, wherein the instructions further cause the one or more processors to:
   receive new target wafer shape transformation information;
   configure the new target wafer shape transformation information into separate component inputs including the shape image and the magnitudes of wafer warpage;
   input the new target wafer shape transformation information into the surrogate machine learning model to determine one or more new corrective film pattern information; and
   retrain the forward model and inverse model, using the one or more new corrective film pattern information.
16. The non-transitory computer readable storage media of Embodiment 1, wherein the corrective film pattern information comprises different coverage ratios across a wafer surface.
17. The non-transitory computer readable storage media of Embodiment 1, wherein the corrective film pattern information is used to determine film patterns to be applied on a backside of a semiconductor wafer opposite a front side on which integrated circuit devices are at least partially fabricated.
18. The non-transitory computer readable storage media according to any one of the above Embodiments, wherein the non-transitory computer readable storage media is further according to any one of Embodiments in Additional Examples II, V, X, or XIV.

### Additional Examples VIII

1. A method of generating corrective film patterns to reduce warpage of semiconductor wafers during manufacturing of integrated circuits, the method comprising:
   receiving a warpage signature of a semiconductor wafer comprising a two dimensional height map;
   determining a target wafer shape transformation information based on the warpage signature;
   configuring the target wafer shape transformation information into separate component inputs including a shape image and magnitudes of wafer warpage;
   providing the target wafer shape transformation to a surrogate machine learning model, wherein the surrogate machine learning model comprises:
      a forward model comprising a first neural network model configured to take as input corrective film pattern information and output a corresponding wafer shape transformation information, and
      an inverse model comprising a second neural network model configured to take as input a wafer shape transformation information and output a corresponding corrective film pattern information,
      wherein, to train the forward model, one or more processors are configured to:
         configure the input of corrective film pattern information, prior to processing through hidden layers of the first neural network model, into separate component inputs including a corrective film image and corrective film variables associated with a wafer coverage and a film thickness;
         obtain the output of corresponding wafer shape transformation information as separate component outputs including a shape image and magnitudes of wafer warpage; and
         reduce a loss associated with each of component outputs of the forward model, and
      wherein, to train the inverse model, the one or more processors are configured to:
         configure the input of wafer shape transformation information, prior to processing through hidden layers of the second neural network model, into separate component inputs including the shape image and the magnitudes of wafer warpage;
         obtain the output of corresponding corrective film pattern information as separate component outputs including the corrective film image and the corrective film variables associated with the wafer coverage and the film thickness; and
         reduce a loss associated with each of component outputs of the inverse model; and
   receiving, from the surrogate machine learning model, one or more corrective film patterns information associated with the warpage signature.
2. The method of Embodiment 1, wherein the warpage signature of the semiconductor wafer comprises a first order component having warpage feature size comparable to a size of the semiconductor wafer and a second order component having warpage feature size substantially smaller than a size of the semiconductor wafer.
3. The method of Embodiment 2,
   wherein the first order component is modeled using a first order Zernike pattern of the warpage signatures; and
   wherein the second order component is modeled using a difference between the first order component and a total warpage signature.
4. The method of Embodiment 2, wherein to configure the input of corrective film pattern information into separate component inputs for the forward model the one or more processors are configured to:
   determine the corrective film variables based on the film thickness and percentages of the wafer coverage; and
   scale the corrective film image based on the corrective film variables.
5. The method of Embodiment 2, wherein to obtain the output of corresponding wafer shape transformation information as separate component outputs of the forward model during training the one or more processors are configured to:
   obtain a second order component associated with the shape image of the corresponding wafer shape transformation information;
   obtain a magnitude of wafer warpage of the second order component; and
   obtain a magnitude of wafer warpage of a first order component associated with the shape image of the corresponding wafer shape transformation information.
6. The method of Embodiment 5, wherein the second order component associated with the shape image of the corresponding wafer shape transformation information is scaled based on the magnitude of wafer warpage of the second order component
7. The method of Embodiment 2, wherein to configure the input of wafer shape transformation information into separate component inputs for the inverse model during training the one or more processors are configured to:
   determine a second order component associated with the shape image of the wafer shape transformation information;
   determine a magnitude of wafer warpage of the second order component; and
   obtain a magnitude of wafer warpage of a first order component associated with the shape image of the wafer shape transformation information.
8. The method of Embodiment 2, wherein to obtain the output of corresponding corrective film pattern information as separate component outputs of the inverse model during training the one or more processors are configured to:
   obtain the corresponding corrective film image; and
   obtain the film thickness and wafer coverage associated with the corresponding corrective film image.
9. The method of Embodiment 8, wherein the corresponding corrective film image is scaled based on the film thickness and wafer coverage associated with the corresponding corrective film image.
10. The method of Embodiment 5, wherein to reduce the loss during training the forward model the one or more processors are configured to reduce:
   a loss associated with second order components associated with the shape images of wafer shape transformation information output from the forward model;
   a loss associated with the magnitude of wafer warpage of the second order components; and
   a loss associated with the magnitude of wafer warpage of the first order components associated with the shape images of wafer shape transformation information output from the forward model.
11. The method of Embodiment 2, wherein to reduce the loss during training the inverse model the one or more processors are configured to reduce:
   a loss associated with a reconstruction of second order components associated with wafer shape transformation information;
   a loss associated with a reconstruction of magnitudes of wafer warpage of the second order components; and
   a loss associated with a reconstruction of magnitudes of wafer warpage of first order components associated with wafer shape transformation information.
12. The method of Embodiment 11, wherein to reduce the loss during training the inverse model the one or more processors are further configured to reduce a loss associated with a regularization penalty.
13. The method of Embodiment 2, further comprising:
   retraining the forward model and inverse model, using the received one or more corrective film patterns information associated with the warpage signature.
14. The method of Embodiment 2, wherein the corrective film pattern information is used to determine film patterns to be applied on a backside of a semiconductor wafer opposite a front side on which integrated circuit devices are at least partially fabricated.
15. The method according to any one of the above Embodiments, wherein the method is further according to any one of Embodiments in Additional Examples I, III, VI, XI, XII, or XV.

### Additional Examples IX

1. A system for generating corrective film patterns for semiconductor wafers, the system comprising:
   one or more sensors configured to measure a warpage signature of a semiconductor wafer comprising a two dimensional height map;
   a memory storing the warpage signature;
   one or more processors; and
   non-transitory computer readable storage media storing instructions that when executed by the one or more processors, cause the one or more processors to:
      receive a warpage signature of a semiconductor wafer comprising a two dimensional height map;
      determine a target wafer shape transformation information based on the warpage signature;
      configure the target wafer shape transformation information into separate component inputs including a shape image and magnitudes of wafer warpage;
      provide the target wafer shape transformation to a surrogate machine learning model, wherein the surrogate machine learning model comprises:
      a forward model comprising a first neural network model configured to take as input corrective film pattern information and output a corresponding wafer shape transformation information, and
      an inverse model comprising a second neural network model configured to take as input a wafer shape transformation information and output a corresponding corrective film pattern information,
      wherein, to train the forward model, a second one or more processors are configured to:
         configure the input of corrective film pattern information, prior to processing through hidden layers of the first neural network model, into separate component inputs including a corrective film image and corrective film variables associated with a wafer coverage and a film thickness;
         obtain the output of corresponding wafer shape transformation information as separate component outputs including a shape image and magnitudes of wafer warpage; and
         reduce a loss associated with each of component outputs of the forward model, and
      wherein, to train the inverse model, the second one or more processors are configured to:
         configure the input of wafer shape transformation information, prior to processing through hidden layers of the second neural network model, into separate component inputs including the shape image and the magnitudes of wafer warpage;
         obtain the output of corresponding corrective film pattern information as separate component outputs including the corrective film image and the corrective film variables associated with the wafer coverage and the film thickness; and
         reduce a loss associated with each of component outputs of the inverse model; and
   receive, from the surrogate machine learning model, one or more corrective film patterns information associated with the warpage signature.
2. The system of Embodiment 1, wherein the one or more processors comprises at least one processor of the second one or more processors.
3. The system of Embodiment 1, wherein the surrogate machine learning model is stored and executed outside of the system.
4. The system of Embodiment 1, wherein the non-transitory computer readable storage media stores the surrogate machine learning model and instructions that when executed by the one or more processors, cause the one or more processors to execute the surrogate machine learning model.
5. The system of Embodiment 1, wherein the warpage signatures of semiconductor wafers comprises a first order component having warpage feature size comparable to a size of the semiconductor wafers and a second order component having warpage feature size substantially smaller than a size of the semiconductor wafers.
6. The system of Embodiment 5,
   wherein the first order component is modeled using a first order Zernike pattern of the warpage signatures; and
   wherein the second order component is modeled using a difference between the first order component and a total warpage signature.
7. The system of Embodiment 5, wherein to configure the input of corrective film pattern information into separate component inputs for the forward model the second one or more processors are configured to:
   determine the corrective film variables based on the film thickness and percentages of the wafer coverage; and
   scale the corrective film image based on the corrective film variables.
8. The system of Embodiment 5, wherein to obtain the output of corresponding wafer shape transformation information as separate component outputs of the forward model during training the second one or more processors are configured to:
   obtain a second order component associated with the shape image of the corresponding wafer shape transformation information;
   obtain magnitude of wafer warpage of the second order component; and
   obtain a magnitude of wafer warpage of a first order component associated with the shape image of the corresponding wafer shape transformation information.
9. The system of Embodiment 8, wherein the second order component associated with the shape image of the corresponding wafer shape transformation information is scaled based on the magnitude of wafer warpage of the second order component
10. The system of Embodiment 5, wherein to configure the input of wafer shape transformation information into separate component inputs for the inverse model during training the second one or more processors are configured to:
   determine a second order component associated with the shape image of the wafer shape transformation information;
   determine a magnitude of wafer warpage of the second order component; and
   obtain a magnitude of wafer warpage of a first order component associated with the shape image of the wafer shape transformation information.
11. The system of Embodiment 5, wherein to obtain the output of corresponding corrective film pattern information as separate component outputs of the inverse model during training the second one or more processors are configured to:
   obtain the corresponding corrective film image; and
   obtain the film thickness and wafer coverage associated with the corresponding corrective film image.
12. The system of Embodiment 11, wherein the corresponding corrective film image is scaled based on the film thickness and wafer coverage associated with the corresponding corrective film image.
13. The system of Embodiment 8, wherein to reduce the loss during training the forward model the second one or more processors are configured to reduce:
   a loss associated with second order components associated with the shape images of wafer shape transformation information output from the forward model;
   a loss associated with the magnitude of wafer warpage of the second order components; and
   a loss associated with the magnitude of wafer warpage of the first order components associated with the shape images of wafer shape transformation information output from the forward model.
14. The system of Embodiment 5, wherein to reduce the loss during training the inverse model the second one or more processors are configured to reduce:
   a loss associated with a reconstruction of second order components associated with wafer shape transformation information;
   a loss associated with a reconstruction of magnitudes of wafer warpage of the second order components; and
   a loss associated with a reconstruction of magnitudes of wafer warpage of first order components associated with wafer shape transformation information.
15. The system of Embodiment 14, wherein to reduce the loss during training the inverse model the second one or more processors are further configured to reduce a loss associated with a regularization penalty.
16. The system of Embodiment 1, wherein the warpage signatures of semiconductor wafers are determined from measurements from semiconductor wafers using one or more sensors.
17. The system of Embodiment 1, wherein the warpage signatures of semiconductor wafers are associated with simulations of semiconductor wafer surfaces.
18. The system of Embodiment 1, wherein the one or more processors are further configured to:
   retrain the forward model and inverse model, using the one or more corrective film patterns information associated with the warpage signature.
19. The system of Embodiment 1, wherein the corrective film pattern information comprises different coverage ratios across a wafer surface.
20. The system of Embodiment 1, wherein the corrective film pattern information is used to determine film patterns to be applied on a backside of a semiconductor wafer opposite a front side on which integrated circuit devices are at least partially fabricated.
21. The system according to any one of the above Embodiments, wherein the system is further according to any one of Embodiments in Additional Examples IV or XIII.

### Additional Examples X

1. Non-transitory computer readable storage media storing instructions that when executed by a system of one or more processors, cause the one or more processors to:
   receive a warpage signature of a semiconductor wafer comprising a two dimensional height map;
   determine a target wafer shape transformation information based on the warpage signature;
   configure the target wafer shape transformation information into separate component inputs including a shape image and magnitudes of wafer warpage;
   provide the target wafer shape transformation to a surrogate machine learning model, wherein the surrogate machine learning model comprises:
   a forward model comprising a first neural network model configured to take as input corrective film pattern information and output a corresponding wafer shape transformation information, and
   an inverse model comprising a second neural network model configured to take as input a wafer shape transformation information and output a corresponding corrective film pattern information,
   wherein, to train the forward model, a second one or more processors are configured to:
      configure the input of corrective film pattern information, prior to processing through hidden layers of the first neural network model, into separate component inputs including a corrective film image and corrective film variables associated with a wafer coverage and a film thickness;
      obtain the output of corresponding wafer shape transformation information as separate component outputs including a shape image and magnitudes of wafer warpage; and
      reduce a loss associated with each of component outputs of the forward model, and
   wherein, to train the inverse model, the second one or more processors are configured to:
      configure the input of wafer shape transformation information, prior to processing through hidden layers of the second neural network model, into separate component inputs including the shape image and the magnitudes of wafer warpage;
      obtain the output of corresponding corrective film pattern information as separate component outputs including the corrective film image and the corrective film variables associated with the wafer coverage and the film thickness; and
      reduce a loss associated with each of component outputs of the inverse model; and
receive, from the surrogate machine learning model, one or more corrective film patterns information associated with the warpage signature.
2. The non-transitory computer readable storage media of Embodiment 1, wherein the warpage signatures of semiconductor wafers comprises a first order component having warpage feature size comparable to a size of the semiconductor wafers and a second order component having warpage feature size substantially smaller than a size of the semiconductor wafers.
3. The non-transitory computer readable storage media of Embodiment 2,
   wherein the first order component is modeled using a first order Zernike pattern of the warpage signatures; and
   wherein the second order component is modeled using a difference between the first order component and a total warpage signature.
4. The non-transitory computer readable storage media of Embodiment 2, wherein to configure the input of corrective film pattern information into separate component inputs for the forward model the second one or more processors are configured to:
   determine the corrective film variables based on the film thickness and percentages of the wafer coverage; and
   scale the corrective film image based on the corrective film variables.
5. The non-transitory computer readable storage media of Embodiment 2, wherein to obtain the output of corresponding wafer shape transformation information as separate component outputs of the forward model during training the second one or more processors are configured to:
   obtain a second order component associated with the shape image of the corresponding wafer shape transformation information;
   obtain magnitude of wafer warpage of the second order component; and
   obtain a magnitude of wafer warpage of a first order component associated with the shape image of the corresponding wafer shape transformation information.
6. The non-transitory computer readable storage media of Embodiment 5, wherein the second order component associated with the shape image of the corresponding wafer shape transformation information is scaled based on the magnitude of wafer warpage of the second order component
7. The non-transitory computer readable storage media of Embodiment 5, wherein to configure the input of wafer shape transformation information into separate component inputs for the inverse model during training the second one or more processors are configured to:
   determine a second order component associated with the shape image of the wafer shape transformation information;
   determine a magnitude of wafer warpage of the second order component; and
   obtain a magnitude of wafer warpage of a first order component associated with the shape image of the wafer shape transformation information.
8. The non-transitory computer readable storage media of Embodiment 5, wherein to obtain the output of corresponding corrective film pattern information as separate component outputs of the inverse model during training the second one or more processors are configured to:
   obtain the corresponding corrective film image; and
   obtain the film thickness and wafer coverage associated with the corresponding corrective film image.
9. The non-transitory computer readable storage media of Embodiment 8, wherein the corresponding corrective film image is scaled based on the film thickness and wafer coverage associated with the corresponding corrective film image.
10. The non-transitory computer readable storage media of Embodiment 5, wherein to reduce the loss during training the forward model the second one or more processors are configured to reduce:
   a loss associated with second order components associated with the shape images of wafer shape transformation information output from the forward model;
   a loss associated with the magnitude of wafer warpage of the second order components; and
   a loss associated with the magnitude of wafer warpage of the first order components associated with the shape images of wafer shape transformation information output from the forward model.
11. The non-transitory computer readable storage media of Embodiment 2, wherein to reduce the loss during training the inverse model the second one or more processors are configured to reduce:
   a loss associated with a reconstruction of second order components associated with wafer shape transformation information;
   a loss associated with a reconstruction of magnitudes of wafer warpage of the second order components; and
   a loss associated with a reconstruction of magnitudes of wafer warpage of first order components associated with wafer shape transformation information.
12. The non-transitory computer readable storage media of Embodiment 11, wherein to reduce the loss during training the inverse model the second one or more processors are further configured to reduce a loss associated with a regularization penalty.
13. The non-transitory computer readable storage media of Embodiment 1, wherein the warpage signatures of semiconductor wafers are determined from measurements from semiconductor wafers using one or more sensors.
14. The non-transitory computer readable storage media of Embodiment 1, wherein the warpage signatures of semiconductor wafers are associated with simulations of semiconductor wafer surfaces.
15. The non-transitory computer readable storage media of Embodiment 1, wherein the instructions further cause the one or more processors to:
   retrain the forward model and inverse model, using the one or more corrective film patterns information associated with the warpage signature.
16. The non-transitory computer readable storage media of Embodiment 1, wherein the corrective film pattern information comprises different coverage ratios across a wafer surface.
17. The non-transitory computer readable storage media of Embodiment 1, wherein the corrective film pattern information is used to determine film patterns to be applied on a backside of a semiconductor wafer opposite a front side on which integrated circuit devices are at least partially fabricated.
18. The non-transitory computer readable storage media according to any one of the above Embodiments, wherein the non-transitory computer readable storage media is further according to any one of Embodiments in Additional Examples II, V, VII, or XIV.

### Additional Examples XI

1. A method of predicting corrective film patterns to reduce warpage of semiconductor wafers during manufacturing of integrated circuit devices, the method comprising:
   training a surrogate machine learning model, wherein training the surrogate machine learning model comprises:
      receiving a training data set comprising:
         a set of target wafer shape transformation information comprising negatives of warpage signatures of semiconductor wafers, and
         a set of training corrective film pattern information to reduce warpage signatures of semiconductor wafers;
      providing the surrogate machine learning model comprising:
         a forward model comprising a first neural network model configured to take as input corrective film pattern information and output a corresponding wafer shape transformation information, the forward model comprising an optimizer algorithm, and
         an inverse model configured to take as input a wafer shape transformation information and output a corresponding corrective film pattern information, the inverse model comprising an optimizer algorithm, the optimizer algorithm configured determine errors associated with thicknesses of the output corresponding corrective film pattern information;
   receiving a particular warpage signature of a semiconductor wafer comprising a two dimensional height map; and
   determining, using the surrogate machine learning model, a particular corrective film pattern to reduce the particular warpage signature.
2. The method of Embodiment 1, wherein determining the particular corrective film pattern to reduce the particular warpage signature comprises:
   providing the trained surrogate machine learning model;
   during inference of the surrogate machine learning model, performing a plurality of iterations, each iteration comprising:
      selecting a thickness associated with the particular corrective film pattern,
      extracting first order wafer bow (FOB) component and second order wafer bow (HOB) component from the particular warpage signature,
      feed input comprising the HOB component to the optimizer algorithm of the inverse model to obtain a film shape and film variables,
      feed the film shape and the film variables as input into the forward model to obtain a predicted HOB component, and
      calculate an error between the HOB component extracted from the wafer bow and the predicted HOB component predicted by the forward model for the thickness;
   reducing a cost function associated with the errors until the cost function reaches below a predetermined value.
3. The method of Embodiment 1, wherein the particular corrective film pattern to reduce the particular warpage signature includes a thickness associated with the reduced cost function.
4. The method of Embodiment 1, wherein the HOB component is modeled using a Zernike polynomial.
5. The method of Embodiment 4, wherein a number of coefficient terms of the Zernike polynomial is greater than 40.
6. The method of Embodiment 1, further comprising, prior training the surrogate machine learning model, training the forward model using the set of corrective film pattern information, wherein training the forward model comprises:
   configuring the input of corrective film pattern information, prior to processing through hidden layers of the first neural network model, into separate component inputs including a corrective film shape and corrective film variables associated with a wafer coverage and a film thickness;
   obtaining the output of corresponding wafer shape transformation information as separate component outputs including a shape image and magnitudes of wafer warpage; and
   reducing a loss associated with each of the separate component outputs of the forward model.
7. The method of Embodiment 1, wherein the optimizer algorithm comprises a trust region reflective optimizer algorithm.
8. The method of Embodiment 1, wherein the optimizer algorithm comprises a Levenberg-Marquardt optimizer algorithm.
9. The method according to any one of the above Embodiments, wherein the method is further according to any one of Embodiments in Additional Examples I, III, VI, VIII, XII, or XV.

### Additional Examples XII

1. A method of generating corrective film patterns to reduce warpage of semiconductor wafers during manufacturing of integrated circuits, the method comprising:
   receiving a warpage signature of a semiconductor wafer comprising a two dimensional height map;
   determining a target wafer shape transformation information based on the warpage signature;
   providing the target wafer shape transformation information to a surrogate machine learning model, wherein the surrogate machine learning model comprises:
      a forward model comprising a neural network model configured to take as input corrective film pattern information and output a corresponding wafer shape transformation information, and
      an inverse model comprising an optimizer algorithm configured to take as input a wafer shape transformation information and output a corresponding corrective film pattern information, wherein, to output the corresponding corrective film pattern information the optimizer algorithm is configured to:
         for a film thickness, determine initial corrective film pattern information and subsequent corrective film pattern information based at least in part on a shape image of an input of wafer shape transformation information,
         for each of the initial corrective film pattern information and subsequent corrective film pattern information provide the initial corrective film pattern information or subsequent film information to the forward model to receive the corresponding wafer shape transformation information; and
         determine an optimizer loss associated with a difference between the wafer shape transformation information output from the forward model and the wafer shape transformation input to the optimizer, and
         output optimized film pattern information associated with the transformation information output from the forward model with a minimized optimizer loss;
      wherein, the surrogate model is configured to:
         provide a plurality of film thicknesses to the optimizer,
         provide the optimized film pattern information output by the optimizer for each of the plurality of film thicknesses to the forward model, and
         output final film pattern information associated with a minimized error between the output wafer shape transformation of the inverse model for each of the plurality of film thicknesses and the target wafer shape transformation provided to the surrogate model; and
   receiving, from the surrogate machine learning model, the final film pattern information associated with the warpage signature.
2. The method of Embodiment 1, wherein, to train the forward model, one or more processors are configured to:
   configure the input of corrective film pattern information, prior to processing through hidden layers of the neural network model, into separate component inputs including a corrective film image and corrective film variables associated with a wafer coverage and a film thickness;
   obtain the output of corresponding wafer shape transformation information as separate component outputs including a shape image and magnitudes of wafer warpage; and
   reduce a loss associated with each of component outputs of the forward model.
3. The method of Embodiment 1, wherein the target wafer shape transformation information comprises separate components including a shape image and magnitudes of wafer warpage.
4. The method of Embodiment 1, wherein the corrective film pattern information comprises different coverage ratios across a wafer surface.
5. The method of Embodiment 1, wherein the corrective film pattern information is used to determine film patterns to be applied on a backside of a semiconductor wafer opposite a front side on which integrated circuit devices are at least partially fabricated.
6. The method of Embodiment 2, wherein the initial corrective film pattern information is associated with a specific film pattern shape, and wherein the optimized film pattern information output comprises optimized film pattern information for predicting the specific film pattern shape.
7. The method according to any one of the above Embodiments, wherein the method is further according to any one of Embodiments in Additional Examples I, III, VI, VIII, XI, or XV.

### Additional Examples XIII

1. A system for generating corrective film patterns for semiconductor wafers, the system comprising:
   one or more sensors configured to measure a warpage signature of a semiconductor wafer comprising a two dimensional height map;
   a memory storing the warpage signature;
   one or more processors; and
   non-transitory computer readable storage media storing instructions that when executed by the one or more processors, cause the one or more processors to:
      receive a warpage signature of a semiconductor wafer comprising a two dimensional height map;
      determine a target wafer shape transformation information based on the warpage signature;
      provide the target wafer shape transformation information to a surrogate machine learning model, wherein the surrogate machine learning model comprises:
         a forward model comprising a neural network model configured to take as input corrective film pattern information and output a corresponding wafer shape transformation information, and
         an inverse model comprising an optimizer algorithm configured to take as input a wafer shape transformation information and output a corresponding corrective film pattern information, wherein, to output the corresponding corrective film pattern information the optimizer is configured to:
         for a film thickness, determine initial corrective film pattern information and subsequent corrective film pattern information based at least in part on a shape image of an input of wafer shape transformation information,
         for each of the initial corrective film pattern information and subsequent corrective film pattern information provide the initial corrective film pattern information or subsequent film information to the forward model to receive the corresponding wafer shape transformation information; and
         determine an optimizer loss associated with a difference between the wafer shape transformation information output from the forward model and the wafer shape transformation input to the optimizer, and
         output optimized film pattern information associated with the transformation information output from the forward model with a minimized optimizer loss;
         wherein, the surrogate model is configured to:
         provide a plurality of film thicknesses to the optimizer,
         provide the optimized film pattern information output by the optimizer for each of the plurality of film thicknesses to the forward model, and
         output final film pattern information associated with a minimized error between the output wafer shape transformation of the inverse model for each of the plurality of film thicknesses and the target wafer shape transformation provided to the surrogate model; and
      receive, from the surrogate machine learning model, the final film pattern information associated with the warpage signature.
2. The system of Embodiment 1, wherein, to train the forward model, a second one or more processors are configured to:
   configure the input of corrective film pattern information, prior to processing through hidden layers of the neural network model, into separate component inputs including a corrective film image and corrective film variables associated with a wafer coverage and a film thickness;
   obtain the output of corresponding wafer shape transformation information as separate component outputs including the shape image and magnitudes of wafer warpage; and
   reduce a loss associated with each of component outputs of the forward model.
3. The system of Embodiment 2, wherein the one or more processors comprises at least one processor of the second one or more processors.
4. The system of Embodiment 1, wherein the surrogate machine learning model is stored and executed outside of the system.
5. The system of Embodiment 1, wherein the non-transitory computer readable storage media stores the surrogate machine learning model and instructions that when executed by the one or more processors, cause the one or more processors to execute the surrogate machine learning model.
6. The system of Embodiment 1, wherein the target wafer shape transformation information comprises separate components including the shape image and magnitudes of wafer warpage.
7. The system of Embodiment 1, wherein the corrective film pattern information comprises different coverage ratios across a wafer surface.
8. The system of Embodiment 1, wherein the corrective film pattern information is used to determine film patterns to be applied on a backside of a semiconductor wafer opposite a front side on which integrated circuit devices are at least partially fabricated.
9. The system according to any one of the above Embodiments, wherein the system is further according to any one of Embodiments in Additional Examples IV or IX.

### Additional Examples XIV

1. Non-transitory computer readable storage media storing instructions that when executed by a system of one or more processors, cause the one or more processors to:
   receive a warpage signature of a semiconductor wafer comprising a two dimensional height map;
   determine a target wafer shape transformation information based on the warpage signature;
   provide the target wafer shape transformation information to a surrogate machine learning model, wherein the surrogate machine learning model comprises:
      a forward model comprising a neural network model configured to take as input corrective film pattern information and output a corresponding wafer shape transformation information, and
      an inverse model comprising an optimizer algorithm configured to take as input a wafer shape transformation information and output a corresponding corrective film pattern information, wherein, to output the corresponding corrective film pattern information the optimizer is configured to:
         for a film thickness, determine initial corrective film pattern information and subsequent corrective film pattern information based at least in part on a shape image of an input of wafer shape transformation information,
         for each of the initial corrective film pattern information and subsequent corrective film pattern information provide the initial corrective film pattern information or subsequent film information to the forward model to receive the corresponding wafer shape transformation information; and
         determine an optimizer loss associated with a difference between the wafer shape transformation information output from the forward model and the wafer shape transformation input to the optimizer, and
         output optimized film pattern information associated with the transformation information output from the forward model with a minimized optimizer loss;
      wherein, the surrogate model is configured to:
         provide a plurality of film thicknesses to the optimizer,
         provide the optimized film pattern information output by the optimizer for each of the plurality of film thicknesses to the forward model, and
         output final film pattern information associated with a minimized error between the output wafer shape transformation of the inverse model for each of the plurality of film thicknesses and the target wafer shape transformation provided to the surrogate model; and
   receive, from the surrogate machine learning model, the final film pattern information associated with the warpage signature.
2. The non-transitory computer readable storage media of Embodiment 1, wherein, to train the forward model, a second one or more processors are configured to:
   configure the input of corrective film pattern information, prior to processing through hidden layers of the neural network model, into separate component inputs including a corrective film image and corrective film variables associated with a wafer coverage and a film thickness;
   obtain the output of corresponding wafer shape transformation information as separate component outputs including the shape image and magnitudes of wafer warpage; and
   reduce a loss associated with each of component outputs of the forward model.
3. The non-transitory computer readable storage media of Embodiment 2, wherein the one or more processors comprises at least one processor of the second one or more processors.
4. The non-transitory computer readable storage media of Embodiment 1, wherein the target wafer shape transformation information comprises separate components including the shape image and magnitudes of wafer warpage.
5. The non-transitory computer readable storage media of Embodiment 1, wherein the corrective film pattern information comprises different coverage ratios across a wafer surface.
6. The non-transitory computer readable storage media of Embodiment 1, wherein the corrective film pattern information is used to determine film patterns to be applied on a backside of a semiconductor wafer opposite a front side on which integrated circuit devices are at least partially fabricated.
7. The non-transitory computer readable storage media according to any one of the above Embodiments, wherein the non-transitory computer readable storage media is further according to any one of Embodiments in Additional Examples II, V, VII, or X

### Additional Examples XV

1. A method of supervised training a surrogate machine learning model for generating corrective film patterns to reduce warpage of semiconductor wafers during manufacturing of integrated circuit devices, the method comprising:
   receiving a training data set comprising:
      a set of target wafer shape transformation information comprising negatives of warpage signatures of semiconductor wafers, and
      a set of training corrective film pattern information to reduce warpage signatures of semiconductor wafers;
   providing the surrogate machine learning model comprising:
      a forward model comprising a first neural network model configured to take as input corrective film pattern information and output a corresponding wafer shape transformation information, and
      an inverse model comprising a second neural network model configured to take as input a wafer shape transformation information and output a corresponding corrective film pattern information,
      wherein the corrective film pattern information output by the inverse model comprises a film shape constructed using a predetermined shape function other than Zernike polynomials;
   training the forward model using the set of corrective film pattern information;
   training the inverse model using the set of wafer shape transformation information and the wafer shape transformation information determined by the trained forward model,
   wherein training the inverse model comprises using parameters other than Zernike coefficient to construct the film shape; and
   continuing to train the surrogate machine learning model until a difference between output from the forward model and input to the inverse model reaches below a predetermined value.
2. The method of Embodiment 1, wherein the predetermined shape function approximates one of a saddle shape, a stripe shape and an hourglass shape.
3. The method of Embodiment 2, wherein the predetermined shape function approximates the stripe shape, and the parameters other than Zernike coefficients include x and y coordinates of a center, a width of the stripe, and a rotation angle with respect to an x-axis.
4. The method of Embodiment 2, wherein the predetermined shape function approximates the hourglass shape, and the parameters other than Zernike coefficients include x and y coordinates of a center, a vertex angle, and a rotation angle with respect to an x-axis.
5. The method of Embodiment 2, wherein the predetermined shape function approximates the saddle shape, and the parameters other than Zernike coefficients include x and y coordinates of a center, a rotation angle with respect to an x-axis, and coefficients of a polynomial applied symmetrically across the center.
6. The method of Embodiment 1, wherein training the forward model comprises:
   configuring the input of corrective film pattern information, prior to processing through hidden layers of the first neural network model, into separate component inputs including a corrective film image and corrective film variables associated with a wafer coverage and a film thickness;
   obtaining the output of corresponding wafer shape transformation information as separate component outputs including a shape image and magnitudes of wafer warpage; and
   reducing a loss associated with each of the separate component outputs of the forward model.
7. The method of Embodiment 1, wherein training the inverse model comprises:
   configuring the input of wafer shape transformation information, prior to processing through hidden layers of the second neural network model, into separate component inputs including the shape image and the magnitudes of wafer warpage;
   obtaining the output of corresponding corrective film pattern information as separate component outputs including the corrective film image and the corrective film variables associated with the wafer coverage and the film thickness; and
   reducing a loss associated with each of component outputs of the inverse model.
8. The method of Embodiment 1, wherein the wafer shape transformation information is derived a wafer shape information comprising a first order bow (FOB) component and second order wafer bow (HOB) component.
9. The method according to any one of the above Embodiments, wherein the method is further according to any one of Embodiments in Additional Examples I, III, VI, VIII, XI, or XII.

Unless the context clearly requires otherwise, throughout the description and the embodiments, the words “comprise,” “comprising,” “include,” “including,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. For example, while the disclosed embodiments are presented in given arrangements, alternative embodiments may perform similar functionalities with different components and/or circuit topologies, and some elements may be deleted, moved, added, subdivided, combined, and/or modified. Each of these elements may be implemented in a variety of different ways as suitable. Any suitable combination of the elements and acts of the various embodiments described above can be combined to provide further embodiments. The accompanying claims and their equivalents are intended to cover such forms or modifications as would fall within the scope and spirit of the disclosure. Accordingly, the scope of the present inventions is defined by reference to the claims.

What is claimed is:

1. A method of supervised training a surrogate machine learning model for generating corrective film patterns to reduce warpage of semiconductor wafers during manufacturing of integrated circuit devices, the method comprising:
receiving a training data set comprising:
a set of target wafer shape transformations corresponding to negatives of warpage signatures of semiconductor wafers, and
a set of training corrective film patterns that reduce warpage signatures of semiconductor wafers;
providing the surrogate machine learning model comprising:
a forward model comprising a first neural network model configured to take as input a corrective film pattern and output a corresponding wafer shape transformation, and
an inverse model comprising a second neural network model configured to take as input a wafer shape transformation and output a corresponding corrective film pattern;
training the forward model using the set of training corrective film patterns;
training the inverse model using the set of wafer shape transformations and the wafer shape transformations determined by the trained forward model,
wherein training the inverse model comprises determining a training loss associated with each wafer shape transformation input thereto and the corresponding corrective film pattern output therefrom, and wherein training the inverse model further comprises a regularization process, comprising:
determining one or more corrective film patterns of a set of corrective film patterns output by the inverse model to be outlier corrective film patterns that are outside of a main distribution of the set of corrective film patterns output by the inverse model, and
applying a regularization penalty to the training loss associated with the outlier corrective film patterns; and
continuing to train the surrogate machine learning model until a difference between the wafer shape transformation output from the forward model and the wafer shape transformation input to the inverse model reaches below a predetermined value.

2. The method of claim 1, wherein the regularization processes further comprises parameterizing the set of corrective film patterns output by the inverse model.

3. The method of claim 2, wherein parameterizing the set of corrective film patterns output by the inverse model comprises determining coefficients of Zernike polynomials of the set of corrective film patterns output by the inverse model.

4. The method of claim 2, wherein determining the one or more corrective film patterns output by the inverse model to be outlier corrective film patterns comprises:
based on the parameterized set of corrective film patterns output by the inverse model, determining a Mahalanobis distance of the one or more corrective film patterns exceeds a threshold.

5. The method of claim 4, wherein the regularization penalty increases as the Mahalanobis distance increases.

6. The method of claim 4, wherein no regularization penalty is applied to the main distribution of the corrective film patterns output by the inverse model.

7. The method of claim 1, wherein the set of corrective film patterns comprises the set of corrective film patterns output by the inverse model and the set of training corrective film patterns.

8. The method of claim 1, wherein the warpage signatures of semiconductor wafers are determined from measurements from semiconductor wafers using one or more sensors.

9. The method of claim 1, wherein the negatives of warpage signatures of semiconductor wafers are associated with simulations of semiconductor wafer surfaces.

10. The method of claim 1, further comprising
receiving a new desired wafer shape transformation;
inputting the new desired wafer shape transformation into the surrogate machine learning model to determine one or more new corrective film patterns;
retraining the forward model and inverse model, using the one or more new corrective film patterns.

11. The method of claim 1, wherein the set of corrective film patterns were generated using an optimizer configured to output an optimized corrective film pattern from a given target wafer shape transformation.

12. The method of claim 1, wherein the corrective film patterns comprise different coverage ratios across a wafer surface.

13. The method of claim 1, wherein the corrective film patterns are to be applied on a backside of a semiconductor wafer opposite a front side on which integrated circuit devices are at least partially fabricated.

14. A method of generating corrective film patterns to reduce warpage of semiconductor wafers during manufacturing of integrated circuits, the method comprising:
receiving a warpage signature of a semiconductor wafer comprising a two dimensional height map;
determining a target wafer shape transformation based on the warpage signature;
providing the target wafer shape transformation to a surrogate machine learning model, wherein the surrogate machine learning model comprises:
a forward model comprising a first neural network model trained to take as input a corrective film pattern and output a corresponding wafer shape transformation, and
an inverse model comprising a second neural network model trained to take as input a wafer shape transformation and output a corresponding corrective film pattern, wherein to train the inverse model one or more processors are configured to:
determine a training loss associated with each wafer shape transformation input thereto and the corresponding corrective film pattern output therefrom, and
perform a regularization process, comprising:
determining one or more corrective film patterns of a set of corrective film patterns output by the inverse model to be outlier corrective film patterns that are outside of a main distribution of the corrective film patterns output by the inverse model, and
applying a regularization penalty to the training loss associated with the outlier corrective film patterns; and
receiving, from the surrogate machine learning model, one or more corrective film patterns associated with the warpage signature.

15. The method of claim 14, wherein the regularization processes further comprises parameterizing the set of corrective film patterns output by the inverse model.

16. The method of claim 15, wherein parameterizing the set of corrective film patterns output by the inverse model comprises determining coefficients of Zernike polynomials of the set of corrective film patterns output by the inverse model.

17. The method of claim 15, wherein determining the one or more corrective film patterns output by the inverse model to be outlier corrective film patterns comprises:
based on the parameterized set of corrective film patterns output by the inverse model, determining a Mahalanobis distance of the one or more corrective film patterns exceeds a threshold.

18. The method of claim 17, wherein the regularization penalty increases as the Mahalanobis distance increases.

19. The method of claim 17, wherein no regularization penalty is applied to the main distribution of the corrective film patterns output by the inverse model.

20. The method of claim 14, further comprising:
providing the one or more corrective film patterns associated with the warpage signature to the surrogate machine learning model,
wherein the one or more processors are configured to retrain the forward model and inverse model using the one or more corrective film patterns associated with the warpage signature.
